(19) United States
(12) Patent Application Publication
(10) Pub. No.: US 2016/0321661 A1
(43) Pub. Date: Nov. 3, 2016

(54) SYSTEMS AND METHODS FOR ORGANIZING, VISUALIZING AND PROCESSING CONSUMER TRANSACTIONS DATA

(71) Applicant: The Retail Equation, Inc., Louisville, KY (US)

(72) Inventors: Mark S. Hammond, Laguna Beach, CA (US); Adi Raz, Lake Forest, CA (US); David Speights, Tustin, CA (US); Vishal P. Rajesh, Irvine, CA (US); William R. Berry, Mission Viejo, CA (US); Ian Williams, Yorba Linda, CA (US); Thomas W. Rittman, Brecksville, OH (US); Steven C. Carroll, Monroe, WA (US); Kenny H.C. Vu, Laguna Hills, CA (US); Peter L. Bradshaw, San Clemente, CA (US)

(21) Appl. No.: 15/143,280

(22) Filed: Apr. 29, 2016

Related U.S. Application Data
(60) Provisional application No. 62/154,651, filed on Apr. 29, 2015.

(51) Int. Cl. G06Q 20/40; G06Q 30/00

(52) U.S. Cl. CPC G06Q 20/407; G06Q 20/4016; G06Q 30/0185

(57) ABSTRACT

Systems and method for interfacing with a client computing system to receive return authorization data associated with the client computing system, determine linked transaction records based on the return authorization data, nominate a group of linked transaction records based on client-specific thresholds indicative of return abuses or frauds, and generate and transmit recommended actions to the client computing system based on the nominated group of linked transaction records are described.

### RELATED APPLICATIONS

Any and all applications for which a foreign or domestic priority claim is identified in the Application Data Sheet as filed with the present application are hereby incorporated by reference under 37 CFR 1.57.

### BACKGROUND

Determining when to allow retail customers to return purchased merchandise is a delicate and complex business decision that many merchants face. Customers typically appreciate, and have come to expect, a liberal return policy. Such a policy can engender good will towards the merchant and often encourages the customer to purchase more freely, indulging more often in “impulse buying.” However, some customers abuse this liberal return policy and engage in fraudulent or abusive behaviors, causing great financial harm to the merchants. For example, some customers will repeatedly purchase items with the intention of returning them after use. Other customers will return items stolen from another store, knowing that many merchants will issue a store credit even when an item is returned without a receipt. These behaviors may not be apparent to the merchants, especially when the customers who engage in such behaviors use forged IDs and divide up the work amongst multiple individuals. In some cases, the employees of the merchants may be colluding with such customers, making it even more difficult to detect and prevent such return abuses and frauds. Thus, an improved system for identifying return abuses and frauds is desired.

### BRIEF SUMMARY

The present disclosure generally relates to an electronic monitoring system that can analyze large amounts of purchase and return transaction data of a merchant, identify potential return abuses and frauds committed against the merchant based on the data, and generate a report detailing the potential return abuses and frauds and the risks to the merchant in an easy-to-digest format. Based on the report, which may include visual illustrations of the individuals and transactions identified as being potentially abusive or fraudulent, the merchant can take further action to prevent or reduce return abuses and frauds in the future. The electronic monitoring system may also identify employees who may be colluding with abusive or fraudulent customers to commit return abuses and frauds against the merchant. Further, the electronic monitoring system may provide real-time alerts to the merchant, allowing the merchant to take immediate action before the customer suspected of committing a return abuse or fraud walks away from the store. The electronic monitoring system may also be used to identify other patterns or trends in the transaction data so that the merchant can take appropriate action based on the identified pattern or trend.

According to an aspect, an electronic monitoring system that automatically identifies organized retail crime rings includes an electronic identify device, a nomination database, and an identification system. The electronic identify device may be configured to communicate with the identification system and the nomination database via a computer-mediated network. The electronic identify device may be associated with a client. The nomination database may be configured to store one or more groups of linked transaction records associated with the client and generated by the identification system. The identification system may be configured to: receive return authorization data from a client computing system associated with the client over the computer-mediated network, the return authorization data generated by a point of return (POR) device of the client based on a plurality of product returns processed by the client, the return authorization data including a plurality of transaction records associated with the plurality of product returns, each transaction record having a transaction identifier and a transaction amount; determine a set of threshold levels associated with the client based on the received return authorization data, the set of threshold levels indicative of whether a group of linked transaction records has an increased likelihood of being associated with an organized retail crime ring; identify a first group of linked transaction records from the plurality of transaction records in the return authorization data based on one or more common attributes shared by one or more subsets of transaction records in the first group of linked transaction records, the one or more common attributes comprising one or more of a driver's license number, a mailing address, a gift card identifier, a loyalty card identifier, a store credit identifier, a credit card number, a state ID number, a debit card number, a check account number, a client-specific customer number, or a passport number; determine that the first group of linked transaction records has an increased likelihood of being associated with an organized retail crime ring based on whether the first group of linked transaction records collectively satisfies the set of thresholds associated with the client; in response to determining that the first group of linked transaction records has an increased likelihood of being associated with an organized retail crime ring, nominate the first group of linked transaction records for presentation to the client and cause the nominated first group of linked transaction records to be stored in the nomination database; receive, from the POR device of the client over the computer-mediated network, an indication that a product return request by a user has been processed, the indication including a first transaction identifier associated with the processed product return request; in response to receiving the indication that the product return request has been processed, query the nomination database to determine, using the received first transaction identifier, whether the nomination database includes one or more nominated transaction records that are associated with the first transaction identifier; in response to determining that the first group of linked transaction records includes a first nominated transaction record associated with the first transaction identifier, generate organized retail crime ring information based on the first group of linked transaction records, the organized retail crime ring information including additional information linking the user with one or more other users associated with the first group of linked transaction records in a context of the organized retail crime ring; and transmit the generated organized retail crime ring information over the computer-mediated network to the electronic identify device, thereby enabling the client to take additional action based on the transmitted organized retail crime ring information.

According to an aspect, each subset of transaction records in the group of linked transaction records may share at least one common attribute with at least one other subset of transaction records in the group of linked transaction records.

According to an aspect, the set of threshold levels may include a threshold level for a total return value, and the identification system may further be configured to determine that the first group of linked transaction records has an increased likelihood of being associated with an organized retail crime ring based on a determination that the first group of linked transaction records collectively exceeds the threshold level for the total return value.

According to an aspect, the set of threshold levels may include a threshold level for a total number of identifications, the identification system may further be configured to determine that the first group of linked transaction records has an increased likelihood of being associated with an organized retail crime ring based on a determination that the first group of linked transaction records collectively exceeds the threshold level for the total number of identifications.

According to an aspect, the set of threshold levels may include a threshold level for a total return rate, the identification system may further be configured to determine that the first group of linked transaction records has an increased likelihood of being associated with an organized retail crime ring based on a determination that the first group of linked transaction records collectively exceeds the threshold level for the total return rate.

According to an aspect, the identification system may further be configured to generate a data structure associated with the nominated first group of linked transaction records in the form of a connected graph user interface and cause the generated data structure to be presented via the client computing device.

According to an aspect, the identification system may further be configured to generate a data structure associated with the nominated first group of linked transaction records in the form of a map user interface and cause the generated data structure to be presented via the client computing device.

According to an aspect, the identification system may further be configured to generate a data structure associated with the nominated first group of linked transaction records in the form of a table user interface and cause the generated data structure to be presented via the client computing device.

According to an aspect, the identification system may further be configured to query the nomination database in response to receiving an indication that a product return request has been denied.

According to an aspect, the identification system may further be configured to query the nomination database in response to receiving an indication that one or more parameters associated with a granted product return request satisfy a threshold condition.

According to an aspect, a method that automatically identifies organized retail crime rings may include: receiving return authorization data from a client computing system associated with a client over a computer-mediated network, the return authorization data generated by a point of return (POR) device of the client based on a plurality of product returns processed by the client, the return authorization data including a plurality of transaction records associated with the plurality of product returns, each transaction record having a transaction identifier and a transaction amount; determining a set of threshold levels associated with the client based on the received return authorization data, the set of threshold levels indicative of whether a group of linked transaction records has an increased likelihood of being associated with an organized retail crime ring; identifying a first group of linked transaction records from the plurality of transaction records in the return authorization data based on one or more common attributes shared by one or more subsets of transaction records in the first group of linked transaction records, the one or more common attributes comprising one or more of a driver's license number, a mailing address, a gift card identifier, a loyalty card identifier, a store credit identifier, a credit card number, a state ID number, a debit card number, a check account number, a client-specific customer number, or a passport number; determining that the first group of linked transaction records has an increased likelihood of being associated with an organized retail crime ring based on whether the first group of linked transaction records collectively satisfies the set of thresholds associated with the client; in response to determining that the first group of linked transaction records has an increased likelihood of being associated with an organized retail crime ring, nominating the first group of linked transaction records for presentation to the client and cause the nominated first group of linked transaction records to be stored in the nomination database; receiving, from the POR device of the client over the computer-mediated network, an indication that a product return request by a user has been processed, the indication including a first transaction identifier associated with the processed product return request; in response to receiving the indication that the product return request has been processed, querying the nomination database to determine, using the received first transaction identifier, whether the nomination database includes one or more nominated transaction records that are associated with the first transaction identifier; in response to determining that the first group of linked transaction records includes a first nominated transaction record associated with the first transaction identifier, generating organized retail crime ring information based on the first group of linked transaction records, the organized retail crime ring information including additional information linking the user with one or more other users associated with the first group of linked transaction records in a context of the organized retail crime ring; and transmitting the generated organized retail crime ring information over the computer-mediated network to an electronic identify device associated with the client, thereby enabling the client to take additional action based on the transmitted organized retail crime ring information.

According to an aspect, each subset of transaction records in the group of linked transaction records may share at least one common attribute with at least one other subset of transaction records in the group of linked transaction records.

According to an aspect, the set of threshold levels may include a threshold level for a total return value, and the method may further include determining that the first group of linked transaction records has an increased likelihood of being associated with an organized retail crime ring based on a determination that the first group of linked transaction records collectively exceeds the threshold level for the total return value.

According to an aspect, the set of threshold levels may include a threshold level for a total number of identifications, the method may further include determining that the first group of linked transaction records has an increased likelihood of being associated with an organized retail crime ring based on a determination that the first group of linked transaction records collectively exceeds the threshold level for the total number of identifications.

According to an aspect, the set of threshold levels may include a threshold level for a total return rate, the method may further include determining that the first group of linked transaction records has an increased likelihood of being associated with an organized retail crime ring based on a determination that the first group of linked transaction records collectively exceeds the threshold level for the total return rate.

According to an aspect, the method may further include generating a data structure associated with the nominated first group of linked transaction records in the form of a connected graph user interface and causing the generated data structure to be presented via the client computing device.

According to an aspect, the method may further include generating a data structure associated with the nominated first group of linked transaction records in the form of a map user interface and causing the generated data structure to be presented via the client computing device.

According to an aspect, the method may further include generating a data structure associated with the nominated first group of linked transaction records in the form of a table user interface and causing the generated data structure to be presented via the client computing device.

According to an aspect, the method may further include querying the nomination database in response to receiving an indication that a product return request has been denied.

According to an aspect, the method may further include querying the nomination database in response to receiving an indication that one or more parameters associated with a granted product return request satisfy a threshold condition.

### BRIEF DESCRIPTION OF THE DRAWINGS

Various embodiments are depicted in the accompanying drawings for illustrative purposes, and should not be interpreted as limiting the scope of the inventions.

FIG. 1 is a block diagram illustrating an example embodiment of an electronic monitoring system.

FIG. 2 is a block diagram of an example embodiment of an identification service.

FIG. 3 is an example embodiment of a dedicated point of return (POR) device.

FIG. 4 depicts a series of user interface screenshots for an example embodiment of a process for collecting data at a point of return.

FIG. 5 depicts an example embodiment of a nomination model architecture.

FIG. 6 depicts a set of factors that may be used to influence a determination made in connection with a requested merchandise return.

FIG. 7 is a flowchart that illustrates an example embodiment of a process for nominating a group of linked transaction records.

FIG. 8 depicts a user interface screenshot for a dashboard view of the nominations.

FIG. 9 depicts a user interface screenshot for a connected graph view corresponding to an example nomination.

FIG. 10 depicts a user interface screenshot for a zoomed in version of the connected graph view corresponding to an example nomination.

FIG. 11 depicts a user interface screenshot for a map view corresponding to an example nomination.

FIG. 12 depicts a user interface screenshot for a table view corresponding to an example nomination.

FIG. 13 is a flowchart that illustrates an example embodiment of a process for determining an employee fraud.

FIG. 14 depicts a legend showing the relative positions of FIGS. 14A-14D.

FIGS. 14A-14D depict a user interface screenshot for an employee profile view corresponding to an example employee.

FIG. 15 depicts a user interface screenshot for a transaction search according to an example embodiment.

FIG. 16 is a flowchart that illustrates an example embodiment of a process for identifying a return abuse or fraud based on SKU anomalies.

FIG. 17 depicts a scatter graph illustrating an example method of identifying SKU anomalies.

FIG. 18 depicts a line graph illustrating an example method of identifying SKU anomalies based on geographic locations.

FIG. 19 depicts an example embodiment of an alert model architecture.

FIG. 20 depicts an email alert generated and transmitted according to an example embodiment.

### DETAILED DESCRIPTION

A merchant typically provides a liberal return policy to encourage consumers to purchase more freely and to create a reputation that the merchant is consumer-friendly. However, such a liberal return policy allows some consumers to engage in abusive or fraudulent behaviors at the merchant's expense. For example, a consumer may repeatedly purchase items with the intention of returning them after use, treating the clothing store as his or her own closet. Such a behavior is harmful to the merchant because once the items have been returned, the merchant will incur restocking expenses and may no longer be able to re-sell the items at their original prices. In another example, a consumer may return items stolen from another store. Even without a verifiable receipt, the merchant may be forced to issue a store credit in exchange for the stolen item that the merchant never even sold. In other cases, consumers may use forged IDs to conceal their abusive or fraudulent behaviors, or even work together to commit these return abuses and frauds in an organized fashion (e.g., Person A steals items, Person B returns the stolen items and receives store credits in return, Person C sells the received store credits online, etc.).

To prevent or reduce these and other return abuses, a merchant may determine, based on an individual's purchase and return patterns, whether the individual is engaging in abusive or fraudulent activities and take appropriate action based on the determination. For example, if the individual is returning 90% of the clothes that he or she purchased at a clothing shop, the owner of the clothing shop may determine, by reviewing the past purchases and returns by the individual, that the individual is abusing the return policy and deny any additional return requests. However, the number of purchase and return transactions processed by a single merchant over time is typically very large, and the labor necessary to review all of the transactions may render such a strategy cost-prohibitive.

A computer-implemented monitoring system according to embodiments of the present invention can nominate key transactions or groups of transactions for the merchant's review, so that the merchant does not need to comb through hundreds and thousands of purchase and return transactions. For example, the electronic monitoring system according to some embodiments may determine client-specific (e.g., based on the data associated with a given merchant) thresholds based on the transaction data and the return authorization data generated by the client, identify a group of related transactions based on shared attributes, and nominate the group of related transactions based on the client-specific thresholds. Nominated transactions may be transmitted to the client in real-time or stored for subsequent review by the client. The nominations may be presented in an easy-to-understand graphical format to facilitate the review by the client. In addition to nominating consumer transactions, the electronic monitoring system according to some embodiments may nominate employees that may be associated with fraudulent customers. Additionally, the electronic monitoring system may identify return frauds based on SKU categories not tied to an identifiable set of fraudulent individuals. Real-time alerts can allow the merchant to take immediate action before the evidence of fraud disappears from the scene.

Although some embodiments and techniques of the present invention are described in the context of return frauds, such embodiments and techniques are not limited as such and may be extended to return abuses, rewards, purchases, or any other areas. For example, nominations (described in greater detail below) may be generated based on return frauds, return abuses, purchases, other consumer activity, employee activity, and/or any other transactions and data.

### Example Configuration of Electronic Monitoring System

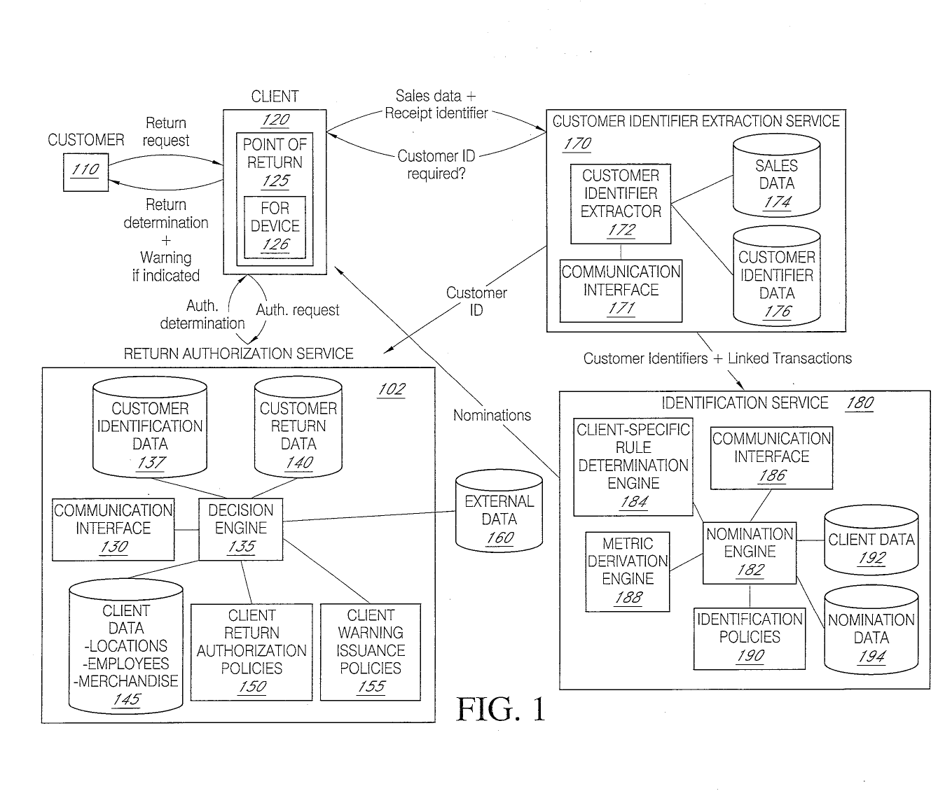

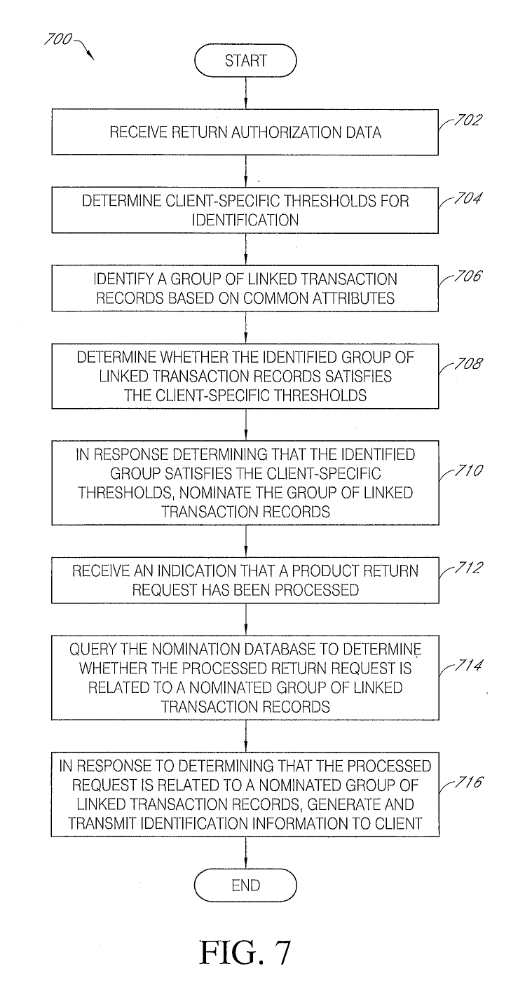

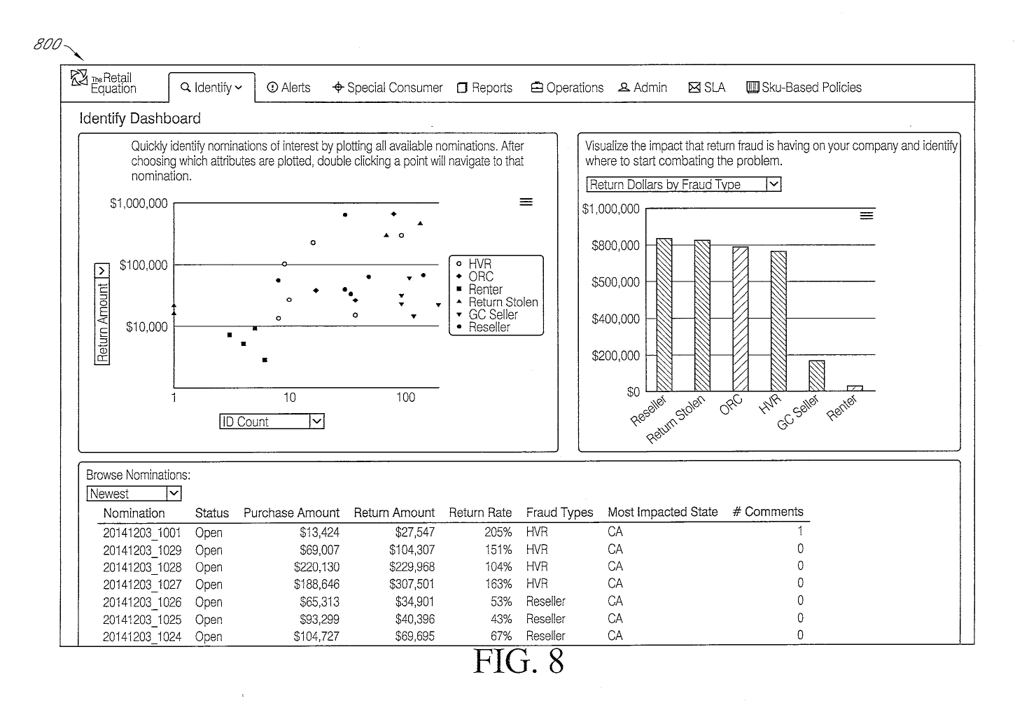

FIG. 1 is a block diagram depicting one embodiment of an electronic monitoring system 100. A customer 110 who wishes to return previously purchased merchandise can bring the merchandise to a point of return 125 at a client establishment 120 (e.g., a retailer) and can request to receive an equivalent dollar amount of cash, credit, merchandise, or some combination or equivalent thereof. The point of return 125 may be a desk or location within the client establishment 120 that is dedicated for processing merchandise returns. Alternatively, the point of return 125 may be a normal checkout terminal or cashier's station that may be additionally used for processing purchases and other types of business transactions, or the point of return 125 may be another location. In some embodiments, the point of return 125 includes a computing device (referred to herein as an “identify” device) associated with the client 120 that may be configured to receive one or more nominations generated by an identification service 180 (described in greater detail with reference to FIG. 7). Alternatively or additionally, such a computing device configured to receive the nominations may be near the point of return 125, at the same store location(s) associated with the nominations, and/or at a headquarter location associated with the client 120. The identify device described herein may be any one of a desktop, a laptop, a mobile phone, a smartphone, a tablet, a kiosk, a wireless device, and any other electronic device.

For purposes of this disclosure, the systems and methods described herein will frequently be described with reference to a clerk or other client employee who receives a merchandise return request from a customer 110 and who accepts or denies the return request, based, at least in part, on a recommendation received from a return authorization service 102. In various embodiments, the actions attributed to the clerk may alternatively or additionally be carried out by another type of client employee or representative, or other person authorized to handle the merchandise return, or by an automated process or system configured to process the return request. Thus, while, for ease of description, the systems and methods will be described with reference to a clerk at a point of return 125, it should be understood that embodiments of the systems and methods may also be carried out with one or more of the above-listed, or other, clerk alternatives.

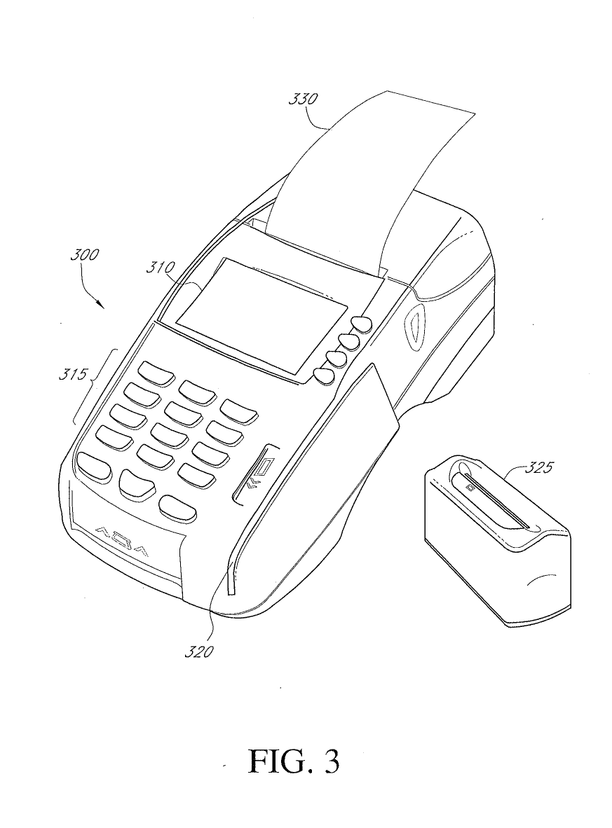

The clerk may use an automated point of return (POR) device 126 for processing the requested merchandise return. The POR device 126 may be used to input information about the requested return and to provide authorization information for the return to the clerk handling the return. In some embodiments, a device dedicated for use with merchandise returns may be used in association with the systems and methods described herein. One embodiment of such a dedicated POR device 126 is described with reference to FIG. 3 below. In other embodiments, the POR device 126 is at least one of: a hand-held device, a wireless device, a telephone-assisted device, a self-serve kiosk, an assisted-return kiosk, or other suitable apparatus. In some embodiments, rather than using a dedicated POR device 126, a multi-functional check-out terminal or other computerized device may be configured to provide some or all of the functionality associated with the POR device 126 described herein. In some embodiments, more than one device may be used to provide some or all of the functionality described herein for the POR device 126. Thus, while the systems and methods described herein may be described with reference to a dedicated POR device 126, it is to be understood that a wide variety of dedicated and/or multi-purpose POR devices 126 may be used without departing from the spirit of the invention as described herein. In some embodiments, the POR device 126 operates as an identify device configured to receive the nominations generated by the identification service 180. In other embodiments, the POR device 126 is separate from the identify device described herein.

In some embodiments, clients 120 can have a return policy that outlines conditions for accepting returned merchandise. For example, the client 120 may stipulate that the customer 110 must have a receipt associated with the purchase of the item to be returned, that the return take place no more than thirty days after the purchase date, that the item be in its original packaging and/or has not been used, and so forth.

Clients 120 may implement this or any of a wide variety of other return policies to suit their business goals. For example, clients 120 may implement different return policies for different classes of items, stipulating, for example, that software merchandise returns must still be in their original, unopened packaging, while returns of other types of products may be accepted, even with opened packaging. In accordance with some client return policies, certain types of merchandise are not accepted for return. As another example, a client 120 may desire to implement a more liberal return policy during the post-holiday season when the point of return 125 counters experience a higher-than-normal volume of returns. Based at least in large part on the return policy used by the client 120, a clerk, or other person or process, at the point of return 125 may accept or deny the customer's 110 returned merchandise.

As depicted in FIG. 1, the authorization determination for the customer's requested return may be handled by an automated return authorization service 102. The return authorization service 102 may accept information input by the clerk at the point of return 125 and use various types of information associated with the requested return in order to implement the client's 120 return policy and to assess risk of exposure to fraudulent, abusive, or unprofitable behavior that may be associated with accepting the requested return.

In some embodiments, the return authorization service 102 may be implemented, as depicted in FIG. 1, as an external entity whose services are contracted or otherwise provided to the client 120. Additionally or alternatively, the return authorization service 102 may be implemented as one or more software and/or hardware components under the operation of the client 120 that function in the POR device 126 and/or within one or more computer devices at the point of return 125, at another location within the same physical client establishment and/or at a geographically removed location used by the client 120 (e.g., an identify device associated with the client 120). Thus, although the systems and methods described herein are most often described in association with an external return authorization service, it is to be understood that any combination of these or other implementation arrangements may be used.

In embodiments where the return authorization service 102 is a separate entity that assesses and authorizes requested returns presented to the client 120, communication between the client's point of return 125 and the return authorization service 102 may be carried out using any of a wide variety of appropriate devices and/or communications and data security technologies. For example, the communications between a computerized device at the client's point of return 125 and a communication interface 130 at the return authorization service 102 may be carried out using the Internet or other global network. In other embodiments, the communications may be carried out using any communication system including by way of example, dedicated communication lines, telephone networks, wireless data transmission systems, two-way cable systems, customized computer networks, interactive kiosk networks, automatic teller machine-type networks, interactive television networks, and the like.

The customer 110 requesting the merchandise return may present a receipt to the clerk. The clerk can scan the receipt or otherwise input a receipt identifier taken from the receipt. The receipt identifier can include, for example, the date, a store number, a transaction number, a register number, some combination thereof, or some other identifier capable of identifying the transaction associated with the receipt. The clerk handling the requested return can use the POR device 126 to input and send information about an authorization request to the return authorization service 102. The receipt identifier can be sent to the return authorization service 102 as part of the authorization request or separately. The return authorization service 102 can receive the information from the POR device 126 via the communication interface 130 and uses the information, together with other stored information, to make an authorization determination for the requested merchandise return, assessing the risk of accepting the return and implementing client return policy preferences to recommend either that the clerk accept the requested return, refuse to accept the requested return, or take another course of action.

In some embodiments, as will be described in greater detail below, the return authorization service 102 may provide a warning to the customer 110 together with a positive authorization determination, indicating that although the current return request is being accepted, authorization of future return requests from the customer may be limited. Also, in some embodiments, the return authorization service 102 may provide a coupon for the customer 110 together with a positive authorization determination.

As another example, in accordance with some store policies, as an alternative to accepting the requested return, the authorization service 102 may provide an authorization determination recommending that the clerk offer store credit or some other alternative in place of a requested cash exchange for the cash value of the returned merchandise. In some embodiments, the authorization service 102 may also provide a recommended timing for paying the consumer. For example, the authorization service 102 may recommend mailing a check to cover the return amount, crediting an account in the future, implementing a cooling-off period, requiring further review before authorization, or the like.

The embodiment of the return authorization service 102 that is depicted in FIG. 1 includes a communication interface 130, a decision engine 135, a customer identification data repository 137, a customer return data repository 140, a client data repository 145, and a repository of client return authorization policies 150. Other embodiments of the return authorization service 102 may include other components (e.g., a repository of client warning issuance policies, a sales data repository, a repository of client coupon policies, etc.) and/or a subset of these components. For example, some embodiments may include only the decision engine 135 and may access information from other sources, and some embodiments may omit components shown in FIG. 1. Additionally, some components shown in FIG. 1 may be divided into multiple components, or combined together. For example, the decision engine 135 can be used to make the authorization determinations, warning determinations, and coupon determinations, or multiple decision engines can be used. Also, a single database can include some or all of the data repositories shown in FIG. 1, or multiple databases can be used.

The communication interface 130 can receive sales data from the client 120 and store the sales data in a sales data repository. The sales data can be sent periodically or intermittently to the communication interface 130. For example, the client 120 can transfer a batch of sales data to the communication interface 130 once each day (e.g., after the store closes), once every two days, once each week, twice each day, once each hour, or at any other suitable frequency. In some embodiments, the sales data can be sent to the communication interface 130 on a per-transaction basis with little or no delay after the purchase transaction. If a customer 110 tries to return the purchased merchandise shortly after making the purchase, and before the sales data is received into the sales data repository, the return authorization service 102 would not be able to access the sales data to extract a customer identifier, access the appropriate customer data, and assess the riskiness of the requested return. Thus, it can be advantageous for the sales data repository to receive the sales data as soon as possible after the purchase transaction occurs. The sales data transferred to the communication interface 130 can include all the sales transactions made by the client 120 during the applicable period (e.g., each day), or some transactions may be excluded so that the sales data includes only a subset of the sales transactions. The communication interface 130 and/or the point of sale devices or other computer systems at the client 120 can be configured to transfer the sales data automatically without any user involvement. Alternatively, the review and/or approval of a manager at the client 120 may be required before a batch of sales data is transferred to the communication interface 130. Many variations are possible.

The communication interface 130 can receive an authorization request from the client POR device 126, information about the requested merchandise return sent from the POR device 126, and a receipt identifier sent from the POR device 126. In some embodiments, the information about the requested merchandise return and/or the receipt identifier can be transferred as part of the authorization request or as separate data transfers. The received information is sent to a decision engine 135 for assessing risk associated with accepting the requested merchandise return and for making an authorization determination that is based on the assessed risk as well as on stored information about the client's return authorization policies 150. The return policies 150 may be implemented in a variety of computer-usable forms, including, but not limited to, rule-based systems, decision trees, scorecard systems, and the like. In various embodiments, the decision engine 135 may assess the requested return transaction with reference to one or more threshold conditions, such as an acceptable score. In some score-based embodiments, in which a high score indicates low risk, if the requested return transaction meets or exceeds an authorization threshold, the return is accepted, while if the requested return does not meet the threshold, the return is denied. Other methods of assessing whether to accept the requested return may alternatively or additionally be used.

The decision engine 135 may also use stored information about the client's warning issuance policies 155, if available, to determine if a warning is to be issued to the customer. The warning policy 155 may also be implemented in a variety of computer-usable forms, including, but not limited to, rule-based systems, decision trees, scorecard systems, and the like. In some embodiments in which assessment is carried out by a scoring system, in which a lower score indicates higher risk, the decision engine 135 can determine that the return transaction has a high enough safety score for the return to be authorized, but that the safety score only exceeded the denial threshold by a small margin, indicating that the customer may be close to crossing the line into abusive or fraudulent return behavior. The decision engine can then prepare an appropriate warning and/or restriction to issue to the customer. In some embodiments, a return request score can fall into one of three categories: authorize, warn, and deny. A return request that falls below the denial threshold can be denied. For a return request that falls between the denial threshold and the authorization threshold, a warning to the customer 110 may be issued along with an acceptance, alerting the customer 110 that acceptance of future returns may be limited, based on additional return activity. A return request that exceeds an authorization threshold can be authorized with no warnings or restrictions. In some embodiments, multiple warning thresholds can be used to determine which of several warnings (if any) should be issued to the customer.

The decision engine 135 may also use stored information about the client's coupon issuance policies, if available, to determine if a coupon is to be offered to the customer. The coupon policies may also be implemented in a variety of computer-usable forms, including, but not limited to, rule-based systems, decision trees, scorecard systems, and the like. In some embodiments in which assessment is carried out by a scoring system, in which a lower score indicates higher risk, when the decision engine 135 determines that the return transaction has exceeded a coupon threshold, a coupon can be offered to the customer 110. In some embodiments, multiple coupon thresholds can be used to determine which of several coupons (if any) should be issued to the customer. Sometimes a customer returns an item because they are dissatisfied with the merchandise or with the client 120, and a coupon offering may appease the customer and further increase the client's good will and reputation. In some embodiments, the coupon offer determination can be based the same scoring algorithm as the return authorization determination, or on a different scoring algorithm.

In addition to stored information about the client's return policies 150, warning policies 155, and coupon policies, the decision engine 135 may make determinations based, at least in part, on information from one or more other repositories of data collected and maintained by the return authorization service 102, or from one or more external client or non-client data sources 160. For example, the decision engine 135 may identify the customer 110 requesting the merchandise return, identify customer data associated with the customer 110 (e.g., prior returns and/or prior purchases made by the customer 110), and make a risk assessment, or other determinations, based at least in part on the identified customer data.

In some embodiments, the decision engine 135 can identify the customer 110 by using the received receipt identifier, without having the customer 110 present a form of ID. As mentioned above, the communication interface 130 can receive the receipt identifier for the receipt associated with the purchase of the merchandise being returned. The decision engine 135 can use the receipt identifier to locate the sales data from the original purchase of the merchandise in the sales data repository. The decision engine 135 can extract a customer identifier from the located sales data. The customer identifier can be, for example, a customer loyalty number, a hashed credit card number, a hashed debit card number, a hashed check account number, a credit card number, a debit card number, a check account number, a client-specific customer number, a driver's license number, an address, or any other identifier associated with the consumer who made the purchase that generated the sales data. In some embodiments, the customer identifier can be unique to an individual consumer (e.g., a driver's license number), or it can be a customer identifier shared by a multiple consumers. For example, a single credit card number may be shared by multiple members of a single family, and the multiple family members may be tracked as a single customer for purposes of the risk assessment and/or other determinations made by the decision engine 135.

The decision engine 135 may access information stored in a repository of customer identification data 137. The repository of customer identification data 137 may store information about a large number of customers, including, for example, information about customer names, addresses, identification numbers, such as driver's license and other identification numbers, biometric identification information, and the like. This information may be used in an effort to positively identify the customer 110. This information can also be used directly in the risk assessment, or other determinations. For example, a customer's 110 address may be an indicator that the requested merchandise return is fraudulent if previous fraudulent returns were made in connection with that address.

In some embodiments, the customer identification data 137 can include stored associations or links between various customer identifiers. For example, if a customer 110 makes a purchase using a first credit card and a customer loyalty card, and then later makes a purchase using a second credit card and the same customer loyalty card, each of the first credit card number, second credit card number, and customer loyalty number can be associated together as representing a single customer. Thus, if the customer later makes a return of merchandise purchased using the first credit card, without the loyalty card, the decision engine 135 will be able to locate and evaluate not only prior purchases and returns made using the first credit card, but also those made using the second credit card or using the customer loyalty card. Many variations are possible. A group of transactions linked based on the customer identifiers may be referred to herein as a group of linked transactions or a group of linked transaction records.

The decision engine 135 may use information from a repository of customer return data 140, which includes a wide variety of information about past merchandise return activity associated with the customers 110. The decision engine 135 may also used information from the repository of sales data, which includes a wide variety of information about past purchases associated with the customers 110. Using the customer identification data 137, the customer return data 140, and the sales data, allows the decision engine 135 to link information about past merchandise purchases and returns with the customer 110 requesting the return at the point of return 125.

The decision engine 135 may base the risk assessment, or other determinations, based at least in part on stored client data 145 that may include any of a wide variety of types of information associated with the client 120, including, but not limited to: information about the location(s) of the client's stores or other establishments, information about the client's employees (including names, identification numbers, hire dates, home addresses, past association with proper, fraudulent, and/or questionable merchandise returns, and the like), and information about the client's inventory of merchandise.

In some embodiments, a “negative file,” such as a listing of customers 110 who are known to have been involved with past fraudulent returns or past criminal activity, may be maintained and used to make return authorization determinations. In some embodiments, one or more “positive files” may be kept that list customers who may be accorded special treatment by the return authorization service. For example, one or more positive files may be maintained to list customers known to be profitable to the client and/or customers in the fashion industry, or other categories of customers, who may be accorded special return privileges. Such positive files may be used to make risk assessments or other determinations.

Furthermore, the decision engine 135 may additionally or alternatively access and make use of information stored in data repositories that are external to the return authorization service 102. External data sources 160 may be used to access information such as, for example: customer and/or employee identification information, address information including postal box information, credit data, shoplifting data, crime data, identification theft data, sales tax data, or any of a wide variety of other useful information types. Such external data 160 may be accessed externally on an as-needed basis and/or may be stored by the return authorization service 102 for subsequent use.

The functions of the decision engine 135 may be carried out in any of a wide variety of suitable, computer-implemented forms, such as a decision tree, an expert system, or other ruled-based decision system, as a linear calculation or other scoring mechanism, or as a form of probabilistic or neural network, genetic, or other statistical model or algorithm for decision-making.

For ease of description, the return authorization service 102 as depicted thus far in the disclosure and with reference to FIG. 1 has been described as providing merchandise return authorizations and other related services to a single client 120. However, it is to be understood that, in practice, it may be much more common for the return authorization service 102 to serve a plurality of clients 120. When the return authorization service 102 serves a plurality of clients 120, it may maintain an associated plurality of data stores, including, but not limited to: the customer return data repository 140, the client data repository 145, the client return authorization policies 150, the client warning issuance policies 155, the client coupon issuance policies, and sales data for each of the clients 120 for whom it provides return authorization services. The return authorization service 102 may maintain these data stores separately, either logically and/or physically. Furthermore, the return authorization service 102 may combine some or all of the various data stores described above.

In some embodiments, agreements may be implemented allowing clients to share their collected data for risk assessment or return authorization purposes or other determinations. In some embodiments, data collected from various clients may be maintained separated, logically and/or physically. Thus, if a customer 110 makes a return request at a particular client, the authorization determination may be based only on data collected in connection with that particular client (e.g., prior purchases and returns made with the particular client), or it can be based on data collected from various clients.

Although a wide variety of embodiments exist, for ease of description in this disclosure, it will be assumed that the embodiments of the return authorization service 102 described herein maintain data received from different clients 120 separately, and do not use data received from one client to make an authorization return determination for another client. In other embodiments, however, modifications may be made to the systems and methods described herein such that the systems and methods may store data from a plurality of clients together and/or may use data from one client in a return authorization request from another client. Furthermore, data from external third-party data providers, such as government information sources, credit bureaus, police information sources, and the like may be used by the return authorization service 102 to make determinations for the client 120.

Once the decision engine 135 has made an authorization determination for the requested return, the communication interface 130 may send a message to the POR device 126, informing the clerk of the determination. In some embodiments, the point of return device 126 may then print a record of the requested return, indicating that the return has been accepted or denied. The record may include associated explanations, and, in some embodiments, a warning about limitations on the acceptance of future merchandise returns from the customer 110. In some embodiments, the record may include a coupon or other offer for the customer.

The return authorization service 102 and included modules 130, 135, 137, 140, 145, 150, and 155, as depicted in FIG. 1, are one embodiment of a return authorization service 102 in connection with the systems and methods described herein. It is to be understood that in other embodiments, the structures and functions of these modules may be implemented in a wide variety of different configurations. For example, some or all of the data storage functions, the decision-making functions, the communications functions, and the like, may be provided by external third-party service providers, may be implemented at one or more client locations, including within the POR device 126, and/or may be implemented differently using different internal structures. Furthermore, although the return authorization service 102 is depicted in FIG. 1 as being a single entity located at a single location, it is to be understood that in other embodiments, the structures and functions of the return authorizations service 102 may be implemented in total or in part by a distributed system of hardware and software that may be located at two or more physically distinct locations.

As illustrated in FIG. 1, the electronic monitoring system 100 can include a customer identifier extraction service 170. The customer identifier extraction service 170 can be configured to receive sales data and a receipt identifier for a requested return, identify sales data associated with the receipt identifier, extract a customer identifier from the identified sales data, and transfer the customer identifier to the return authorization service 102. The return authorization service 102 can be configured to receive an authorization request and a customer identifier, make a return authorization determination (or other related determinations), and communicate the determination(s) to the client 120.

Communication between the client 120, the customer identifier extraction service 170, and/or the return authorization service 102 may be carried out using any of a wide variety of appropriate devices and/or communications and data security technologies such as using the Internet or other global network. In other embodiments, the communications may be carried out using any communication system including by way of example, dedicated communication lines, telephone networks, wireless data transmission systems, two-way cable systems, customized computer networks, interactive kiosk networks, automatic teller machine-type networks, interactive television networks, and the like.

The customer identifier extraction service 170 and a return authorization service 102 can be implemented as separate entities whose services are contracted or otherwise provided to the client 120. In some embodiments, the customer identifier extraction service 170 can be implemented as one or more software and/or hardware components under the operation of the client 120 that function in the POR device 126 and/or within one or more computer devices at the point of return 125, at another location within the same physical client establishment and/or at a geographically removed location used by the client 120 (e.g., an identify device associated with the client 120).

The customer identifier extraction service 170 can include a communication interface 171, a customer identifier extractor 172, a sales data repository 174, and a customer identifier data repository 176. Sales data can be transferred from a client 120 to the communication interface 171 and stored in the sales data repository 174. When a customer 110 presents merchandise to be returned, the clerk at the client point of return 125 may receive a receipt from the customer 110 and input (e.g., scan) a receipt identifier from the receipt (e.g., using a POR device 126). The receipt identifier can be sent to the customer identifier extraction service 170 via the communication interface 171.

The customer identifier extractor 172 can use the receipt identifier to identify the sales data in the repository that is associated with the original purchase of the merchandise being returned. The customer identifier extractor 172 can then extract a customer identifier from the identified sales data. In some embodiments, the customer identifier data repository 176 can include stored associations or links between various customer identifiers, to tie various customer identifiers to a single customer, as described above. In some embodiments, the communication interface 171 can send a single customer identifier to the return authorization service 102, or a list of customer identifiers can be sent so that the return authorization service 102 can access a more complete set of data in connection with the requested return. If the customer identifier extractor 172 is unable to extract a customer identifier, a notification can be communicated to the client 120 to request a form of ID (e.g., driver's license) from the customer 110.

In some embodiments, the customer identifier extraction service 170 can compile a summary of the relevant sales data (e.g., relating to prior purchases associated with the extracted customer identifier(s)) and send the summary to the return authorization service 102 for use in making determination(s). Thus, in some embodiments, the return authorization service 102 can consider prior purchases made by customers 110 without directly storing the client's 120 sales data. This can be advantageous, for example, in embodiments in which the customer identifier extraction service 170 is under control of the client 120 and the client 120 is not willing to allow outside entities direct access to its sales data. In some embodiments, the return authorization service 102 can have direct access to the sales data for use in making determination(s).

The return authorization, or other determination(s), can be transferred to the client 120 using the communication interface 130, for example, as a message to the POR device 126. The clerk or POR device 126 can inform the customer of the return authorization decision, can issue a warning to the consumer, and/or can offer a coupon or other offer to the consumer, as dictated by the determination(s) made by the return authorization service 102.

As illustrated in FIG. 1, the electronic monitoring system 100 can include an identification service 180. The identification service 180 can be configured to receive customer identifiers and linked transactions from the customer identifier extraction service 170 and nominate a group of linked transactions based on a set of client-specific thresholds. The client 120 can be configured to receive the nominations generated by the identification service 180. In some embodiments, instead of receiving the linked transactions from the customer identifier extraction service 170, the identification service 180 identifies the linked transactions based on client data or other return authorization data received from the client 120 and/or the return authorization service 102.

The embodiment of the identification service 180 that is depicted in FIG. 1 includes a nomination engine 182, a client-specific rule determination engine 184, a client interface 186, a metric derivation engine 188, identification policies 190, a repository of client data 192, and a repository of nomination data 194. Other embodiments of the identification service 180 may include other components (e.g., employee fraud determination engine, SKU anomaly determination engine, user interface generation engine, alert engine, etc.) and/or a subset of these components. For example, some embodiments may include only the nomination engine 182 and may access information from other sources, and some embodiments may omit components shown in FIG. 1. Additionally, some components shown in FIG. 1 may be divided into multiple components, or combined together. For example, the nomination engine 182 can be used to make the nomination determinations, client-specific rule determinations, metric derivation, return fraud identification, user interface generation, alert generation, etc., or multiple decision engines can be used. Also, a single database can include some or all of the data repositories shown in FIG. 1, or multiple databases can be used.

The communication interface 186 can receive data from the client 120, the return authorization service 102, the customer identifier extraction service 170, and/or any other sources. Such data may be sent periodically or intermittently to the communication interface 186. For example, the return authorization service 102 can transfer a batch of return authorization data to the communication interface 186 once each day (e.g., after the store closes), once every two days, once each week, twice each day, once each hour, or at any other suitable frequency. In some embodiments, the data can be sent to the communication interface 186 on a per-transaction basis with little or no delay after the purchase transaction. The communication interface 186 may also transmit nominations to an identify device associated with the client 120 (e.g., located at or near the point of return, at the same store location(s) associated with the nominated groups of linked transaction, and/or at a headquarter location associated with the client 120)

The client-specific rule determination engine 184 may determine various threshold levels used by the nomination engine 182 to nominate transactions or groups of transactions. The thresholds may be specific to the location, hours, purchase and return volume, customer base, or other characteristics of the client 120. The metric derivation engine 188 may determine various metrics, parameters, and variables used by the nomination engine 182 to nominate transactions or groups of transactions. For example, the metric derivation engine 188 may determine, based on the client data or the return authorization data, which variables should be generated or monitored. The identification policies 190 may include additional policies that are used by the nomination engine 182 to nominate transactions or groups of transactions. For example, if a SKU category is identified as a problem SKU category, a return authorization policy may provide an indication that any return requests of items in the SKU category are to be automatically nominated by the nomination engine 182.

The client data 192 may include sales data and return authorization data generated by the client 120 and/or the return authorization service 102 and the customer identifier and linked transactions generated by the customer identifier extraction service 170. Additionally, the client data 192 may include any of a wide variety of types of information associated with the client 120, including, but not limited to: information about the location(s) of the client's stores or other establishments, information about the client's employees (including names, identification numbers, hire dates, home addresses, past association with proper, fraudulent, and/or questionable merchandise returns, and the like), and information about the client's inventory of merchandise. The nomination data 194 may include nominations generated by the nomination engine 182, including transactions, consumers, employees, SKU categories, etc.

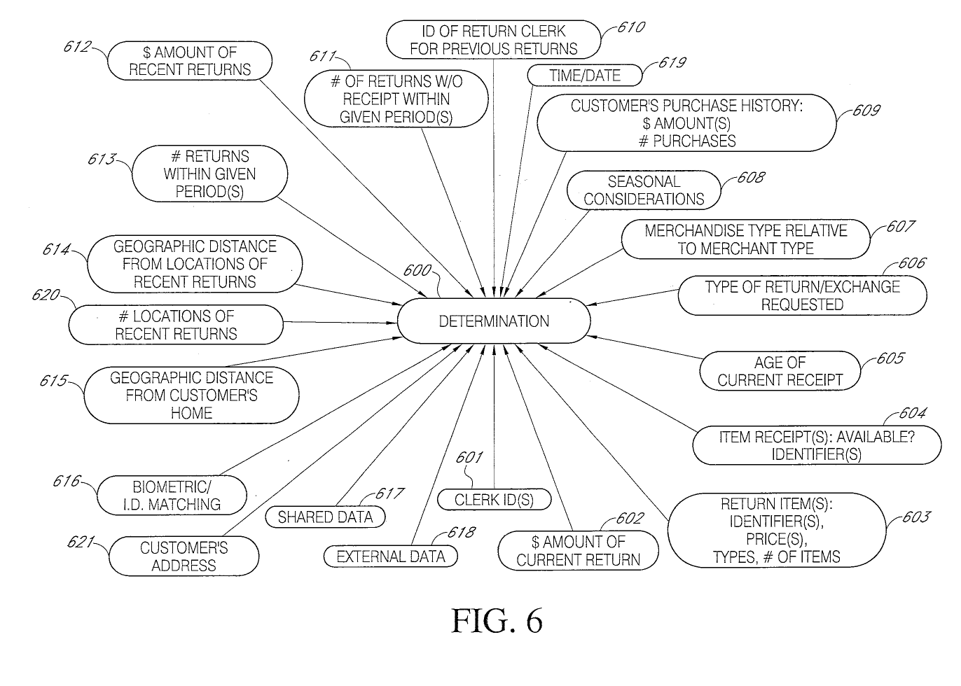

As will be described with reference to FIG. 6, in various embodiments, the determination of whether to nominate a group of linked transaction records may depend on a wide variety of factors. The identification service 180 is described in greater detail below with reference to FIG. 7.

In some embodiments, the identification service 180 may be implemented, as depicted in FIG. 1, as an external entity whose services are contracted or otherwise provided to the client 120. Additionally or alternatively, the identification service 180 may be implemented as one or more software and/or hardware components under the operation of the client 120 that function in the POR device 126 and/or within one or more computer devices at the point of return 125, at another location within the same physical client establishment and/or at a geographically removed location used by the client 120 (e.g., an identify device associated with the client 120). Thus, although the systems and methods described herein are most often described in association with an external identification service, it is to be understood that any combination of these or other implementation arrangements may be used.

In embodiments where the identification service 180 is a separate entity that provides nominations based on the returns processed by the client 120, communication between the client 120 and the identification service 180 may be carried out using any of a wide variety of appropriate devices and/or communications and data security technologies. For example, the communications between a computerized device at the client 120 and a communication interface 186 at the identification service 180 may be carried out using the Internet or other global network. In other embodiments, the communications may be carried out using any communication system including by way of example, dedicated communication lines, telephone networks, wireless data transmission systems, two-way cable systems, customized computer networks, interactive kiosk networks, automatic teller machine-type networks, interactive television networks, and the like.

For ease of description, the identification service 180 as depicted thus far in the disclosure and with reference to FIG. 1 has been described as providing nominations and other related services to a single client 120 (e.g., via an identify device associated with the client 120). However, it is to be understood that, in practice, it may be much more common for the identification service 180 to serve a plurality of clients 120. When the identification service 180 serves a plurality of clients 120, it may maintain an associated plurality of data stores, such as, for example, the client data repository 192 and the nomination data repository 194 for each of the clients 120 for whom it provides the identification and nomination services. The identification service 180 may maintain these data stores separately, either logically and/or physically. Furthermore, the identification service 180 may combine some or all of the various data stores described above.

The identification service 180 and included modules 182-194, as depicted in FIG. 1, are one embodiment of an identification service 180 in connection with the systems and methods described herein. It is to be understood that in other embodiments, the structures and functions of these modules may be implemented in a wide variety of different configurations. For example, some or all of the data storage functions, the decision-making functions, the communications functions, and the like, may be provided by external third-party service providers, may be implemented at one or more client locations, including within the POR device 126, and/or may be implemented differently using different internal structures. Furthermore, although the identification service 180 is depicted in FIG. 1 as being a single entity located at a single location, it is to be understood that in other embodiments, the structures and functions of the identification service 180 may be implemented in total or in part by a distributed system of hardware and software that may be located at two or more physically distinct locations.

### Example Configuration of Nomination Service

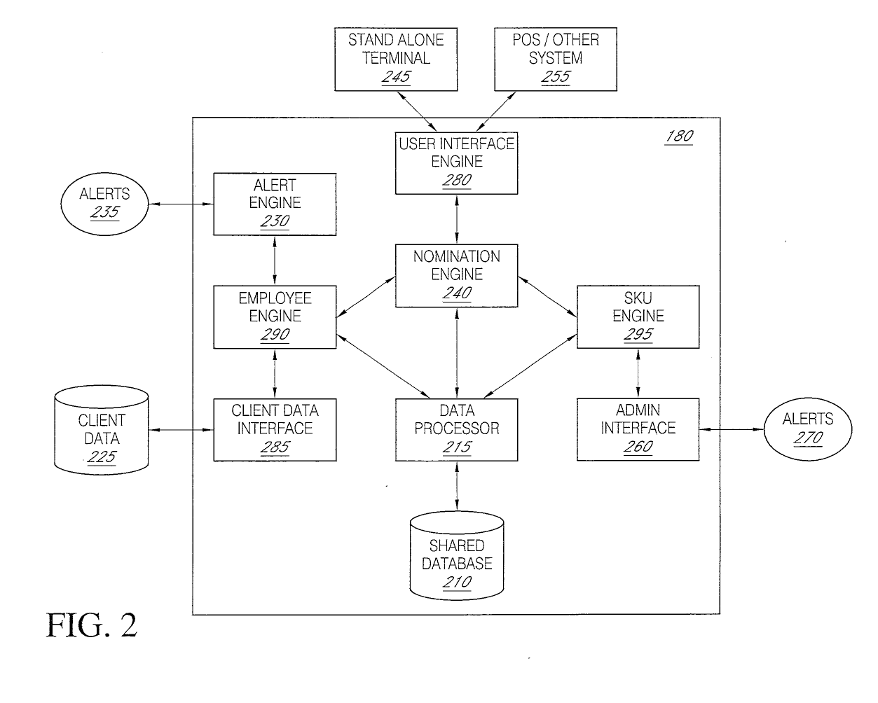

FIG. 2 is a block diagram depicting a closer view of one embodiment of an identification service 180 that provides a variety of services to the client 120. As depicted in FIG. 2, the various repositories of data used by the identification service 180 are combined conceptually as a single shared database 210. As described with reference to FIG. 1, the data stored for use by the identification service 180 may be stored and maintained as a single or a plurality of data repositories.

The data in the shared database 210 is managed by a data accessor 215 that receives data for storage in the shared database 210 from a variety of sources and that receives requests for data from the shared database 210 for a variety of purposes. In various embodiments, the data accessor 215 may manage the various types of data using any of a variety of computer-implemented platforms suitable for such purposes, including, but not limited to, DB2, Oracle, or other SQL-based systems.

As depicted in FIG. 2, client data 225 associated with a client 120 may be sent to a client data interface 285 of the identification service 180 for storage in the shared database 210 by the data accessor 215. The client data 225 may include sales data and return authorization data generated by the client 120 and/or the return authorization service 102 and the customer identifier and linked transactions generated by the customer identifier extraction service 170. Client administrators 270 may use an administrative interface 260 of the identification service 180 to send and receive data to the data accessor 215.

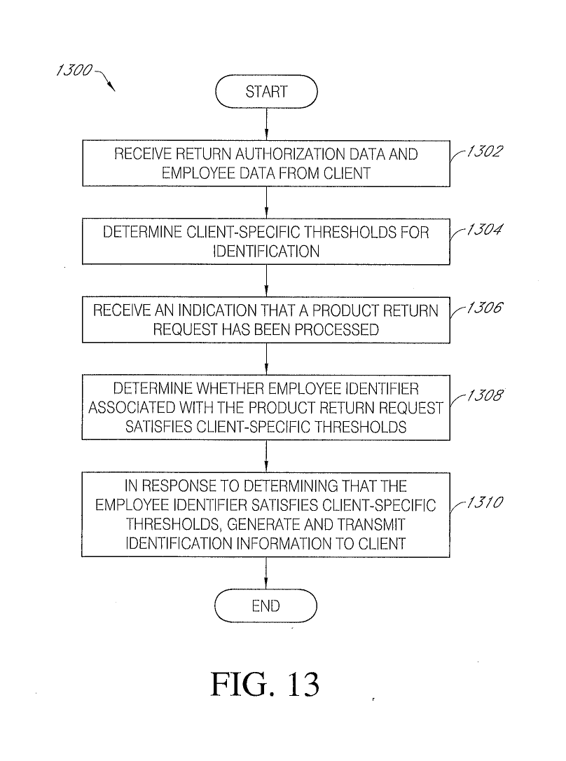

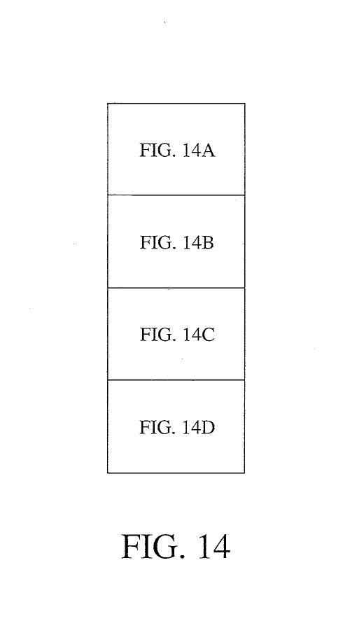

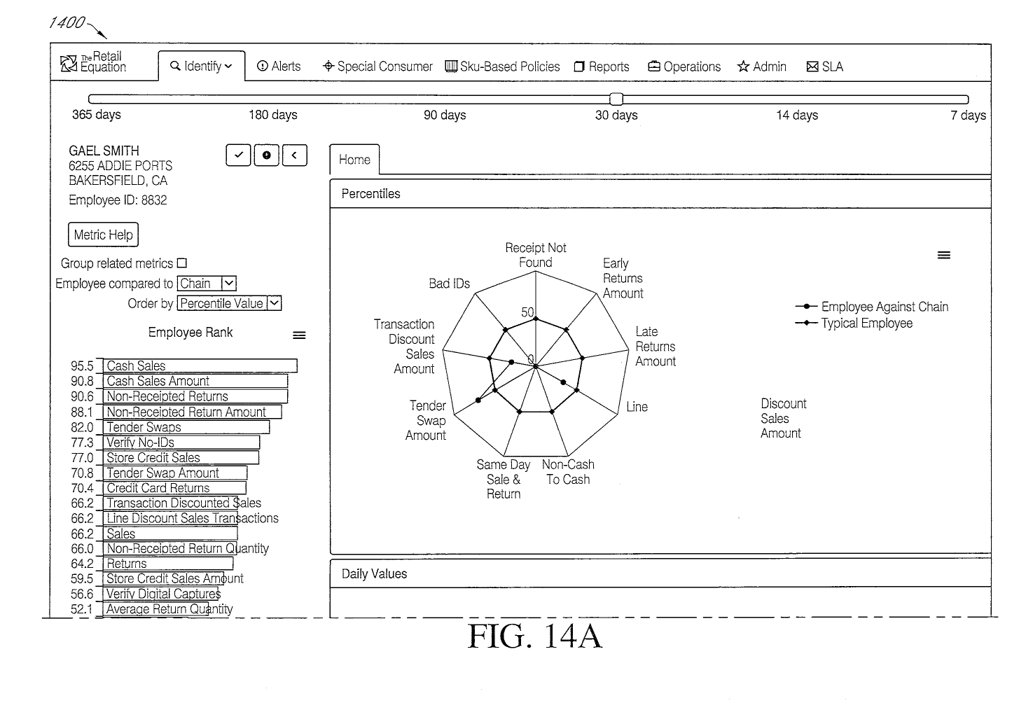

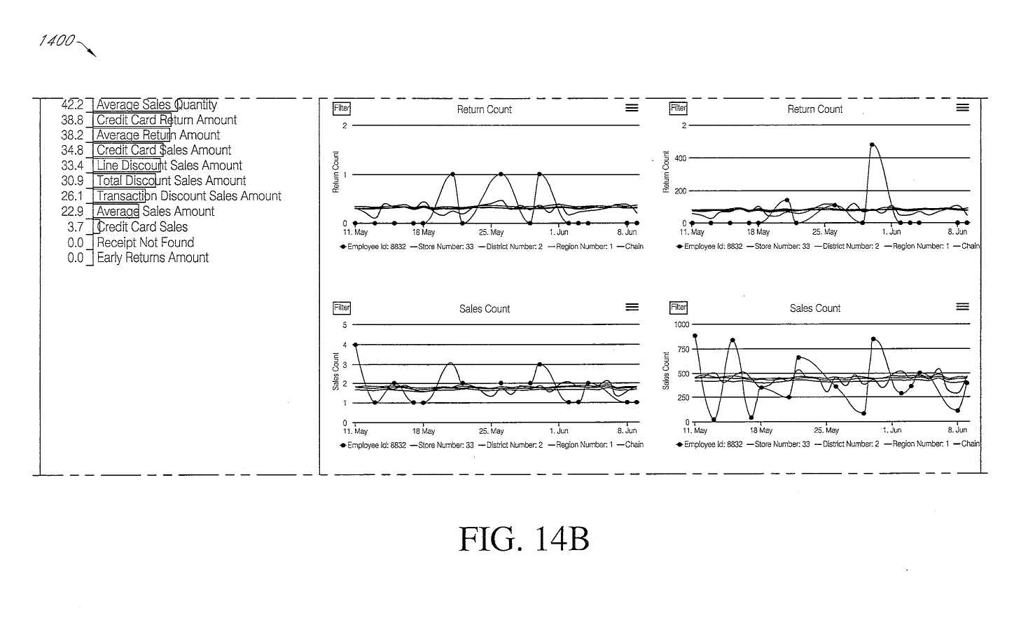

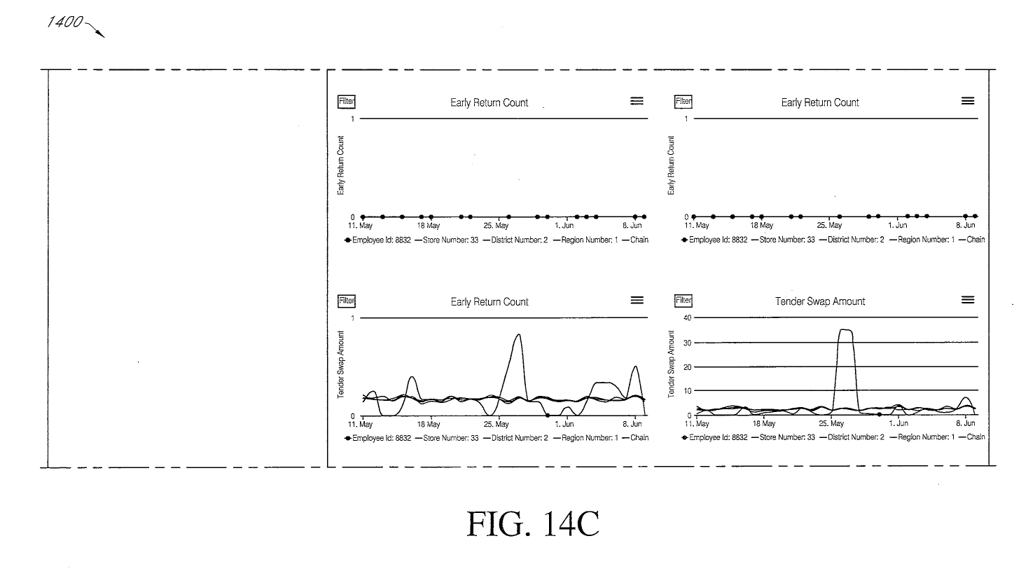

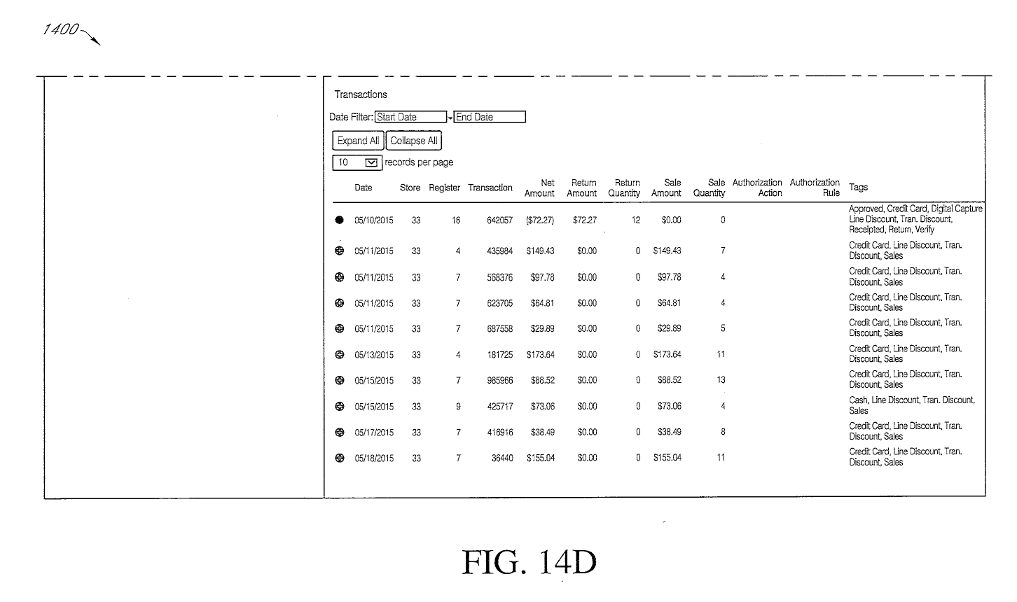

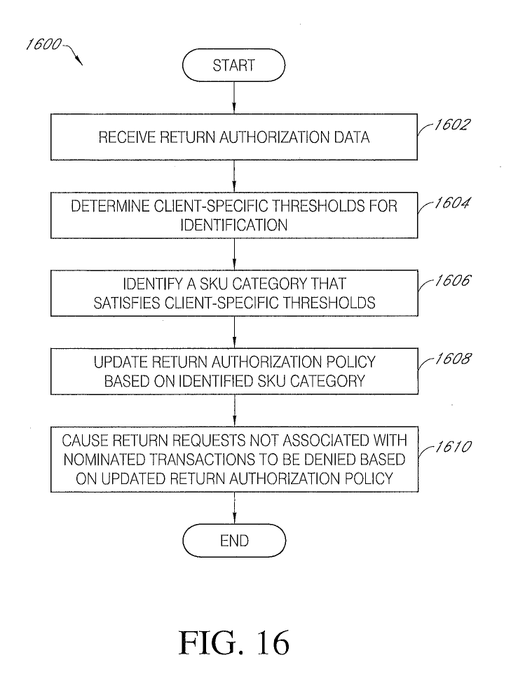

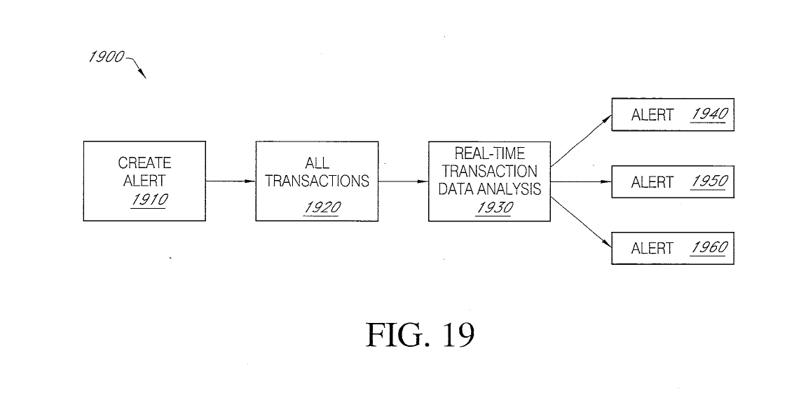

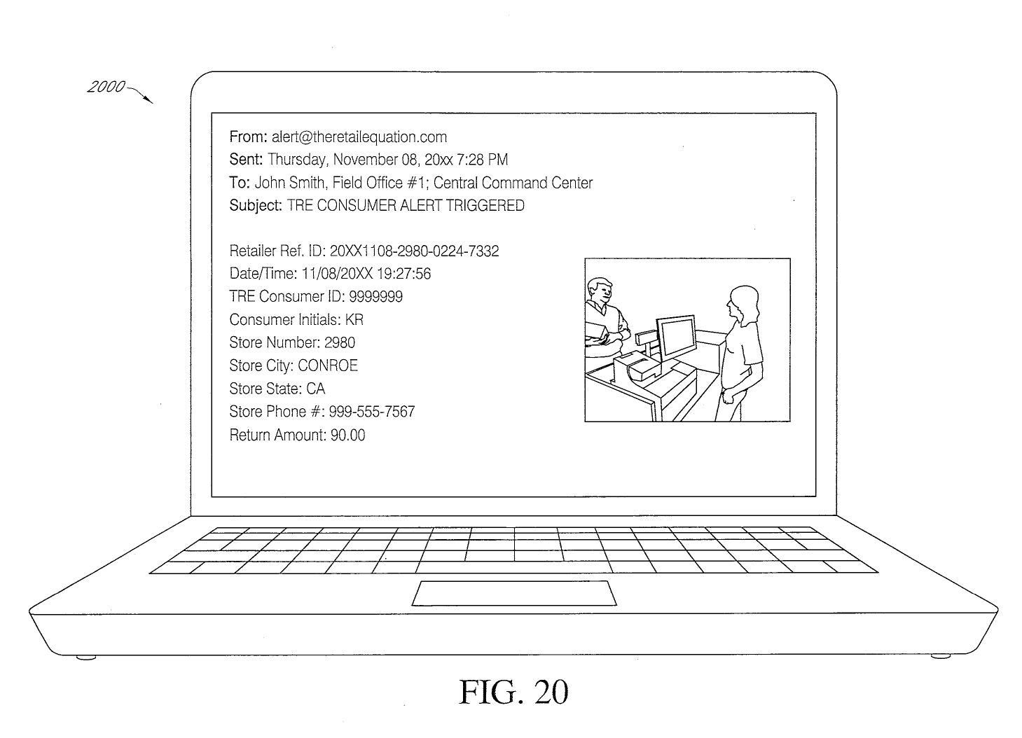

The data accessor 215 may further provide data to an alert engine 230 that provides alert services 235 to the client 120. The alert services 235 are described in greater detail below with reference to FIGS. 19 and 20. The data accessor 215 may further provide data to an employee engine 290 that identifies employee fraud. The employee engine 290 is described in greater detail below with reference to FIGS. 13 and 14. The data accessor 215 may further provide data to a SKU engine 295 that identifies SKU anomalies. The SKU engine 295 is described in greater detail below with reference to FIGS. 16-18.

A nomination engine 240 (e.g., similar to nomination engine 182 in the example of FIG. 1) provides generates nominations of linked transactions and provides the nominations to the client 120 based on the data received from the data accessor 215, employee engine 290, and the SKU engine 295. A user interface engine 280 may generate a user interface based on the nominations received from the nomination engine 240. The user interface generated by the user interface engine 280 may include graphical illustrations of the nominations and recommendations regarding client action that can be taken based on the nominations.

As depicted in the embodiment shown in FIG. 2, the user interface engine 280 may communicate directly with a stand-alone terminal 245 that is dedicated for point of return use. The user interface engine 280 can be configured to communicate with a point of sale (POS) or other system 255 used by the client to process merchandise returns and/or to communicate with the identification service 180. Alternatively, the nomination engine 240 may communicate directly with the stand-alone terminal 245 and the POS or other system 255.

In various embodiments, transfer of some or all of the data into and out from the identification service 180 may be implemented, for example, using FTP transfer protocols. For protection of consumer privacy and client business information, the data is preferably transferred into and out from the return authorization service 102 in an encrypted form, for example using PGP (Pretty Good Privacy) or other suitable encryption technology.

The functions and/or components of the identification service 180 described with reference to FIG. 2 may be implemented, in some embodiments, as a plurality of servers operating as a server farm under the management of any of a variety of clustering technologies. Such an arrangement typically allows for relatively seamless replacement of components as well as upgrades and additions to the system as transaction volume increases.

Furthermore, the functions and/or various modules of the identification service 180 may be implemented in various embodiments using personal computers (PCs), workstations, other processors, program logic, or other substrate configurations representing data and instructions, which operate as described herein. In various embodiments, the processors may comprise controller circuitry, processor circuitry, processors, general purpose single-chip or multi-chip microprocessors, digital signal processors, embedded microprocessors, microcontrollers and the like.

### Point of Return (POR) Device

FIG. 3 depicts one embodiment of a dedicated point of return (POR) device 300 for use in processing merchandise returns. The POR device 300 can be configured to use a telephone dial-up connection or network cable connection to communicate with the return authorization service 102. In other embodiments, one or more other wired or wireless communications systems are used for communicating with the return authorization service 102. In some embodiments, some or all of the functions provided by the return authorization service 102 may be provided by components that are internal to the POR device 300.

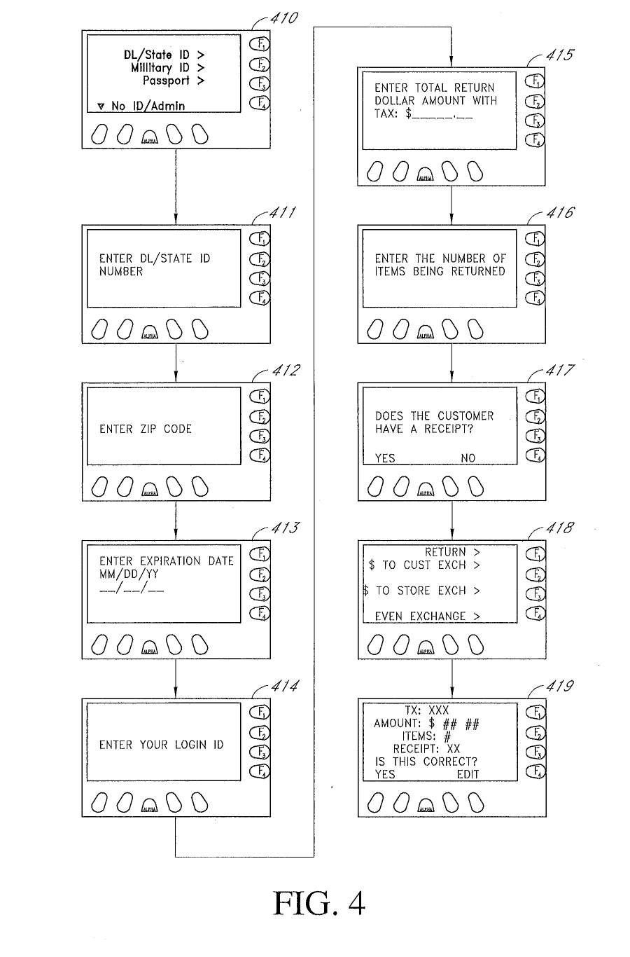

As depicted in FIG. 3, the POR device 300 includes a display screen 310 for communicating visually with a clerk or other person handling the requested return transaction. Examples of communications that may be presented on the display screen 310 are described with reference to FIG. 4 below. In other embodiments, the POR device 300 may include audio speakers, video display, or any of a wide variety of other communications technologies for communicating information to the clerk.

The POR device 300 also includes a keyboard 315 with a plurality of buttons that allow the clerk to input information to the POR device 300. Additionally, other buttons and input systems in other parts of the POR device 300 also allow the clerk to input information to the POR device 300. In other embodiments, any of a wide variety of other input systems, such as voice recognition systems, keyboards, touch screen systems, camera or video systems, biometric systems, and the like, may be used additionally or alternatively for allowing the clerk to input information into the POR device 300. Furthermore, other forms of electronic reading devices, including, but not limited to, 1-dimensional, 2-dimensional, or 3-dimensional barcode scanners, magnetic stripe readers, readers for other electronically-readable codes, RFID readers, any of a wide variety of biometric data input devices, and the like, may be used to input data to the POR device 300. For example, the POR device 300 depicted in FIG. 3 includes a built-in magnetic stripe reader 320 for scanning identification cards, credit cards, and the like that include a magnetic stripe, and a peripheral 2-dimensional bar code scanner 325 for reading cards or other items provided with a 2-dimensional barcode. Other peripherals for inputting data about a wide variety of other identification and informational sources may also be used.

As shown in FIG. 3, the POR device 300 may be configured to produce a paper receipt 330 or other record of the merchandise return transaction for the customer 110 and/or for the clerk on behalf of the client 120. In other embodiments, a record of the transaction may be provided to the customer 110 using email or other electronic communications technology. Where the customer 110 is requested to sign a record of the return transaction, the POR device 300 may include a system for electronically capturing the signature or other form of customer acknowledgement. In some embodiments, an indication of a warning provided to the customer 110 at the point of return 125 is printed, or otherwise displayed, on the receipt 330, on the display 310, or on a separately printed paper. In some embodiments, a coupon or other offer for the customer 110 is printed, or otherwise displayed, on the receipt 330, on the display 310, or on a separately printed paper.

As described above, the functions of the POR device 300 may additionally or alternatively be provided by other types of electronic devices, such as a suitably programmed and configured point of sale (POS) terminal, cash register terminal, or other device that may process merchandise returns as well as other types of transactions and that may use technologies such as biometrics, bar-code readers, and the like.

### Example User Interface of POR Device

FIG. 4 depicts a series of sample user interface screenshots 410-416 for one embodiment of a process for collecting data at a point of return 125. The screenshots 410-416 depicted in FIG. 4 exemplify screenshots that may be presented on a display screen 310 of a POR device 300 such as the one depicted in FIG. 3. The screen shots 410-416 represent prompts to the clerk to input information associated with the requested merchandise return so that a return authorization determination may be made for the requested return.

In screenshot 410, the clerk is prompted to enter a login ID or other employee identification number used to identify the clerk processing the return. In some embodiments, a password is required to prevent a clerk from entering an inaccurate login ID. In screenshot 411, the clerk is prompted to enter whether the customer 110 has a receipt for the items being returned. If the customer does have a receipt, screenshot 412 prompts the clerk to enter the receipt number. The receipt number can be entered using the key pad 315 or read from a barcode on the receipt using the scanner 325. In screenshot 413, the clerk is prompted to scan the products being returned. A bar code on the products can be scanned using the scanner 325, or alternatively, the clerk can user the keypad 315 to enter a Stock Keeping Unit code (SKU), a Universal Product Code (UPC), or other number that identifies the products being returned.

In screenshot 414, the clerk is presented with a summary of the inputted transaction information. The return transaction can be assigned an identification number, as shown in screenshot 414. The clerk can be prompted to verify that certain information (e.g., the exchange dollar amount and number of items) is correct. The clerk may also be prompted to verify whether a purchase receipt has been provided with the return request. The clerk provides an input indicating either that the information is correct or that the information needs to be edited.

If the customer does not have a receipt for the return, the clerk may be presented with screenshot 415, which prompts the clerk to indicate which kind (if any) of identification verification the customer 110 is providing. In Screenshot 416, assuming that the clerk indicates that the customer 110 is presenting a driver's license or other state identification card, the clerk is now prompted to input the driver's license number or state identification card number. As was discussed above, this information may be keyed in, read electronically from a magnetic stripe, barcode, or other smart card reader, or input using any of a wide variety of other input technologies.

Furthermore, in various embodiments, if desired, the POR device 126 may be configured to alternatively or additionally accept input about other types of identification, such as other types of U.S. government-issued identification numbers, or Canadian or Mexican identification numbers. Examples of identification that may be used, alone or in combination with one another, include, but are not limited to numbers, identifiers or other data associated with: student identification, military identification, passport, voter registration card, Immigration and Naturalization Service documents (such as a green card or laser visa), consular identifications (matricula consular and others), loyalty card, gift card, coupon, merchandise credit slip, receipt authorization code, checking account, receipt date or other combination of receipt data identifiers, name, address (current and/or past), data of birth, phone number, SSN, credit card, debit card, biometrics (photo, face, fingerprint, voice, DNA, retinal), employer identification number, digital image of the customer obtained from license, customer birth date and/or age, driver's license expiration date, security system number, and many other types of accounts and identifiers.

Once the customer ID has been entered, the clerk can be presented with screenshot 413 as described above. The screenshots of FIG. 4 have been provided as an example of a POR device 126 user interface interaction for inputting information about a requested merchandise return. As will be familiar to one of skill in the art, a wide array of variations may exist in the exact methods used to obtain information about the requested return at the point of return 125. The content and order of screenshot displays, for example, may be different than those depicted in FIG. 4, and, in fact, the clerk may be expected to input the relevant data in response to an interactive voice response (IVR) system or without the use of prompts at all. In some embodiments, the POR device 126 may be configured to allow for the collection of some or all of the following additional information: retailer identification, consumer name and address, customer zip code, current price of the returned items, product condition, customer's stated reason for making the return, purchase date, time, tender type, and original salesperson, ID expiration date, requested return type (e.g., cash exchange, credit to account, even exchange for merchandise, or merchandise exchange with balance due either to the client or to the customer), as well as other types of information.

Furthermore, the POR device 126 may preferably be configured to automatically transmit some additional information to the return authorization service 102 with the request for authorization determination. For example, an identifier associated with the POR device 126 may be transmitted to the return authorization service 102 and may be used to identify the client 120, the store branch or other location at which the point of return device 126 is located, as well as the date and local time of the requested return transaction, and the like.

In some embodiments, the POR device 126 is configured to transmit an indication a product return request has been received, processed, denied, or granted to another component of the electronic monitoring system 100. For example, the POR device 126 may, in response to receiving, processing, denying, or granting a product return request, transmit a corresponding indication to the identification service 180.

### Nomination Model

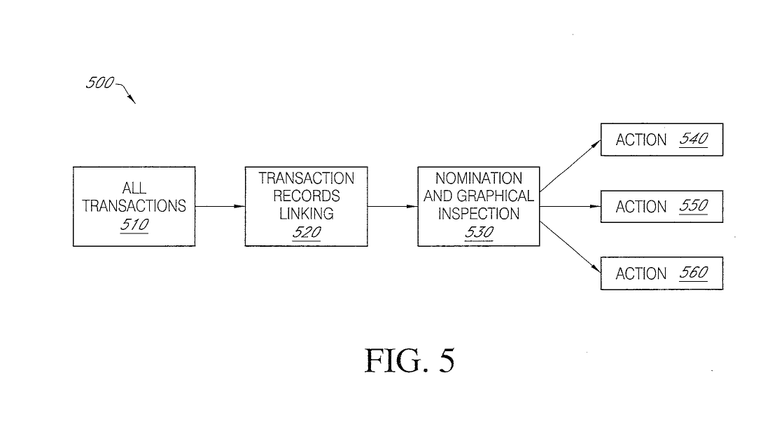

FIG. 5 depicts one embodiment of a nomination model architecture 500 that may be used to provide nominations to the client 120 using the return authorization service 102, the customer identifier extraction service 170, and the identification service 180. In various embodiments, the identification service 180 may accept information available at the time of a merchandise return transaction and provide a risk score or other assessment that represents a relative likelihood that the requested return is abusive or fraudulent. Alternatively or additionally, the identification service 180 may provide a list of nominations to the client 120 based on such risk scores determined based on the historical transaction and return authorization data. In some embodiments, the nominations provided by the identification service 180 may be integrated into a return authorization process to provide an authorization determination to a clerk processing the return transaction at the point of return 125 or to provide recommendations to a manager or administrator associated with the client 120 regarding further action that can be taken based on the nominations.

As depicted in FIG. 5, transaction data collected by the client 120 (e.g., return data, purchase data, return authorization data, the location of the return request, the clerk processing the return, etc.), together with existing stored data which may comprise information about the customer, the clerk, the store, and/or other stored data (collectively transactions 510), are processed to create linked transaction records 520. Based on the linked transaction records, the identification service 180 generates and nominates a group of linked transaction records for transmission to the client 120. As illustrated in FIG. 5, the generated nominations allow the client 120 graphically inspect the nominated group of linked transaction records. The identification service 180 may further generate and provide recommendations (e.g., actions 540-560) regarding further action that can be taken by the client 120 in view of the generated nominations. For example, the recommendations may include denying future return requests by individuals associated with the nominations, placing the individuals associated with the nominations on a watch list, or immediately visiting the scene of the transaction associated with the nominations and further investigating the validity of the transaction by a manger or administrator of the client 120.

### Factors Used for Nomination

FIG. 6 depicts a set of factors that influence one embodiment of a process for making a determination 600 of whether to nominate a group of linked transactions for transmission to the client 120. In other embodiments, a different set of factors, including some, all, or none of the factors depicted in FIG. 6, may influence the determination 600. Furthermore, some or all of the factors may influence a determination of whether to authorize the requested return and/or whether to issue a warning or a coupon to the customer requesting that a merchandise return transaction be accepted.

Broadly speaking, the factors may include information about the current return, information about the customer's identification, information about the customer's past purchase, and/or return history, as well as general information about the store and other related data.

For example, as depicted in FIG. 6, factors associated with one or more transaction records used by the identification service 180 to generate the nominations may include information about an identifier 601 for the clerk handling the return, and in some embodiments an identifier for the clerk(s) who handled the associated purchase transaction, a dollar amount associated with the requested return 602, the items in the current return 603, a receipt for the items being returned 604, the age of the receipt 605, the type of return 606 requested by the customer, and the type of merchandise being returned relative to the client type 607. Other factors associated with the transaction records may include, but not be limited to, a location and/or identifier for the client, the day, date and/or time of the requested return 619, an amount of time lapsed since purchase of the items being returned, and information about other customers in the client location 120 during the time of the requested return transaction. Another factor that may be considered in making the determination 600 is the department or category of the item being returned. For example, in a department store, returns from a clothing department may be handled differently than returns from a sporting goods department. In some cases, products can be separated into categories (e.g., using SKU code categories) which can influence the determination 600. Thus, products in a single department or in a store that does not include separate departments (e.g., a specialty store) can be separated into distinct categories. As one possible example, in a sporting goods store or department, the return of skis or a snowboard may lead to an automatic warning to the customer that no returns of skis or snowboards may be made for a predetermined time (e.g., 6 weeks). Another factor which can influence the determination 600 is the location in the store where the return is being made. For example, a particular register within a client's store may be favored by abusers (e.g., a register near an exit, or a register in a department with little activity or far from a manager's office), and returns made at the fact that a customer selects this register for a return can influence the determination 600.

The dollar amount associated with the return 602 may include a net return dollar amount, for example, the dollar amount of the requested return without tax, or the net amount of the return with any discounts taken into consideration. The dollar amount 602 may additionally or alternatively include a net transaction amount that takes into consideration the amount of the return amount and the amount of any purchases and/or exchanges being made by the customer at the same time.

Information about items presented for return 603 may include information about one or more item identifiers (bar code, Stock Keeping Unit code (SKU), Universal Product Code (UPC), Radio Frequency Identifier (RFID), and the like), information about individual item prices and merchandise types, as well as a total number of items being returned.

Information about one or more purchase receipts 604 for the items being presented for return 604 may include, for example, date of the receipt, one or more data items that serve to identify the receipt, and whether a receipt is presented by the customer for each returned item. As described herein, the receipt can be used to locate the sales data associated with the purchases of the merchandise being returned, and one or more customer identifiers can be extracted from the located sales data. The customer identifiers can be used to identify or generate other variables used in making the determination 600. In some embodiments, the determination 600 may consider data associated with one or more additional customer identifiers 621, which were not extracted from the sales data for the particular receipt associated with the present return, but which were previously identified as belonging to the same consumer as a customer identifier that was extracted from the sales data for the present return.

Factors associated with the customer's identification may include a matching of the identification and/or biometric information 616 offered by the customer at the point of return 125 with stored identification and/or biometric information about the customer 110. For example, information about fingerprint, retina, voice and/or facial or other metrics may be used. Additionally, information about the customer's current and, possibly, past home addresses 620 may serve as a factor in the determination 600 that may be used to calculate the geographical distance 615 from the customer's home to the store. The customer's home address may also be compared to stored information about the clerk's home address in order to rule out a possibly fraudulent and usually forbidden processing of the return transaction by clerk who shares a home address with the customer 110. The customer's address can also be compared against a “negative list” of addresses known to be associated with fraudulent returns. In some embodiments, previous purchase data and/or previous returns data associated with other customers that share the same address as the customer 110 who is requesting the current merchandise return 622 can also influence the determination 600.

Additional information about the customer, such as, for example, birth date, state of residence, state of identification card, identification number, loyalty card number, gift card number, checking account number, coupon number, merchandise credit slop number, phone number(s), credit card number, check number, debit card number, receipt authorization code, license expiration date, and any information available may also be used as factors. In some embodiments, identification of the customer allows for determining whether the customer is included on a “positive list” of customers whose transactions may be automatically removed from the consideration for nomination (or have a reduced chance of being nominated), or a “negative list” of customers whose transactions may be automatically nominated (or have an increased chance of being nominated). Furthermore, other available types of information about the customer, such as credit information, check information address history, and possible shoplifting record or other criminal record information may also be useful as a factor.

In some embodiments information about the customer may be obtained from an ID provided by the customer (e.g., a driver's license). In some embodiments, the system may prompt the clerk to ask a customer who requests a merchandise return for proof of ID if no ID is yet on file for the customer identifier(s) extracted from the sales data associated with the provided receipt. For subsequent returns in which those customer identifier(s) are extracted, no proof of ID would be needed, and the customer information could be accessed by the association previously made to the customer identifier(s). In some embodiments, the identification service 180 can make the determination 600 without any proof of ID ever being obtained from the customer. Customer information may be obtained from external sources. For example, if a customer number is a credit card number used to make the merchandise purpose, customer information may be obtained from the credit card company. Also, a clerk may input customer information.

A wide variety of factors regarding the customer's history of purchase and/or return transactions may influence the determination 600. For example, two factors are the number of returns 613 and the dollar amount of the returns 612, as well as the dollar amounts and identifiers of the individual merchandise items, that the customer has requested within one or more recent periods of interest, including, in some embodiments, the occurrence of any denied return transactions. Dates, times, and locations of previous requested returns may be a factor, as well as previous return authorization scores or other assessments determined for the customer and past returns for the same items as the current return. Another factor is the number of non-receipted returns 611 that the customer has requested within one or more recent periods of interest. The identifiers for the clerks handling previous returns 610 and the geographic distances from the locations of other recent returns 614, the number of different locations of recent returns 623, as well as the number of returns within a pre-determined geographic area, may be used as factors in the determination 600. In addition, in some embodiments, information about the customer's purchase history 609 with the client, including, for example, dollar amounts, numbers of items, price and identifiers of individual items, and number of recent purchases, payment types and payment history, previous warnings received, previous authorization scores, may influence the determination 600. Additional factors of interest associated with the customer's past transactions may include information about discounts and/or credit associated with previous purchases and/or overrides associated with past returns, as well as past payment information.

In addition to the above-described factors, other factors may influence the determination 600, as suits the preferences of the client 120. As one example, the client 120 may desire to have seasonal considerations 608 influence the determination 600, for example, rejecting fewer returns during the holiday shopping season, or alternatively, allowing more returns while issuing more warnings. Seasonal considerations 608 may also affect subsequent determinations 600, such as in embodiments in which returns made during a holiday period are “weighed” less heavily against the customer than returns made at other times of the year. Current and/or past address data associated with employees may also be a factor, as well as override information associated with the employees.

Other types of information available from external sources 618, either publicly available free information and/or purchased information may serve as factors. For example, sales tax information, postal box information, census data, householding data, identification theft data, Department of Commerce data, credit data, bank data, check data, crime data, loan delinquency data, and the like may be received from sources external to the identification 180 and used to make a determination 600. Some or all such data 618 may be stored for later use and/or may be accessed from one or more external sources on an as-needed basis.

Furthermore, data that has been collected by other clients 617, including data collected in association with purchase and/or return transactions and authorizations, may be shared with the client 120 and used as factors in the determination 600.

With respect to the process for nominating a list of linked transaction records, any one of the factors described herein with reference to FIG. 6 or in any other portion of this disclosure may be used by, for example, the nomination engine 182 as a single or separate factor, or may be used in combination with any subset of the factors 601-623 to make a determination 600. For example, in some embodiments, customer identification information 616 may be used in conjunction with any one or more of the following types of information to make a determination: original receipt date, dollar amount of the return without tax, net return transaction amount, number of items being returned, SKU identifier(s) for returned item(s), RFID identifier(s) for returned item(s), and receipt identifier or combination of uniquely identifying data items for the receipt. In other embodiments, other single factors or combinations of factors may be used to make the determination 600.

Thus, the process for nominating one or more groups of linked transaction records may be highly customized to the business preferences of the client 120, if desired, and may be tailored to include factors deemed relevant and practical for the client's business.

Tables 1-10 illustrate additional factors that may be used to make the determination 600. For example, some or all of the additional factors may be used for identifying linked transactions, nominating groups of linked transactions, identifying employee fraud, identifying SKU anomalies, generating user interfaces, generating alerts, or any other processes described herein. In some embodiments, any combination of the factors described with reference to FIG. 6 and the factors included in Tables 1-10 may be used to determine whether to create associations between various identifiers and transactions, to identify a group of linked transactions, to nominate a group of linked transactions, to deny or approve a return request, etc. Any number of factors (e.g., two, three, four, or any other number of factors along with corresponding thresholds) may be used for making such a determination. For example, the identification service 180 may nominate a group of linked transactions if Factor A associated with the group satisfies Condition A′, Factor B associated with the group satisfies Condition B′, Factor C associated with the group satisfies Condition C′, and Factor D associated with the group satisfies Condition D′.

TABLE 1
Example types of data used for generating nominations

| Data Type | Examples |
|---|---|
| Transaction | a. Transaction key variables (store number, register number, |
| Data at | date, time, transaction number, etc.) |
| SKU Level | b. Employee ID |
| (Sales and | c. SKU |
| Returns) | d. Sequence number |
| | e. Line discount amounts |
| | f. Line discount codes |
| | g. Transaction discount amounts |
| | h. Transaction Discount codes |
| | i. Codes required to identify when a reward or incentive is |
| | redeemed. |
| | i. Override amounts |
| | j. Override codes |
| | k. Quantity |
| | l. Original price |
| | m. Actual price after discount |
| | n. Return reason |
| | o. Original transaction information (if returned item, |
| | includes original key variables) |
| | p. Void flags/Post void flags (to enable removal of voided |
| | items and transactions) |
| | q. Other relevant fields that help accurately describe the |
| | transaction detail |
| Tender Data | a. Transaction key variables |
| | b. Tender type (cash, check, Visa, MasterCard, AMEX, |
| | Discover, PayPal, etc.) |
| | c. Account ID |
| | d. Sequence number |
| | e. Routing number (for checking accounts) |
| | f. ID number and state (if collected on checks or other) |
| | g. First name/last name of account holder |
| | h. Amount |
| | i. Void flags/Post void flags |
| | j. Other relevant fields that help accurately describe the |
| | tender |
| Transaction | a. Transaction key variables |
| Summary | b. Transaction time |
| Data | c. Register number |
| | d. Employee ID |
| | e. Void flags/Post void flags |
| | f. Tax paid |
| | g. Sub total |
| | h. Total with tax |
| | i. Transaction type fields |
| | j. Driver's license number and State of issue (or other forms |
| | of ID) |
| | k. Customer (e.g. loyalty) information: number, name, |
| | address |
| | l. Other relevant fields that help accurately summarize the |
| | transaction |
| Miscel- | a. Other data dictionaries and code tables that are needed to |
| laneous | understand the fields provided. (e.g. tender code |
| | definitions) |

TABLE 2
Example types of data used for generating nominations

| Data Type | Examples |
|---|---|
| SKU/Item | a. SKU |
| Master Cross | b. UPC |
| Reference | c. Product Description (long description) |
| Table | d. Hierarchy of merchandise classification |
| | i. Department Code (or hierarchy level 1) |
| | ii. Department Description |
| | iii. Sub Department Code (or hierarchy level 2) |
| | iv. Sub Department Description |
| | v. Class Code (or hierarchy level 3) |
| | vi. Class Description |
| | vii. Sub Class Code (or hierarchy level 4) |
| | viii. Sub Class Description |
| | e. Brand/manufacturer |
| | i. Brand Code |
| | ii. Brand Description |
| | iii. Sub Brand Code |
| | iv. Sub Brand Description |
| | f. Color/size/style |
| | i. Color Code |
| | ii. Color Description |
| | iii. Size Code |
| | iv. Size Description |
| | v. Style Code |
| | vi. Style Description |
| | g. Item cost (optional, except for Return Rewards) |
| | h. Other relevant fields that help accurately describe the |
| | product being sold/returned |
| Store | a. Store number |
| Master Cross | b. Store name |
| Reference | c. Hierarchy (district, division, region, etc.) |
| Table | d. Store address (address, city, state, zip) |
| | e. Store phone number |
| | f. Store open date |
| | g. Store manager name |
| | h. Typical sales tax rate |
| | i. Other relevant information about store |
| Employee | a. Employee ID |
| Master Cross | b. Store number |
| Reference | c. Employee name |
| Table | d. Employee address (address, city, state, zip) |
| | e. Employee position/security level (manager/non-manager |
| | is sufficient) |
| | f. Hire date |
| | g. Termination date (if applicable) |
| | h. Active/Inactive |
| | i. Other relevant information describing the employee |

TABLE 3
Example types of data used for generating nominations

| Data Type | Examples |
|---|---|
| Customer Master or | a. Customer ID number |
| Customer Loyalty Cross | b. ID type |
| Reference Table | c. Customer name |
| | d. Customer address (address, city, state, |
| | zip) |
| | e. Customer phone number |
| | f. Customer classification |
| | g. Other relevant information about |
| | customer |
| Shoplifting/ | a. Date of incident |
| Crime/Fraud Data | b. Type/Description of incident |
| | c. Conviction information |
| | d. Store number involved |
| | e. Employee involved (Y/N) |
| | f. Transaction numbers involved (if in |
| | POS data) |
| | g. How incident detected |
| | i. Name of employee detecting incident |
| | ii. Method of detection (description) |
| | h. Name of person committing incident |
| | i. Address of person committing incident |
| | j. Merchandise involved and amounts |
| | k. Other relevant information about |
| | incident or person |

TABLE 4
Example definitions of aggregate data
used for generating nominations

| Field Name | Field Description | How used? | Value to Analysis |
|---|---|---|---|
| Store | Store number for | Used in return | Valuable field for |
| Number | the weekly total | rate trend | return rate trend |
| | | analysis | analysis |
| Week | Week ending date | Used in return | Valuable field for |
| Ending | | rate trend | return rate trend |
| Date | | analysis | analysis |
| Total Gross | Total dollars of all | Used in return | Valuable field for |
| Sales | sales plus the total | rate trend | return rate trend |
| | of all positive | analysis | analysis |
| | portions of exchange | | |
| | transactions | | |
| Total | Total dollars of all | Used in return | Valuable field for |
| Returns | returns plus the | rate trend | return rate trend |
| | total of all | analysis | analysis |
| | negative portions of | | |
| | exchange transactions | | |

TABLE 4
Example definitions of transaction detail data used for generating nominations

| Field Name | Field Description | How used? | Value to Analysis |
|---|---|---|---|
| Store Number | Store where the | Used in store-level | Valuable field in |
| | transaction was | analysis, to match to Verify | joining tables and |
| | conducted | transactions and as part of | completing any |
| | | the key which allows | analysis. |
| | | matching between | |
| | | summary and tender data | |
| Register | Register number where | Used to match to Verify | Valuable field in |
| Number | the transaction was | transactions and as part of | joining tables and |
| | conducted | the key which allows | completing any |
| | | matching between | analysis. |
| | | summary and tender data | |
| Transaction | Date that the | Used to complete analysis | Valuable field in |
| Date | transaction was | by date, to match to Verify | joining tables and |
| | conducted | transactions and as part of | completing any |
| | | the key which allows | analysis. |
| | | matching between | |
| | | summary and tender data | |
| Transaction | Transaction number for | Used to match to Verify | Valuable field in |
| Number | the transaction being | transactions and as part of | joining tables and |
| | conducted | the key which allows | completing any |
| | | matching between | analysis. |
| | | summary and tender data. | |
| | | Also allows for separating | |
| | | one transaction from | |
| | | another. | |
| Transaction | The time of the | Used to match to Verify | Valuable field in |
| Time | transaction being | and may be part of the | joining tables and |
| | conducted | transaction Key. Used for | completing any |
| | (HH:MM:SS). Usually | analysis of fraud relating to | analysis. |
| | in military time. | time of day. | |
| Employee ID | ID Number of the | This is the primary field for | Valuable field in |
| | employee processing | determining purchase | doing analysis of |
| | the transaction | quantity and is used to | product and |
| | | determine many fraud | individuals. |
| | | related variables. | |
| SKU | Stock Keeping Unit | Used to identify products | Valuable field in |
| | number which identifies | and do analysis of returns | doing analysis of |
| | the product and allows | at the product level. We | product and |
| | for joining this table to | develop product level risk | individuals. |
| | the item table described | metrics which are part of | |
| | later | our fraud models and are | |
| | | used to identify fraudulent | |
| | | individuals | |
| UPC | Universal Product Code | Used to identify products | Valuable field in |
| | number which identifies | and do analysis of returns | doing analysis of |
| | the product and allows | at the product level. We | product and |
| | for joining this table to | develop product level risk | individuals if SKU is |
| | the item table described | metrics which are part of | not provided. |
| | later | our fraud models and are | |
| | | used to identify fraudulent | |
| | | individuals | |
| Sequence | The number of this | Used to joining this with | Valuable field in |
| Number | specific line of the | other lines from same | joining transactions |
| | transaction detail | transaction | and completing any |
| | | | analysis. |
| Line Discount | Discounts and/or | Used for doing discount | Important field for |
| and/or | markdowns applied to | analysis | discount analysis |
| Markdown | this line | | (which we have |
| Amount | | | found to be related |
| | | | to return fraud) |
| Line Discount | Discount code of | Used for doing discount | Important field for |
| Codes | Discount applied to this | analysis | discount analysis |
| | line | | (which we have |
| | | | found to be related |
| | | | to return fraud) |
| Transaction | Portion of the | Used for doing discount | Important field for |
| Discount | transaction discount | analysis | discount analysis |
| Amount | allocated to this line | | (which we have |
| (allocated) | item | | found to be related |
| | | | to return fraud) |
| Transaction | Code for transaction | Used for doing discount | Important field for |
| Discount | discount | analysis | discount analysis |
| Codes | | | (which we have |
| | | | found to be related |
| | | | to return fraud) |
| Override | Price override applied | Used for doing discount | Important field for |
| Amount | to this line | analysis | discount analysis |
| | | | (which we have |
| | | | found to be related |
| | | | to return fraud) |
| Override | Price override code of | Used for doing discount | Important field for |
| Codes | Discount applied to this | analysis | discount analysis |
| | line | | (which we have |
| | | | found to be related |
| | | | to return fraud) |
| Quantity | Number of items | This is the primary field for | Valuable field in |
| | purchased | determining purchase | doing analysis of |
| | | quantity and is used to | product and |
| | | determine many fraud | individuals. |
| | | related variables. | |
| Original Price | Original price of the | Used to determine the | Important field for |
| | merchandise as marked | percentage discount of an | discount analysis |
| | in the store before any | item and to reconcile data | (which we have |
| | discounts or | from extended amount | found to be related |
| | markdowns are applied. | with the discounts. | to return fraud) and |
| | | | to insure data |
| | | | quality. |
| Extended | Actual price paid by the | This is the primary price | Valuable field in |
| Amount | customer for the | field for an item and is used | doing analysis of |
| | merchandise | to determine many fraud | product and |
| | | related variables. | individuals. |
| Return Reason | Reason that the | Used to analyze the reason | Able to analyze |
| | merchandise is returned | for a return | return reasons and |
| | (if coded, will need a | | incorporate into risk |
| | list of codes with the | | assessment |
| | description) | | |
| Original Store | Store number for the | Used to locate the original | Important for |
| Number | purchase transaction | purchase | linking the original |
| | (ONLY ON | | purchase to a return |
| | RETURNS) | | and for linking |
| | | | together identities |
| Original | Register number for the | Used to locate the original | Important for |
| Register | purchase transaction | purchase | linking the original |
| Number | (ONLY ON | | purchase to a return |
| | RETURNS) | | and for linking |
| | | | together identities |
| Original | Transaction number for | Used to locate the original | Important for |
| Transaction | the purchase | purchase | linking the original |
| Number | transaction (ONLY ON | | purchase to a return |
| | RETURNS) | | and for linking |
| | | | together identities |
| Original | Transaction date for the | Used to locate the original | Important for |
| Transaction | purchase transaction | purchase | linking the original |
| Date | (ONLY ON | | purchase to a return |
| | RETURNS) | | and for linking |
| | | | together identities |
| Void | Indicates if the line item | Used to identify adherent | Important field for |
| flags/Post void | was voided | employee behavior | determining |
| flags or Line | | | employee collusion |
| Void | | | or employee fraud. |
| Indicators | | | |

TABLE 5
Example definitions of transaction tender data used for generating nominations

| Field Name | Field Description | How used? | Value to Analysis |
|---|---|---|---|
| Store Number | Store where the | Used in store-level analysis, | Valuable field in |
| | transaction was | to match to Verify | joining tables and |
| | conducted | transactions and as part of | completing any |
| | | the key which allows | analysis. |
| | | matching between detail and | |
| | | summary data | |
| Register | Register Number | Used to match to Verify | Valuable field in |
| Number | where the | transactions and as part of | joining tables and |
| | transaction was | the key which allows | completing any |
| | conducted | matching between detail and | analysis. |
| | | summary data | |
| Transaction | Date that the | Used to complete analysis | Valuable field in |
| Date | transaction was | by date, to match to Verify | joining tables and |
| | conducted | transactions and as part of | completing any |
| | | the key which allows | analysis. |
| | | matching between detail and | |
| | | summary data | |
| Transaction | Transaction number | Used to match to Verify | Valuable field in |
| Number | for the transaction | transactions and as part of | joining tables and |
| | being conducted | the key which allows | completing any |
| | | matching between detail and | analysis. |
| | | summary data. Also allows | |
| | | for separating one | |
| | | transaction from another. | |
| Transaction | The time of the | Used to match to Verify and | Valuable field in |
| Time | transaction being | may be part of the | joining tables and |
| | conducted | transaction Key. Used for | completing any |
| | (HH:MM:SS). | analysis of fraud relating to | analysis. |
| | Usually in military | time of day. | |
| | time. | | |
| Tender Type | Code indicating | Used to identify the method | Important field for |
| | which tender was | of payment and to compare | determining employee |
| | used | the payment on returns to | collusion or employee |
| | | the original tender method | fraud. |
| | | on the sale. Allows us to | |
| | | identify credit card | |
| | | transactions and to link | |
| | | individuals for those | |
| | | transactions | |
| Account | Represents the | Used to link transactions | Increases our ability to |
| Number | account number for | together which were made | link an individual's |
| (encrypted, | the tender provided | by the same account | transactions together |
| encoded or | in an encrypted, | | which has a positive |
| hashed) | encoded, or hashed | | impact on our ability |
| | format | | to measure |
| | | | profitability and to |
| | | | detect fraud. |
| Sequence | The number of this | Used to joining this with | Valuable field in |
| Number | specific line of the | other tender lines from same | joining transactions |
| | transaction's tender | transaction | and completing any |
| | detail | | analysis. |
| Routing | Represents the | Used to link transactions | Increases our ability to |
| Number | routing number for | together which were made | link an individual's |
| (encrypted, | the check provided | by the same account | transactions together |
| encoded or | in an encrypted, | | which has a positive |
| hashed) | encoded, or hashed | | impact on our ability |
| | format | | to measure |
| | | | profitability and to |
| | | | detect fraud. |
| ID Number | ID number and state | Used to link transactions | Increases our ability to |
| and State | collected from a | together which were made | link an individual's |
| | Driver's License, if | by the same account | transactions together |
| | entered when a | | which has a positive |
| | check is accepted | | impact on our ability |
| | | | to measure |
| | | | profitability and to |
| | | | detect fraud. |
| Cardholder | Represents the name | Used to link transactions | Increases our ability to |
| First/Last | associated with the | together which were made | link an individual's |
| Name | cardholder | by the same account | transactions together |
| | | | which has a positive |
| | | | impact on our ability |
| | | | to measure |
| | | | profitability and to |
| | | | detect fraud. |
| Tender | Total amount paid | Used for reconciliation with | Important field for |
| Amount | with this tender | detail and summary files and | determining the |
| | | for tender analysis. | amount of money |
| | | | applied to each tender |
| | | | type |
| Void | Indicates if the line | Used to identify adherent | Important field for |
| flags/Post void | item was voided | employee behavior | determining employee |
| flags or Line | | | collusion or employee |
| Void | | | fraud. |
| Indicators | | | |

TABLE 6
Example definitions of transaction summary data used for generating nominations

| Field Name | Field Description | How used? | Value to Analysis |
|---|---|---|---|
| Store | Store where the | Used in store-level | Valuable field in joining |
| Number | transaction was | analysis, to match to | tables and completing |
| | conducted | Verify transactions and as | any analysis. |
| | | part of the key which | |
| | | allows matching between | |
| | | detail and tender data | |
| Transaction | Transaction number | Used to match to Verify | Valuable field in joining |
| Number | for the transaction | transactions and as part of | tables and completing |
| | being conducted | the key which allows | any analysis. |
| | | matching between detail | |
| | | and tender data. Also | |
| | | allows for separating one | |
| | | transaction from another. | |
| Transaction | Date that the | Used to complete analysis | Valuable field in joining |
| Date | transaction was | by date, to match to Verify | tables and completing |
| | conducted | transactions and as part of | any analysis. |
| | | the key which allows | |
| | | matching between detail | |
| | | and tender data | |
| Transaction | The time of the | Used to match to Verify | Valuable field in joining |
| Time | transaction being | and may be part of the | tables and completing |
| | conducted | transaction Key. Used for | any analysis. |
| | (HH:MM:SS). | analysis of fraud relating | |
| | Usually in military | to time of day. | |
| | time. | | |
| Register | Register number | Used to match to Verify | Valuable field in joining |
| Number | where the transaction | transactions and as part of | tables and completing |
| | was conducted | the key which allows | any analysis. |
| | | matching between detail | |
| | | and tender data | |
| Employee ID | ID Number of the | This is the primary field | Valuable field in doing |
| | employee processing | for determining purchase | analysis of product and |
| | the transaction | quantity and is used to | individuals. |
| | | determine many fraud | |
| | | related variables. | |
| Transaction | Indicates if the | Used to identify adherent | Important field for |
| Void | transaction was | employee behavior | determining employee |
| Indicator | voided | | collusion or employee |
| | | | fraud. |
| Tax Amount | Total tax amount | Used to reconcile to the | Improved data quality |
| | | tender and detail files to | |
| | | insure that we read the | |
| | | data in correctly | |
| Sub Total | Total amount paid by | Used to reconcile to the | Improved data quality |
| Amount | the customer before | tender and detail files to | |
| | tax | insure that we read the | |
| | | data in correctly | |
| Total | Total amount paid by | Used to reconcile to the | Improved data quality |
| Transaction | the customer | tender and detail files to | |
| Amount | including tax | insure that we read the | |
| | | data in correctly | |
| Transaction | Code indicating | Used to identify the type | Valuable field in joining |
| Type | which kind of | of transaction and separate | tables and completing |
| | transaction this was - | purchases from returns | any analysis. |
| | purchase, return, | from others. | |
| | other, etc. | | |
| DL Number | ID number and state | Used to link transactions | Increases our ability to |
| and State | collected from a | together which were made | link an individual's |
| | Driver's License, if | by the same account | transactions together |
| | entered when a check | | which has a positive |
| | is accepted | | impact on our ability to |
| | | | measure profitability and |
| | | | to detect fraud. |
| Customer | Loyalty ID number of | Used for analyzing | Increased our ability to |
| Loyalty ID | the customer | behaviors in individuals. | link an individual's |
| Number | | Combined with other | transactions together |
| | | fields, this is used to link | which has a positive |
| | | transactions together | impact on our ability to |
| | | which belong to the same | measure profitability and |
| | | individual | to detect fraud. |

TABLE 7
Example definitions of SKU/item master data used for generating nominations

| Field Name | Field Description | How used? | Value to Analysis |
|---|---|---|---|
| SKU | Stock Keeping | Used to identify products and | Valuable field in doing |
| | Unit number | do analysis of returns at the | analysis of product and |
| | which identifies | product level. We develop | individuals. |
| | the product and | product level risk metrics | |
| | allows for joining | which are part of our fraud | |
| | this table to the | models and are used to | |
| | item table | identify fraudulent individuals | |
| | described later | | |
| UPC | Universal Product | Used to identify products and | Valuable field in doing |
| | Code number | do analysis of returns at the | analysis of product and |
| | which identifies | product level. We develop | individuals if SKU is not |
| | the product and | product level risk metrics | provided. |
| | allows for joining | which are part of our fraud | |
| | this table to the | models and are used to | |
| | item table | identify fraudulent individuals | |
| | described later | | |
| Product | Description of the | Used to identify products and | Valuable field in doing |
| Description | Item | do analysis of returns at the | analysis of product and |
| | | product level. We develop | individuals if SKU is not |
| | | product level risk metrics | provided. |
| | | which are part of our fraud | |
| | | models and are used to | |
| | | identify fraudulent individuals | |
| Department | Highest level of | Used for calculating return | Able to produce reports |
| Code | product hierarchy | statistics at each level of the | by SKU and hierarchical |
| Department | Highest level of | hierarchy. Example statistics | categories. Able to do |
| Description | product hierarchy | are return fraud risk score, | risk analysis by product. |
| | description | return rate, return | Improves accuracy of |
| Sub- | 2nd Highest level | authorization result, return | risk models and will |
| Department | of product | frequency, time-to-return, | impact our identification |
| Code | hierarchy | seasonality of returns, returns | of suspicious returners |
| Sub- | 2nd Highest level | by price tier, returns by | as this is tied to the |
| Department | of product | geography, returns by | riskiness of products and |
| Description | hierarchy | manufacturer, warranty | product categories. |
| | description | returns, recall returns, etc. all | |
| Class Code | 3rd Highest level | expressed at various levels of | |
| | of product | the merchandise hierarchy. | |
| | hierarchy | | |
| Class | 3rd Highest level | | |
| Description | of product | | |
| | hierarchy | | |
| | description | | |
| Sub-Class | 4th Highest level | | |
| Code | of product | | |
| | hierarchy | | |
| Sub Class | 4th Highest level | | |
| Description | of product | | |
| | hierarchy | | |
| | description | | |
| Brand Code | Highest level of | Used for calculating return | Able to produce reports |
| | product's brand or | statistics at each level of the | by SKU and hierarchical |
| | manufacturer | hierarchy. Example statistics | categories. Able to do |
| | hierarchy | are return fraud risk score, | risk analysis by product. |
| Brand | Highest level of | return rate, return | Improves accuracy of |
| Description | product's brand or | authorization result, return | risk models and will |
| | manufacturer | frequency, time-to-return, | impact our identification |
| | hierarchy | seasonality of returns, returns | of suspicious returners |
| | description | by price tier, returns by | as this is tied to the |
| Sub-Brand | 2nd Highest level | geography, returns by | riskiness of products and |
| Code | of product's brand | manufacturer, warranty | product categories. |
| | or manufacturer | returns, recall returns, etc. all | |
| | hierarchy | expressed at various levels of | |
| Sub-Brand | 2nd Highest level | the product's brand or | |
| Description | of product's brand | manufacturer hierarchy. | |
| | or manufacturer | | |
| | hierarchy | | |
| | description | | |
| Color Code | Color code of item | Used for calculating return | Able to produce reports |
| | (if used) | statistics at each level of the | by SKU and hierarchical |
| Color | Color description | hierarchy. Example statistics | categories. Able to do |
| Description | (if used) | are return fraud risk score, | risk analysis by product. |
| Size Code | Size code of item | return rate, return | Improves accuracy of |
| | (if used) | authorization result, return | risk models and will |
| Size | Size description (if | frequency, time-to-return, | impact our identification |
| Description | used) | seasonality of returns, returns | of suspicious returners |
| Style Code | Style code of item | by price tier, returns by | as this is tied to the |
| | (if used) | geography, returns by | riskiness of products and |
| Style | Style description | manufacturer, warranty | product categories. |
| Description | (if used) | returns, recall returns, etc. all | |
| | | expressed at various levels of | |
| | | the product's color, size | |
| | | and/or style hierarchy. | |
| Item Cost | Cost of the | Used for margin analysis and | Able to do margin |
| | merchandise | to measure customer | analysis and improves |
| | | profitability and to | the accuracy of our fraud |
| | | counterbalance fraud risk | detection efforts. Ideal |
| | | | models separate frequent |
| | | | abusive or fraudulent |
| | | | returners from frequent |
| | | | profitable shoppers |

TABLE 8
Example definitions of store master data used for generating nominations

| Field Name | Field Description | How used? | Value to Analysis |
|---|---|---|---|
| Store | ID Number of | The primary key for joining this | Valuable field for joining |
| Number | the store as | table with the transaction data | transactions |
| | used in the | | |
| | transaction | | |
| | summary file | | |
| Store | Store name | Allows for reports at the store | Able to provide readable |
| Name | | level to be readable by a | store level reports. |
| | | manager without a cross | |
| | | reference table. Allows for | |
| | | linking of stores across multiple | |
| | | sources. | |
| Hierarchy | Store's place | Used for calculating return | Able to produce reports by |
| (district, | within the | statistics at each level of the | store and hierarchical |
| division, | company | hierarchy. Example statistics are | categories. Able to do risk |
| region, | hierarchy | return fraud risk score, return | analysis by store. Improves |
| etc.) | | rate, return authorization result, | accuracy of risk models and |
| | | return frequency, time-to-return, | will impact our |
| | | seasonality of returns, returns by | identification of suspicious |
| | | price tier, returns by geography, | returners as this is tied to |
| | | returns by manufacturer, | the riskiness of stores and |
| | | warranty returns, recall returns, | store groups. |
| | | etc. all expressed at various | |
| | | levels of the store hierarchy. | |
| Store Full | Store address | Allows for geographic linking of | Able to provide readable |
| Address | | stores and individuals across | store level reports. Able to |
| | | multiple sources and IDs. | link stores to employees |
| | | | and to customers by name |
| | | | and address |
| Store | Store contact | Facilitates store support, | Authenticating callers is |
| Phone | info | valuable for fraud exception | easier. Consolidating store |
| Number | | reporting, fraud prevention, etc. | histories for multiple IDs |
| (and/or | | Allows for linking of individuals | possible. Will have positive |
| email) | | across multiple sources and IDs. | impact on model accuracy |
| | | | and fraud detection |
| | | | capabilities. |
| Store | Store contact | Facilitates store support, | Authenticating callers is |
| Manager | info | valuable for fraud exception | easier. |
| Name | | reporting, fraud prevention, etc. | |
| Store Open | Date the store | Used to determine if the store is | Determines active status |
| Date | was opened | active or inactive in the system | |
| Typical | Store sales tax | Used for margin analysis and to | Able to do margin analysis |
| Sales Tax | rate | measure customer profitability | and improves the accuracy |
| Rate | | and to counterbalance fraud risk | of our fraud detection |
| | | | efforts. Ideal models |
| | | | separate frequent abusive |
| | | | or fraudulent returners |
| | | | from frequent profitable |
| | | | shoppers |
| Hierarchy | Store's place | Used for calculating return | Able to produce reports by |
| (district, | within the | statistics at each level of the | store and hierarchical |
| division, | company | hierarchy. Example statistics are | categories. Able to do risk |
| region, | hierarchy | return fraud risk score, return | analysis by store. Improves |
| etc.) | | rate, return authorization result, | accuracy of risk models and |
| | | return frequency, time-to-return, | will impact our |
| | | seasonality of returns, returns by | identification of suspicious |
| | | price tier, returns by geography, | returners as this is tied to |
| | | returns by manufacturer, | the riskiness of stores and |
| | | warranty returns, recall returns, | store groups. |
| | | etc. all expressed at various | |
| | | levels of the store hierarchy. | |

TABLE 9
Example definitions of employee master data used for generating nominations

| Field Name | Field Description | How used? | Value to Analysis |
|---|---|---|---|
| Employee ID | ID Number of the | The primary key for joining | Valuable field for |
| Number | employee as used | this table with the transaction | joining transactions |
| | in the transaction | data | |
| | summary file | | |
| Employee Store | Primary employee | Used in combination with the | Valuable field for |
| Number | store number | employee ID as a key for | joining transactions |
| | | joining to the transaction | |
| | | data (if needed) | |
| Employee First | Employee name | Allows for reports at the | Able to provide |
| and Last Name | | employee level to be readable | readable employee |
| | | by a manager without a cross | level reports. Able |
| | | reference table. Allows for | to link employees to |
| | | linking of individuals across | customers by name |
| | | multiple sources and IDs to | and address |
| | | employees and is used in | |
| | | detecting employee collusion | |
| | | with customers. | |
| Employee Full | Employee address | Allows for linking of | Able to provide |
| Address | | individuals across multiple | readable employee |
| | | sources and IDs to | level reports. Able |
| | | employees and is used in | to link employees to |
| | | detecting employee collusion | customers by name |
| | | with customers. | and address |
| Employee | Indicator to | This flag is in the TRE | Able to set up this |
| position/security | determine if the | database and determines | feature in the system |
| level (i.e. | employee can run | which individuals have access | automatically |
| Manager/Non- | the manager | to certain manager functions | |
| Manager) | functions on the | in the system. | |
| | TRE systems | | |
| Hire Date | Date the | Used to determine if | Determines active |
| | employee was | someone is active or inactive | status |
| | hired | in the system | |
| Termination Date | Date the | Used to determine if | Determines active |
| | employee | someone is active or inactive | status |
| | terminated | in the system | |
| | employment (if | | |
| | available) | | |
| Active/Inactive | Indicator to | Used to determine if | Determines active |
| | determine if the | someone is active or inactive | status |
| | employee is active | in the system | |

TABLE 10
Example definitions of customer master/loyalty data used for generating nominations

| Field Name | Field Description | How used? | Value to Analysis |
|---|---|---|---|
| Customer/Loyalty | Loyalty ID number | The primary key for | Able to link transactions |
| ID Number | as used in the | joining this table | together to determine |
| | Transaction | with the transaction | purchase and return history. |
| | Summary Data | data | Able to do analysis of |
| | | | customer purchase and |
| | | | return patterns. Able to |
| | | | build models which utilize |
| | | | customer transaction |
| | | | history, etc. |
| ID Type | How is this person | Facilitates | Authenticating callers is |
| | identified in your | consumer support, | easier. Consolidating |
| | system? Your | valuable for fraud | consumer histories for |
| | loyalty program, | exception reporting, | multiple IDs possible. |
| | some other | fraud prevention, | Linking to individuals from |
| | identification | etc. Allows for | DL information will be |
| | program, etc. | linking of | possible. Will have positive |
| | | individuals across | impact on model accuracy |
| | | multiple sources | and fraud detection |
| | | and IDs. | capabilities. |
| First and Last Name | Customer name | Facilitates | Authenticating callers is |
| | | consumer support, | easier. Consolidating |
| | | valuable for fraud | consumer histories for |
| | | exception reporting, | multiple IDs possible. |
| | | fraud prevention, | Linking to individuals from |
| | | etc. Allows for | DL information will be |
| | | linking of | possible. Will have positive |
| | | individuals across | impact on model accuracy |
| | | multiple sources | and fraud detection |
| | | and IDs. | capabilities. |
| Customer Full | Customer address | Facilitates | Authenticating callers is |
| Address | | consumer support, | easier. Consolidating |
| | | valuable for fraud | consumer histories for |
| | | exception reporting, | multiple IDs possible. |
| | | fraud prevention, | Linking to individuals from |
| | | etc. Allows for | DL information will be |
| | | linking of | possible. Will have positive |
| | | individuals across | impact on model accuracy |
| | | multiple sources | and fraud detection |
| | | and IDs. | capabilities. |
| Customer Phone | Customer contact | Facilitates | Authenticating callers is |
| Number (and/or | info | consumer support, | easier. Consolidating |
| email) | | valuable for fraud | consumer histories for |
| | | exception reporting, | multiple IDs possible. |
| | | fraud prevention, | Linking to individuals from |
| | | etc. Allows for | DL information will be |
| | | linking of | possible. Will have positive |
| | | individuals across | impact on model accuracy |
| | | multiple sources | and fraud detection |
| | | and IDs. | capabilities. |
| Customer | The level or tier of | Used for analysis of | Able to do analysis and |
| Classification (i.e. | the customer (e.g. | return patterns by | have custom models by tier. |
| Loyalty Status | gold, platinum) | customer tier and | |
| Level) | | for designing | |
| | | custom models by | |
| | | tier | |

### Nomination Process

FIG. 7 is a flowchart that illustrates one embodiment of a process 700 for providing nominations. In some embodiments, the process 700 may be used to identify an organized crime ring. The process 700 begins at block 702, where the identification service 180 receives return authorization data from the client 120, the return authorization service 102, and/or the customer identifier extraction service 170. The return authorization data may include a plurality of transaction records, where each transaction record is associated with a product purchase, a product return, or any other transaction associated with the client 120. Each transaction record may be associated with a transaction identifier and a transaction amount.

At block 704, the identification service 180 determines a set of threshold levels associated with the client 120 based on the received return authorization data. The set of threshold levels may indicate whether a group of linked transaction records has an increased likelihood of being associated with organized retail crime ring. In other embodiments, the set of threshold levels can indicate whether a group of linked transaction records represents a high-volume returner (HVR), a renter, a returner who returns stolen items, a gift card seller, a reseller, or any other return fraud type.

At block 706, the identification service 180 identifies a first group of linked transaction records from the plurality of transaction records in the return authorization data. The identification service 180 may identify the first group based on one or more common attributes shared by one or more subsets of transaction records in the first group. For example, the common attributes may include a driver's license number, a mailing address, a gift card identifier, a loyalty card identifier, a store credit identifier, a credit card number, or any other identifier. If Person A's credit card number is associated with Transactions 1-10 (e.g., purchases, returns, or other transactions) and Person B's credit card number is associated with Transactions 11-20 (e.g., purchases, returns, or other transactions), where both Transaction 5 and Transaction 13 are associated with the same loyalty card identifier, all of Transactions 1-20 may be grouped under a single group of linked transactions based on (i) the sharing of Person A's credit card number by Transactions 1-10 (first subset of transaction records), (ii) the sharing of the Person B's credit card number by Transactions 1-10 (second subset of transaction records), and (iii) the sharing of the same loyalty card identifier by Transactions 5 and 13 (third subset of transaction records).

At block 708, the identification service 180 determines that the first group of linked transaction records has an increased likelihood of being associated with an organized retail crime ring. Such a determination may be made based on whether the first group of linked transaction records collectively satisfies the set of thresholds associated with client 120. For example, the set of threshold levels may include a threshold level for a total return value (e.g., greater than $1,000), a threshold level for a total number of identifications (e.g., multiple individuals linked to each other based on use of the same credit card number, mailing or resident address, driver's license number, state ID number, gift card ID, loyalty card ID, store credit card ID, and/or other identifier), a total return rate (e.g., greater than 50%), or specific combinations thereof. The set of threshold levels may further include threshold levels for any of the factors illustrated in FIG. 6 and/or Tables 1-10. The set of threshold levels may be determined based on client data specific to the client 120.

At block 710, in response to determining that the first group of linked transaction records has an increased likelihood of being associated with an organized retail crime ring, the identification service 180 nominates the first group of linked transaction records for presentation to the client and causes the nominated first group of linked transaction records to be stored in a nomination database. In some embodiments, the nominated groups of linked transaction records (also referred to herein as nominations) may be periodically (e.g., daily, weekly, monthly, etc.) compiled and transmitted to the client 120 or any other computing system associated with the client 120. Thus, in some embodiments, the retailer (e.g., client 120) can review the most important transaction records or groups of transactions records generated based on the purchases, returns, and other transactions processed by the retailer by simply reviewing the nominations generated based on the transaction data without having to examine the hundreds and thousands of transaction records, thereby saving time and energy and more effectively identifying potential fraudulent activities.

Upon nominating the first group of linked transaction records at block 710, the identification service 180 may also cause a notification (with or without the nomination) to be transmitted to the client 120 (e.g., computing device associated with the client 120). As described above, the computing device receiving such a notification may be at or near the point of return, at the same store location(s) associated with the nominated first group of linked transaction, and/or at a headquarter location associated with the client 120. The nominations generated by the identification service 180 may also be accessed by the return authorization service 102 to make a determination of whether to authorize a return transaction as described above with reference to FIG. 1. For example, the identification service 180 or the return authorization service 102 may calculate and/or maintain risk scores for all customers and transactions (e.g., based on prior purchases, prior returns, nominations, or other factors described herein) and authorize return requests based on such risk scores.

In some embodiments, the determination of whether to nominate a group of linked transaction records is determined based on one or more of the following factors: average amount of time a consumer kept the product before returning, actual amount of time the consumer kept the product before returning, the rate of non-receipted return request, the dollar amount of the non-receipted return request, whether a non-receipted return matches a prior purchase, average time between transactions, average distance between transactions, the number of gift cards or store credits used, average gift card amount, the number of stores associated with the gift cards or store credits, number of transactions by employee, dollar amount of the returns by employee, number of first names, number of last names, number of mailing or resident addresses, number of zip codes, number of individuals associated with the same address, maximum number of individuals associated with the same address, average distance between gift card transactions, maximum distance between gift card transactions, number of gift card transactions spanning more than 100 miles, maximum distance or radius among transactions, the velocity of transactions (e.g., number of transactions per day, number of days between transactions, etc.), time since last transaction, and the like. Additionally, or alternatively, any factors described herein (e.g., with reference to FIG. 6 and Tables 1-10) may be used by the identification service 180 to determine whether to nominate a group of linked transaction records.

In some embodiments, the identification service 180 automatically determines that the group of linked transaction records should not be nominated if the number of transactions occurring in a specified period of time (e.g., last month, last 3, 6, or 9 months, last year, etc.) does not exceed a threshold percentage of all transaction records in the group of linked transaction records. For example, if the transactions occurring in the last 90 days do not constitute at least 10% of the transaction records in the group of linked transaction records, the identification service 180 automatically determines that the group should not be nominated.

### Timing of Generating a Nomination

The process of generating a nomination (e.g., blocks 702-710) may be performed periodically (e.g., daily, every night, every week, every month, etc.). Alternatively or additionally, the process may be triggered when new data (e.g., client data, return authorization data, return policy data, etc.) is received or becomes available. In another example, the process may be triggered by a change in the identification or nomination policy (e.g., if the criteria and/or thresholds change, if new criteria and/or thresholds are added, or if existing criteria and/or thresholds are removed). In some embodiments, the frequency may be specified by the client 120. In other embodiments, the process may be performed after a threshold dollar amount (or a threshold number) of returns has been processed. In some cases, the identification service 180 may create or update nominations in real-time every time a new transaction is processed.

### Renter

In one embodiment, the identification service 180 determines that a group of linked transaction records represents a renter (e.g., someone who repeatedly purchases items with the intention of returning the items after use) if the average return rate of all transaction records in the group is greater than a threshold percentage. In another embodiment, the identification service 180 determines that a group of linked transaction records represents a renter if the average return rate of all transaction records in the group is greater than a threshold percentage and if another threshold percentage of the return transactions match a prior purchase at any store location. In yet another embodiment, the identification service 180 determines that a group of linked transaction records represents a renter if the average return rate of all transaction records in the group is greater than a threshold percentage and if another threshold percentage of the return transactions match a prior purchase at the same store location. In yet another embodiment, the identification service 180 determines that a group of linked transaction records represents a renter if the average return rate of all transaction records in the group is greater than a first threshold percentage, if a second threshold percentage of the return transactions match a prior purchase at the same store location, and if the average return rate of return transactions occurring during a specific period of time (e.g., past 90 days) is greater than a third threshold percentage and the average return rate of all transaction records is less than a fourth threshold percentage (e.g., 120%).

### Example Nomination Logic for Renter

In some embodiments, the following logic may be used by the identification service 180 to determine whether to nominate the group of linked transaction records as a renter: the identification service 180 nominates the group of linked transaction records as a renter if Conditions A, B, C, and D are satisfied, where Condition A is satisfied if: (i) the overall return rate (e.g., the total number of returns associated with the group divided by the total number of purchases associated with the group) is greater than a first threshold percentage (e.g., 85%) and the total purchase dollar amount (e.g., sum of all purchases associated with the group) is greater than a first threshold amount (e.g., $1,000), (ii) the overall return rate is greater than a second threshold percentage (e.g., 82%) and the total purchase dollar amount is greater than a second threshold amount (e.g., $1,500), (iii) the overall return rate is greater than a third threshold percentage (e.g., 78%) and the total purchase dollar amount is greater than a third threshold amount (e.g., $2,250), or (iv) the overall return rate is greater than a fourth threshold percentage (e.g., 75%) and the total purchase dollar amount is greater than a fourth threshold amount (e.g., $4,000); Condition B is satisfied if the return rate over a specific time period (e.g., past 90 days) is greater than a fifth threshold percentage (e.g., 60%); Condition C is satisfied if the overall return rate is less than a sixth threshold percentage (e.g., 120%); and Condition D is satisfied if the quantity or dollar amount of the matched returns (e.g., non-receipted returns for which the identification service 180 or other components of the electronic monitoring system 100 was able to locate the corresponding purchases, for example, using the SKU) is greater than a seventh threshold percentage (e.g., 60%).

For example, in some of such embodiments, each of the percentages, amounts, and time periods may have a different value. In other embodiments, in Condition A, the percentages have different values with respect to each other and the corresponding amounts have different values with respect to each other. The percentages may be inversely proportional to the corresponding amounts (e.g., if the first threshold percentage has the highest value among the four threshold percentages used in Condition A, the corresponding first threshold amount has the lowest value among the four threshold amounts used in Condition A. Although four threshold percentages and four threshold amounts are used in the example of Condition A, a different number of threshold percentages/amounts may be used (e.g., 2, 3, 5, 6, 10, etc.).

In other embodiments, any combination of the Conditions A-D may be used by the identification service 180 to determine whether to nominate the group of linked transaction records as a renter. For example, the identification service 180 may nominate the group of linked transaction records as a renter if Conditions ABC are satisfied (a similar technique may be extended to ABD or BCD). In another example, the identification service 180 may nominate the group of linked transaction records as a renter if Conditions AB are satisfied (a similar technique may be extended to AC, AD, BC, BD, or CD). Alternatively, the identification service 180 may nominate the group of linked transaction records as a renter if any two of the four conditions are satisfied. Alternatively, the identification service 180 may nominate the group of linked transaction records as a renter if any three of the four conditions are satisfied.

In other implementations, the following logic may be used by the identification service 180 to determine whether to nominate the group of linked transaction records as a renter: the identification service 180 nominates the group of linked transaction records as a renter if Condition E is satisfied, where Condition E is satisfied if a normalized quantity or dollar amount of the matched returns is greater than a first threshold percentage (e.g., 75%) and if the overall return rate is greater than a second threshold percentage (e.g., 60%).

### Returner of Stolen Items

In one embodiment, the identification service 180 determines that a group of linked transaction records represents a returner of stolen items (e.g., someone who steals items and returns the items to obtain refunds, store credits, or other payment) if the return rate over a specific time period (e.g., past month, past 180 days, past year, past 5 years, etc.) is greater than a first threshold percentage (e.g., 100%, 120%, 150%, 200%, etc.). In another embodiment, the identification service 180 determines that a group of linked transaction records represents a returner of stolen items if the return rate over a specific time period is greater than a first threshold percentage and the number of unique returned items (e.g., the number of SKUs) is greater than a first threshold number (e.g., 5, 10, 20, etc.). In yet another embodiment, the identification service 180 determines that a group of linked transaction records represents a returner of stolen items if the return rate over a specific time period is greater than a first threshold percentage, the number of unique returned items is greater than a first threshold number, and the normalized matched return quantity or dollar amount is less than a second threshold percentage (e.g., 10%, 20%, 30%, 40%, etc.). In yet another embodiment, the identification service 180 determines that a group of linked transaction records represents a returner of stolen items if the return rate over a specific time period is greater than a first threshold percentage, the number of unique returned items is greater than a first threshold number, the normalized matched return quantity or dollar amount is less than a second threshold percentage, and the ratio of the overall non-receipted return dollar amount to the overall total return dollar amount is greater than a threshold ratio (e.g., 0.3, 0.4, 0.5, 0.6, etc.).

### Example Nomination Logic for Stolen Item Returner Identification

In some embodiments, the following logic may be used by the identification service 180 to determine whether to nominate the group of linked transaction records as a returner of stolen items: the identification service 180 nominates the group of linked transaction records as a returner of stolen items if Conditions A, B, C, and D are satisfied, where Condition A is satisfied if: (i) the return rate over a first specific time period (e.g., past 365 days) is greater than a first threshold percentage (e.g., 120%) or (ii) the return rate over a second specific time period (e.g., past 180 days) is greater than a second threshold percentage (e.g., 120%); Condition B is satisfied if: (i) the number of unique returned items (e.g., having unique SKUs) is greater than a first threshold number (e.g., 20) or (ii) if the number of unique returned items having at least a threshold count (e.g., 3) is greater than a second threshold number (e.g., 6); Condition C is satisfied if: (i) the normalized matched return quantity is less than a third threshold percentage (e.g., 40%) or (ii) the normalized matched return dollar amount is less than a fourth threshold percentage (e.g., 40%); and Condition D is satisfied if the absolute value of the ratio of the overall non-receipted return dollar amount to the overall total return dollar amount is greater than a threshold ratio (e.g., 0.5).

In other embodiments, any combination of the Conditions A-D may be used by the identification service 180 to determine whether to nominate the group of linked transaction records as a returner of stolen items. For example, the identification service 180 may nominate the group of linked transaction records as a returner of stolen items if Conditions ABC are satisfied (a similar technique may be extended to ABD or BCD). In another example, the identification service 180 may nominate the group of linked transaction records as a returner of stolen items if Conditions AB are satisfied (a similar technique may be extended to AC, AD, BC, BD, or CD). Alternatively, the identification service 180 may nominate the group of linked transaction records as a returner of stolen items if any two of the four conditions are satisfied. Alternatively, the identification service 180 may nominate the group of linked transaction records as a returner of stolen items if any three of the four conditions are satisfied.

### Organized Retail Crime (ORC) Ring

In one embodiment, the identification service 180 determines that a group of linked transaction records represents an organized retail crime (ORC) ring (e.g., a group of individuals committing retail frauds in concert in an organized fashion) if the number of IDs (e.g., the number of individuals or IDs associated with the group of linked transaction records) used over a first specific time period (e.g., past month, past 180 days, past year, past 5 years, etc.) is greater than a first threshold number (e.g., 3, 4, 5, 6, 10, etc.). In another embodiment, the identification service 180 determines that a group of linked transaction records represents an ORC ring if the number of IDs used over a first specific time period is greater than a first threshold number, and the return rate over a second specific time period (e.g., past month, past 180 days, past year, past 5 years, etc.) is greater than a first threshold percentage (e.g., 100%, 120%, 150%, 200%, etc.). In yet another embodiment, the identification service 180 determines that a group of linked transaction records represents an ORC ring if the number of IDs used over a first specific time period is greater than a first threshold number, the return rate over a second specific time period is greater than a first threshold percentage, and the total number of driver's license numbers or addresses associated with the group of linked transaction records is greater than a second threshold number (e.g., 3, 4, 5, 6, 10, etc.). In yet another embodiment, the identification service 180 determines that a group of linked transaction records represents an ORC ring if the number of IDs used over a first specific time period is greater than a first threshold number, the return rate over a second specific time period is greater than a first threshold percentage, the total number of driver's license numbers or addresses associated with the group of linked transaction records is greater than a second threshold number, and the overall return dollar amount (e.g., sum of all returns associated with the group) is greater than a first threshold amount (e.g., $1000, $2000, $3000, $4000, $5000, $10000, etc.).

### Example Nomination Logic for ORC Ring Identification

In some embodiments, the following logic may be used by the identification service 180 to determine whether to nominate the group of linked transaction records as an ORC ring: the identification service 180 nominates the group of linked transaction records as an ORC ring if Conditions A, B, C, and D are satisfied, where Condition A is satisfied if: (i) the overall return dollar amount is greater than a first threshold amount (e.g., $4000) or (ii) the sum of the returns over a first specific time period (e.g., past 180 days) is greater than a second threshold amount (e.g., $1000); Condition B is satisfied if the number of IDs used over a second specific time period (e.g., past 365 days) is greater than a first threshold number (e.g., 4); Condition C is satisfied if: (i) the return rate over a third specific time period (e.g., past 365 days) is greater than a first threshold percentage (e.g., 65%) or (ii) the return rate over a fourth specific time period (e.g., past 180 days) is greater than a second threshold percentage (e.g., 65%); and Condition D is satisfied if: (i) the total number of driver's license numbers associated with the group of linked transaction records is greater than a second threshold number (e.g., 4) or (ii) the total number of mailing or resident addresses associated with the group of linked transaction records is greater than a third threshold number (e.g., 4).

In other embodiments, any combination of the Conditions A-D may be used by the identification service 180 to determine whether to nominate the group of linked transaction records as an ORC ring. For example, the identification service 180 may nominate the group of linked transaction records as an ORC ring if Conditions ABC are satisfied (a similar technique may be extended to ABD or BCD). In another example, the identification service 180 may nominate the group of linked transaction records as an ORC ring if Conditions AB are satisfied (a similar technique may be extended to AC, AD, BC, BD, or CD). Alternatively, the identification service 180 may nominate the group of linked transaction records as an ORC ring if any two of the four conditions are satisfied. Alternatively, the identification service 180 may nominate the group of linked transaction records as an ORC ring if any three of the four conditions are satisfied.

### Forged ID

In one embodiment, the identification service 180 determines that a group of linked transaction records represents a returner using forged IDs if the number of addresses (e.g., addresses associated with the group of linked transaction records) used over a first specific time period (e.g., past month, past 180 days, past year, past 5 years, etc.) is greater than a first threshold number (e.g., 1, 2, 3, 4, 5, 6, 10, etc.). In another embodiment, the identification service 180 determines that a group of linked transaction records represents a returner using forged IDs if the number of addresses used over a first specific time period is greater than a first threshold number, and the return rate over a second specific time period (e.g., past month, past 180 days, past year, past 5 years, etc.) is greater than a first threshold percentage (e.g., 30%, 45%, 60%, etc.). In yet another embodiment, the identification service 180 determines that a group of linked transaction records represents a returner using forged IDs if the number of addresses used over a first specific time period is greater than a first threshold number, the return rate over a second specific time period is greater than a first threshold percentage, and the number of IDs (e.g., the number of individuals or IDs associated with the group of linked transaction records) used over a third specific time period (e.g., past month, past 180 days, past year, past 5 years, etc.) is greater than a second threshold number (e.g., 3, 4, 5, 6, 10, etc.). In yet another embodiment, the identification service 180 determines that a group of linked transaction records represents a returner using forged IDs if the number of addresses used over a first specific time period is greater than a first threshold number, the return rate over a second specific time period is greater than a first threshold percentage, the number of IDs used over a third specific time period is greater than a second threshold number, and the return dollar amount over a fourth specific time period (e.g., past month, past 180 days, past year, past 5 years, etc.) is greater than a first threshold amount (e.g., $100, $500, $1000, $5000, etc.).

In some cases, the identification service 180 may determine that a group of linked transaction records represents a returner using forged IDs if the number of unique IDs (e.g., maximum, average, etc.) associated with a single address and used over a first specific time period (e.g., past month, past 180 days, past year, past 5 years, etc.) is greater than a first threshold number (e.g., 2, 3, 4, 5, 6, 10, etc.). For example, to forge an ID, a fraudulent customer may physically alter his or her driver's license number (e.g., by changing 1 digit), while leaving the name and address intact. In such an example, some transactions may be associated with one driver's license number with a name and an address, and other transactions may be associated with a different driver's license number with the same name and address. In another embodiment, the identification service 180 determines that a group of linked transaction records represents a returner using forged IDs if the number of unique IDs associated with a single address and used over a first specific time period is greater than a first threshold number, and the return rate over a second specific time period (e.g., past month, past 180 days, past year, past 5 years, etc.) is greater than a first threshold percentage (e.g., 30%, 45%, 60%, etc.). In yet another embodiment, the identification service 180 determines that a group of linked transaction records represents a returner using forged IDs if the number of unique IDs associated with a single address and used over a first specific time period is greater than a first threshold number, the return rate over a second specific time period is greater than a first threshold percentage, and the total number of IDs (e.g., the number of individuals or IDs associated with the group of linked transaction records) used over a third specific time period (e.g., past month, past 180 days, past year, past 5 years, etc.) is greater than a second threshold number (e.g., 3, 4, 5, 6, 10, etc.). In yet another embodiment, the identification service 180 determines that a group of linked transaction records represents a returner using forged IDs if the number of unique IDs associated with a single address and used over a first specific time period is greater than a first threshold number, the return rate over a second specific time period is greater than a first threshold percentage, the number of IDs used over a third specific time period is greater than a second threshold number, and the return dollar amount over a fourth specific time period (e.g., past month, past 180 days, past year, past 5 years, etc.) is greater than a first threshold amount (e.g., $100, $500, $1000, $5000, etc.).

### Example Nomination Logic is for Forged ID Identification

In some embodiments, the following logic may be used by the identification service 180 to determine whether to nominate the group of linked transaction records as a returner using forged IDs: the identification service 180 nominates the group of linked transaction records as a returner using forged IDs if Conditions A, B, C, and D are satisfied, where Condition A is satisfied if: (i) the overall return dollar amount is greater than a first threshold amount (e.g., $2000) and (ii) the sum of the returns over a first specific time period (e.g., past 180 days) is greater than a second threshold amount (e.g., $500); Condition B is satisfied if the number of IDs used over a second specific time period (e.g., past 365 days) is greater than a first threshold number (e.g., 4); Condition C is satisfied if: (i) the return rate over a third specific time period (e.g., past 365 days) is greater than a first threshold percentage (e.g., 45%) or (ii) the return rate over a fourth specific time period (e.g., past 180 days) is greater than a second threshold percentage (e.g., 45%); and Condition D is satisfied if the number of addresses used over a first specific time period (e.g., past 365 days) is greater than a first threshold number (e.g., 2).

In other embodiments, any combination of the Conditions A-D may be used by the identification service 180 to determine whether to nominate the group of linked transaction records as a returner using forged IDs. For example, the identification service 180 may nominate the group of linked transaction records as a returner using forged IDs if Conditions ABC are satisfied (a similar technique may be extended to ABD or BCD). In another example, the identification service 180 may nominate the group of linked transaction records as a returner using forged IDs if Conditions AB are satisfied (a similar technique may be extended to AC, AD, BC, BD, or CD). Alternatively, the identification service 180 may nominate the group of linked transaction records as a returner using forged IDs if any two of the four conditions are satisfied. Alternatively, the identification service 180 may nominate the group of linked transaction records as a returner using forged IDs if any three of the four conditions are satisfied.

### Reseller

In one embodiment, the identification service 180 determines that a group of linked transaction records represents a reseller (e.g., someone who purchases items, sells them to other consumers, and returns any unsold items) if the number of purchases over a first specific time period (e.g., past month, past 180 days, past year, past 5 years, etc.) is greater than a first threshold number (e.g., 20, 50, 75, 100, etc.). In another embodiment, the identification service 180 determines that a group of linked transaction records represents a reseller if the number of purchases over a first specific time period is greater than a first threshold number, and the average purchase or return quantity (e.g., number of items purchased or returned per transaction) over a second specific time period (e.g., past month, past 180 days, past year, past 5 years, etc.) is greater than a second threshold number (e.g., 3, 4, 5, 10, etc.). In yet another embodiment, the identification service 180 determines that a group of linked transaction records represents a reseller if the number of purchases over a first specific time period is greater than a first threshold number, the average purchase or return quantity over a second specific time period is greater than a second threshold number, and the return rate over a third specific time period (e.g., past month, past 180 days, past year, past 5 years, etc.) is greater than or equal to a first threshold percentage (e.g., 20%, 30%, 45%, etc.) and less than or equal to a second threshold percentage (e.g., 50%, 60%, 70%, etc.). In yet another embodiment, the identification service 180 determines that a group of linked transaction records represents a reseller if the number of purchases over a first specific time period is greater than a first threshold number, the average purchase or return quantity over a second specific time period is greater than a second threshold number, the return rate over a third specific time period is greater than or equal to a first threshold percentage and less than or equal to a second threshold percentage, and the return dollar amount over a fourth specific time period (e.g., past month, past 180 days, past year, past 5 years, etc.) is greater than a first threshold amount (e.g., $500, $1000, $2000, $5000, etc.).

### Example Nomination Logic for Reseller Identification

In some embodiments, the following logic may be used by the identification service 180 to determine whether to nominate the group of linked transaction records as a reseller: the identification service 180 nominates the group of linked transaction records as a reseller if Conditions A, B, C, and D are satisfied, where Condition A is satisfied if: (i) the overall return dollar amount is greater than a first threshold amount (e.g., $2000) and (ii) the sum of the returns over a first specific time period (e.g., past 180 days) is greater than a second threshold amount (e.g., $500); Condition B is satisfied if: (i) the average purchase quantity over a second specific time period (e.g., past 365 days) is greater than a first threshold number (e.g., 4) or (ii) the overall average return quantity is greater than a second threshold number (e.g., 4); Condition C is satisfied if: (i) the number of purchases over a third specific time period (e.g., past 365 days) is greater than a third threshold number (e.g., 20) or (ii) the number of transactions (e.g., both purchases and returns) over a fourth specific time period (e.g., past 365 days) is greater than a fourth threshold number (e.g., 30); and Condition D is satisfied if: (i) the return rate over a fifth specific time period (e.g., past 365 days) is greater than equal to a first threshold percentage (e.g., 30%) and less than or equal to a second threshold percentage (e.g., 60%) or (ii) the overall return rate is greater than equal to a third threshold percentage (e.g., 30%) and less than or equal to a fourth threshold percentage (e.g., 60%).

In other embodiments, any combination of the Conditions A-D may be used by the identification service 180 to determine whether to nominate the group of linked transaction records as a reseller. For example, the identification service 180 may nominate the group of linked transaction records as a reseller if Conditions ABC are satisfied (a similar technique may be extended to ABD or BCD). In another example, the identification service 180 may nominate the group of linked transaction records as a reseller if Conditions AB are satisfied (a similar technique may be extended to AC, AD, BC, BD, or CD). Alternatively, the identification service 180 may nominate the group of linked transaction records as a reseller if any two of the four conditions are satisfied. Alternatively, the identification service 180 may nominate the group of linked transaction records as a reseller if any three of the four conditions are satisfied.

### High Volume Returner (HVR)

In one embodiment, the identification service 180 determines that a group of linked transaction records represents a high volume returner (HVR) (e.g., someone who purchases and returns a large number and a large percentage of the purchased items) if the average or total return quantity is greater than a first threshold number threshold number (e.g., 3, 4, 5, 10, etc.). In another embodiment, the identification service 180 determines that a group of linked transaction records represents an HVR if the average or total return quantity is greater than a first threshold number threshold number, and if the return rate over a first specific time period (e.g., past month, past 180 days, past year, past 5 years, etc.) is greater than a first threshold percentage (e.g., 60%, 70%, 80%, 90%, etc.). In yet another embodiment, the identification service 180 determines that a group of linked transaction records represents an HVR if the average or total return quantity is greater than a first threshold number threshold number, if the return rate over a first specific time period is greater than a first threshold percentage, and if the overall return rate is greater than a second threshold percentage (e.g., 30%, 40%, 50%, 60%, etc.). In yet another embodiment, the identification service 180 determines that a group of linked transaction records represents an HVR if the average or total return quantity is greater than a first threshold number threshold number, if the return rate over a first specific time period is greater than a first threshold percentage, if the overall return rate is greater than a second threshold percentage, and if the total return dollar amount is greater than a first threshold amount (e.g., $500, $1000, $1500, $3000, etc.).

### Example Nomination Logic for HVR Identification

In some embodiments, the following logic may be used by the identification service 180 to determine whether to nominate the group of linked transaction records as an HVR: the identification service 180 nominates the group of linked transaction records as an HVR if Conditions A, B, C, and D are satisfied, where Condition A is satisfied if the overall return dollar amount is greater than a first threshold amount (e.g., $1500); Condition B is satisfied if: (i) the overall average return quantity or the average return quantity over a first specific time period (e.g., past 365 days) is greater than a first threshold number (e.g., 3), (ii) the total return quantity is greater than a second threshold number (e.g., 60), the return quantity over a second specific time period (e.g., past 365 days) is greater than a third threshold number (e.g., 30), or the return quantity over a third specific time period (e.g., past 90 days) is greater than a fourth threshold number (e.g., 20), or (iii) the number of returns (e.g., return transactions) over a fourth specific time period (e.g., past 365 days) is greater than a fifth threshold number (e.g., 20); Condition C is satisfied if the return rate over a fifth specific time period (e.g., past 365 days) is greater than a first threshold percentage (e.g., 80%); and Condition D is satisfied if the overall return rate is greater than a second threshold percentage (e.g., 50%).

In other embodiments, any combination of the Conditions A-D may be used by the identification service 180 to determine whether to nominate the group of linked transaction records as an HVR. For example, the identification service 180 may nominate the group of linked transaction records as an HVR if Conditions ABC are satisfied (a similar technique may be extended to ABD or BCD). In another example, the identification service 180 may nominate the group of linked transaction records as an HVR if Conditions AB are satisfied (a similar technique may be extended to AC, AD, BC, BD, or CD). Alternatively, the identification service 180 may nominate the group of linked transaction records as an HVR if any two of the four conditions are satisfied. Alternatively, the identification service 180 may nominate the group of linked transaction records as an HVR if any three of the four conditions are satisfied.

### Variation in Threshold Levels

The threshold levels (e.g., numbers, amounts, percentages, etc.) specified herein may be determined or adjusted based on the needs of the client 120. The factors described herein may be determined for each transaction record in the group and/or collectively for the entire group.

### Nomination-Specific Actions

In some embodiments, in response to nominating a group of linked transaction records based on the client-specific thresholds, the identification service 180 may cause or recommend the client 120 to take certain actions that are specific to the nomination. For example, in response to determining that a group of linked transaction records represents a renter, the identification service 180 (or the client 120 or the return authorization service 102, based on the nomination data) may cause a warning to be issued when an individual linked to the group requests a product return but still approve the return. On the other hand, in response to determining that a group of linked transaction records represents a group of individuals returning stolen items, the identification service 180 (or the client 120 or the return authorization service 102, based on the nomination data) may cause any returns requested by such individuals to be automatically denied.

Such nomination-specific actions may also be tied to a subset of the items sold by the client 120. For example, after generating a nomination based on a determination that a group of linked transaction records represents a renter, the identification service 180 (or the client 120 or the return authorization service 102, based on the nomination data) may determine if there is a trend or pattern in the behavior of the individual(s) linked to the nomination. If the identification service 180 further determines that a threshold percentage (e.g., 50%, 60%, 70%, 80%, or any other percentage) of the returns associated with the nomination belong to the same category, SKU category, or SKU (e.g., sporting goods, more specifically snowboarding goods, and even more specifically snowboards), instead of causing all product returns to result in a denial or a warning, the identification service 180 may cause only product returns in such specific category, SKU category, or SKU to result in a denial or a warning and allow other returns to be processed without regard to this nomination.

### Other Types of Nominations

Although return fraud type nominations are described above, nominations can be used for identifying any other types of consumer and employee behavioral trends and patterns. For example, reward thresholds can be used to nominate a group of linked transaction records that represents one or more loyal customers. In response to such a nomination, the identification service 180 or the client 120 may cause a reward or discount to be provided to such customers. In another example, the identification service 180 may nominate, based on seasonality thresholds, a group of consumers who shops heavily during the Christmas season. In such an example, the identification service 180 or the client 120 may cause a targeted advertisement to be provided to such a group of consumers. Nominations can also be used to identify other product associations, graphical associations, seasonality associations, household or family associations, etc.

### Nomination Process (Cont.)

With continued reference to FIG. 7, at block 712, the identification service 180 receives an indication that a product return request has been processed. For example, the indication may be received from the POR device 126 over a computer-mediated network. The indication may include a transaction identifier associated with the processed product return request. Further, the indication may include one or more parameters associated with the product return request. For example, the parameters may include a credit card number, a mailing or resident address, a driver's license number, a state ID number, a gift card ID, a loyalty card ID, a store credit card ID, and/or any other identifier associated with the consumer requesting the product return.

At block 714, in response to receiving the indication that the product return request has been processed, the identification service 180 queries the nomination database to determine whether the nomination database includes any nominated transaction records that are associated with the transaction identifier associated with the processed product return request.

At block 716, in response to determining that the processed request is related to a nominated group of linked transaction records, the identification service 180 generates and transmits the identification information to the client 120. The identification information may indicate to the client 120 that the processed product return request is associated with an organized retail crime ring. Alternatively, the identification information can indicate that the processed product return request is associated with a high-volume returner (HVR), a renter, a returner who returns stolen items, a gift card seller, a reseller, or any other return fraud type. The computing device receiving such identification information may be at or near the point of return, at the same store location(s) associated with the nominated first group of linked transaction, and/or a headquarter location associated with the client 120.

Additionally, the identification information may include a recommendation regarding any action that the retailer may wish to take in view of the determination that the processed product return request is related to a nominated group of linked transaction records. For example, such a recommendation may include denying future return requests by individuals associated with the nominations, denying the processed product return request, placing the individual associated with the processed product return request on a watch list, or immediately visiting the scene of the processed product return request and further investigating the validity of the transaction by a manger or administrator of the client 120. In some embodiments, in response to receiving the identification information from the identification service 180, the client 120 or any other computing system associated with the client 120 causes a video camera to capture a picture or video of the scene of the transaction for transmission to and/or review by the client 120. Thus, in some embodiments, the retailer (e.g., client 120) can take immediate action based on the identification information received from the identification service 180. For example, before the consumer initiating the product return request leaves the store, a manager or administrator of the client 120 can visit the scene of the transaction and further investigate the validity of the transaction or gather any evidence for future monitoring.

As will be familiar to one of skill in the art, other embodiments of the process 700 described in FIG. 7 may be carried out by executing the functions described in FIG. 7 in a different order, by dividing the functions in another manner, and/or by including some or all of the functions described above in conjunction with other associated functions. For example, in some embodiments, block 712 may be modified to receive an indication that a product return request has been denied. In other embodiments, block 712 may be modified to receive an indication that a product return request has satisfied a condition for checking the nomination database. In some implementations, blocks 712-716 may be modified such that an instruction to query the nomination database (or a request for nomination data or other data) is received from an identify device associated with the client 120. In such implementations, in response to the received instructions, the identification service 180 may transmit requested data back to the identify device associated with the client 120. Other variations are possible. For example, in the process 700 (or other processes disclosed herein) certain steps may be omitted. For example, in some embodiments, blocks 712-716 are omitted, and the method 700 ends after the nominations have been generated, stored, and/or transmitted to the client 120.

Other variations are possible. For example, the identification service 180 may perform the steps at blocks 712-716 in response to receiving an indication that a product return request has been rejected. In another example, the identification service 180 may perform the steps at blocks 712-716 in response to receiving an indication that a product return request has been granted. In yet another example, the identification service 180 may perform the steps at blocks 712-716 in response to receiving an indication that a product return request has satisfied a threshold condition for generating a nomination and providing recommendations as to further action to be taken by the retailer. In some embodiments, the threshold condition may include whether the return amount associated with the product return request exceeds a threshold level, whether the customer initiating the product return request has a receipt, whether the customer initiating the product return request is on a watch list, whether the employee handling the product return request is on a watch list, or any other condition indicative of the likelihood that the product return request may be associated with a return fraud.

Advantageously, by nominating a group of linked transactions for the retailer to review, the techniques described in the present disclosure can eliminate the need for the retailer to analyze hundreds of data points in order to identify the most important transactions or to determine which transactions, consumers, and/or employees constitute desirable targets for further investigation and monitoring.

### Example User Interface: Dashboard View

With reference to FIG. 8, an example dashboard user interface 800 showing the nominations is described. In the example of FIG. 8, the dashboard user interface 800 shows a dot graph plotting the nominations based on the number of IDs associated with each nomination (x-axis) and the aggregate return amount (e.g., dollar value) associated with each nomination (y-axis). In some embodiments, each nomination is plotted using an icon representative of the return fraud type associated with the nomination. For example, the return fraud type associated with each nomination may include one or more of high volume returner (HVR), organized retail crime (ORC), renter, return of stolen items, gift card seller, or reseller.

As shown in FIG. 8, the dashboard user interface 800 may also include a graphical illustration of the total return amount (e.g., dollar value) by fraud type. In addition, the dashboard user interface 800 may include a table listing the nominations generated for the retailer. For example, for each nomination, one or more of the following parameters may be displayed: nomination ID, status, purchase amount, return amount, return rate, fraud type, most impacted state, and comments. In some embodiments, the purchase amount is a sum of all the purchase amounts associated with the individual transactions associated with a given nomination, and the return amount is a sum of all the return amounts associated with the individual transactions associated with the given nomination. For example, if a given nomination has two IDs and eight transactions associated therewith, and five of the transactions are return transactions each having a return amount of $100, and the remaining three transactions or purchase transactions each having a purchase amount of $50, the return amounts associated with the given nomination would be $500, and the purchase amount associated with the given nomination would be $150.

The information generated and displayed for each nomination may include other metrics. The displayed information may be customized by the retailer. The retailer can customize the types of graphical representations and/or statistics to be included in the dashboard user interface 800.

### Example User Interface: Connected Graph View

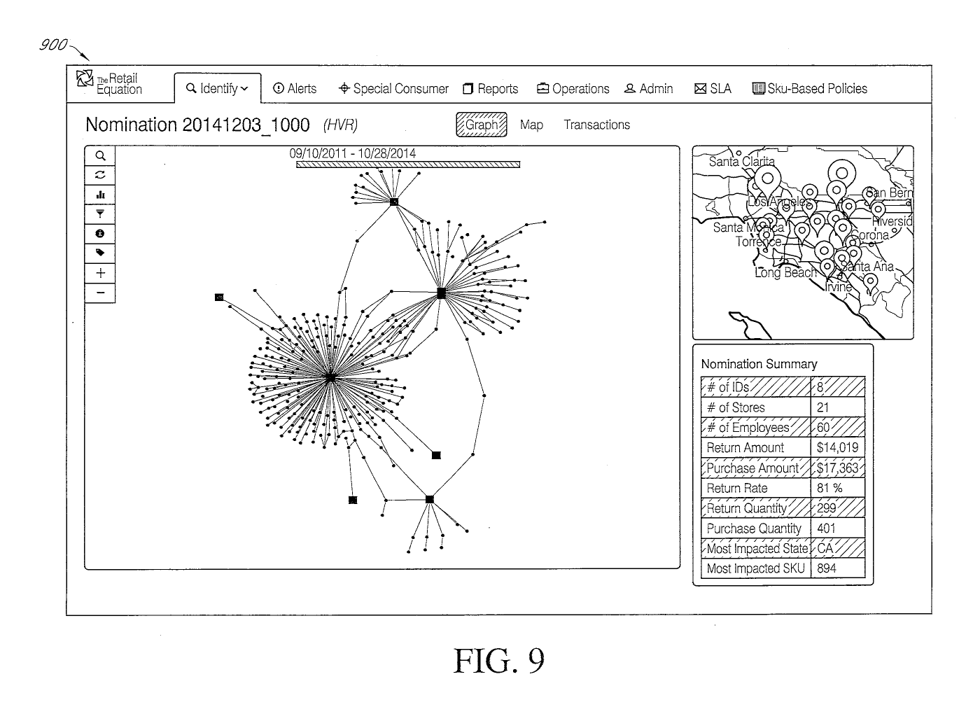

With reference to FIG. 9, a connected graph user interface 900 is described. As shown in FIG. 9, the graph shows a plurality of IDs and the transactions associated with a plurality of IDs. In the example of FIG. 9, each square icon illustrates an ID, and each dot illustrates a transaction. For example, an ID can be linked to multiple transactions, and each transaction can be linked to an ID and/or one or more other transactions. In the example of FIG. 9, the square icons represent an ID (e.g., an identifier used to identify a consumer, such as a driver's license number, a mailing address, a gift card identifier, a loyalty card identifier, a store credit identifier, a credit card number, a state ID number, a debit card number, a check account number, a client-specific customer number, or a passport, etc.), and the small dots represent a transaction (e.g., a return transaction, a purchase transaction, etc.). If a consumer purchases an item using an ID, the purchase transaction illustrated as a small dot may become connected to the ID illustrated as a square icon. If the consumer (or another person) returns the item using a receipt identifying the prior purchase (but without presenting some form of ID), the return transaction illustrated as another small dot may become connected to the small dot representing the prior purchase (but not to the square icon representing the ID because the receipt alone does not indicate whether the person returning the item is identical to the person who made the prior purchase).

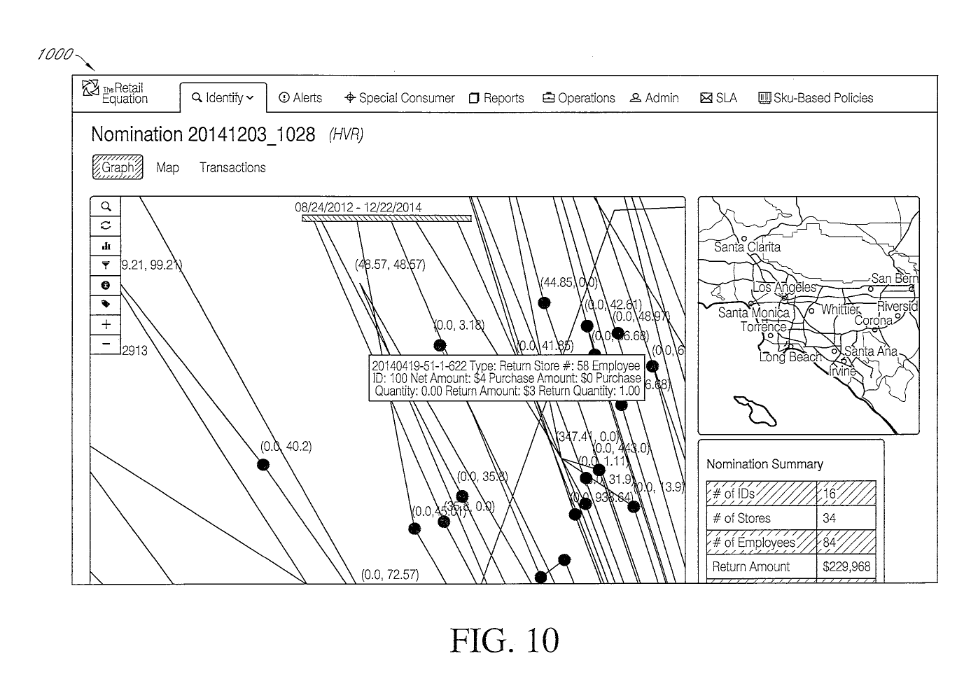

FIG. 10 illustrates a zoomed in version 1000 of the graph shown in FIG. 9. As shown in FIG. 10, a purchase amount and a return amount are displayed along with each transaction. For example, a single transaction may have a nonzero value only for the return amount, may have a nonzero value only for the purchase amount, or may have a nonzero value for each of the return amount and the purchase amount. As shown in FIG. 10, the graph may also illustrate the store ID, the employee ID, the return quantity, and/or the purchase quantity associated with a given transaction.

### Example User Interface: Map View

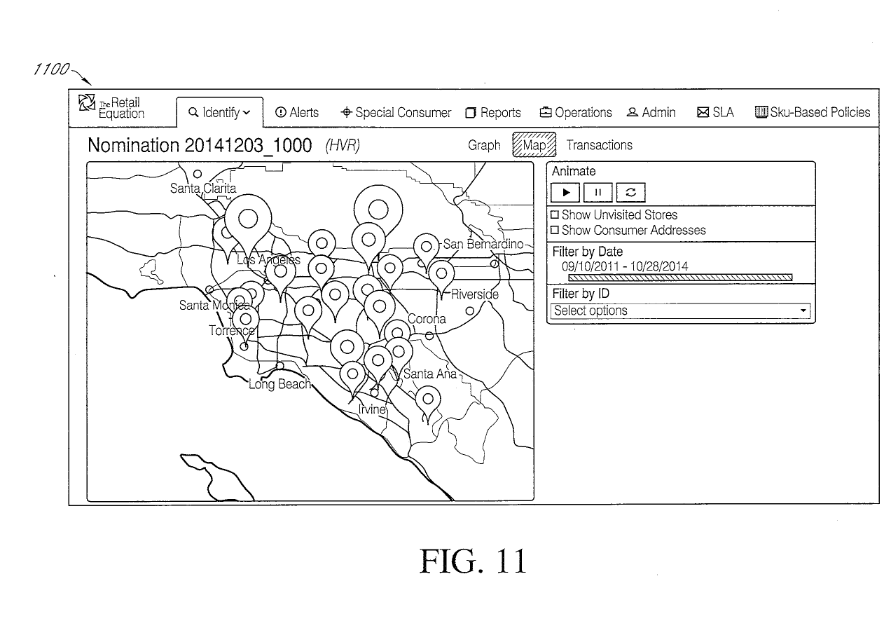

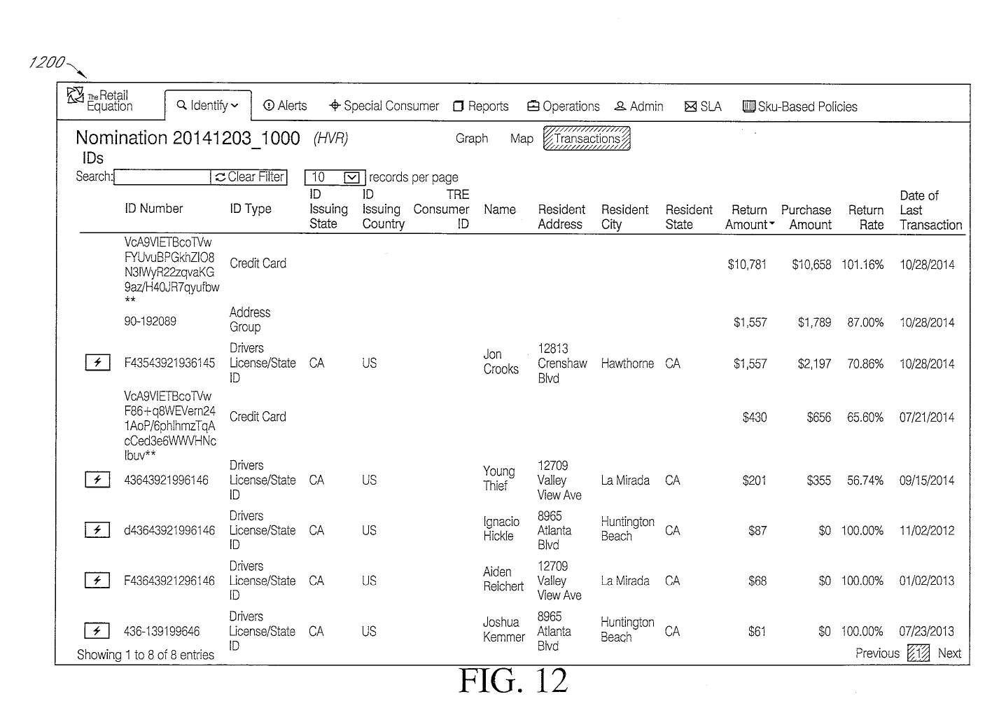

With reference to FIG. 11, a map user interface 1100 for providing a geographical context for a given nomination is described. As shown in FIG. 11, the transactions associated with the given nomination are plotted on a map on top of the store locations with which the transactions are associated.

In some embodiments, the size of the graphical representation placed on the map to indicate the presence of one or more transactions at a given store location is proportional to the number of transactions associated with the given store location. For example, a graphical representation placed on top of a first store location is bigger than another graphical representation placed on top of a second store location, if the number of transactions associated with the first store location is greater than the number of transactions associated with the second store location. In other embodiments, characteristics other than the size of the graphical representation may be used to indicate the number of transactions associated with each store location. For example, the color, brightness, contrast, shape, and other visual qualities of the graphical representation placed on each of the store locations may indicate the number of transactions associated with the store locations. In such an example, the closer the color of the graphical representation is to a first color (e.g., red), the greater the number of transactions represented by the graphical representation, and the closer the color of the graphical representation is to a second color (e.g., green), the smaller the number of transactions represented by the graphical representation.

In some embodiments, the size, color, brightness, contrast, shape, and/or other visual qualities of the graphical representation may be used to indicate the time and date of the transactions represented by the graphical representation. For example, a first graphical representation corresponding to the oldest transaction may be illustrated in a first color, and a second graphical representation corresponding to the most recent transaction may be illustrated a second color different from the first color. In such an example, graphical representations corresponding to transactions that are closer to the oldest transaction than the most recent transaction may be illustrated in colors closer to the first color, and graphical representations corresponding to transactions that are closer to the most recent transaction then the oldest transaction may be illustrated in colors closer to the second color. In other embodiments, instead of color, other visual qualities of the graphical representations may be used to illustrate the temporal trend among the transactions associated with the given nomination.

Upon reviewing the map user interface 1100 illustrated in FIG. 11, the retailer may determine that the particular retail fraud associated with the illustrated nomination is spreading eastward, anticipate where future transactions associated with the particular retail fraud are likely to occur, and take appropriate action to prevent or reduce any additional damage caused by the particular retail fraud. For example, the retailer may increase the number of security guards at the store locations the future transactions are expected to occur, and/or review the return transactions in such store locations more closely.

### Example User Interface: Table View

With reference to FIG. 12, a table user interface 1200 illustrating a given nomination is described. As shown in FIG. 12, the table user interface 1200 may include a list of IDs and/or transactions associated with the given nomination. The IDs associated with the given nomination may include a credit card number, a mailing or resident address, a driver's license number, a state ID number, a gift card ID, a loyalty card ID, a store credit card ID, and/or any other identifier associated with a consumer making the purchase or return associated with the transaction. Each ID may include one or more of a return amount, a purchase amount, a return rate, a date of last transaction, and/or any other parameters indicative of the nature of the ID. For example, a return amount of a given ID may be equal to the sum of the return amounts of all the transactions associated with the given ID, and a purchase amount of the given ID may be equal to the sum of the purchase amounts of all the transactions associated with the given ID. The date of last transaction of a given ID may be the date of transaction of the most recent transaction associated with the given ID.

The table user interface 1200 may also include a list of transactions associated with the given nomination. Each transaction may include one or more of a return amount, a purchase amount, a data transaction, and/or any other parameters indicative of the nature of the transaction.

### Employee Identification Process

FIG. 13 is a flowchart that illustrates one embodiment of a process 1300 for identifying an employee who may be connected to return frauds. The process 1300 begins at block 1302, wherein the identification service 180 receives return authorization data and employee data from the client 120, the return authorization service 102, and/or the customer identifier extraction service 170. The return authorization data may include a plurality of transaction records, where each transaction record is associated with a product purchase, a product return, or any other transaction associated with the client 120. Each transaction record may be associated with a transaction identifier and a transaction amount. The employee data may include data associated with each employee of the client 120. Table 11 provides example metrics that may be included in the employee data. In some embodiments, the employee data may include any criminal records or other publicly available information associated with the employees of the client 120.

At block 1304, the identification service 180 determines client specific thresholds for identification. The client-specific thresholds may be indicative of whether an employee has an increased likelihood of being connected to a fraudulent customer or performing fraudulent activities herself/himself. For example, the client-specific thresholds may include a threshold number of voided transactions, a threshold number of tender swap, a threshold number of return transactions, a threshold amount of return dollar value, etc.

At block 1306, the identification service 180 receives an indication that a product return request has been processed. For example, the indication may be received from the POR device 126 over a computer-mediated network. The indication may include a transaction identifier associated with the processed product return request. Further, the indication may include one or more parameters associated with the product return request. For example, the parameters may include a credit card number, a mailing or resident address, a driver's license number, a state ID number, a gift card ID, a loyalty card ID, a store credit card ID, and/or any other identifier associated with the consumer requesting the product return. In addition, the indication may include an employee identifier associated with the product return request.

At block 1308, the identification service 180 determines whether employee identifier associated with the product return request satisfies the client specific thresholds. For example, the identification service 180 may query the nomination database and determine whether the employee identifier is associated with existing nominations and/or whether the processed product return request causes the data associated with the employee identifier to exceed one or more of the client-specific thresholds.

At block 1310, the identification service 180, in response to determining that the employee identifier associated with the product return request satisfies the client specific thresholds, generates and transmits identification information to the client computing system. For example, if the processed product return request includes a tender swap, and the number of tender swaps associated with the employee identifier was 1 short of satisfying the tender swap threshold associated with the client 120 prior to the processed product return request, the identification service 180, based on the indication that the processed product return request includes a tender swap, may cause the employee identifier and the transactions associated with the employee identifier to be nominated and transmitted to the client 120.

As will be familiar to one of skill in the art, other embodiments of the process 1300 described in FIG. 13 may be carried out by executing the functions described in FIG. 13 in a different order, by dividing the functions in another manner, and/or by including some or all of the functions described above in conjunction with other associated functions. For example, in some embodiments, block 1306 may be modified to receive an indication that a product return request has been denied. In other embodiments, block 1306 may be modified to receive an indication that a product return request has satisfied a condition for checking the nomination database. Other variations are possible. For example, in the process 700 (or other processes disclosed herein) certain steps may be omitted. For example, in some embodiments, block 1306 is omitted. In some other embodiments, blocks 1306-1310 are replaced by another block at which the identification service 180 generates employee nominations based on the return authorization data and the employee data.

Other variations are possible. For example, the identification service 180 may perform the steps at blocks 1306-1310 in response to receiving an indication that a product return request has been rejected. In another example, the identification service 180 may perform the steps at blocks 1306-1310 in response to receiving an indication that a product return request has been granted. In yet another example, the identification service 180 may perform the steps at blocks 1306-1310 in response to receiving an indication that a product return request has satisfied a threshold condition for generating a nomination and providing recommendations as to further action to be taken by the retailer. In some embodiments, the threshold condition may include whether the total return amount processed by an employee has exceeded a threshold level, whether the total number of tender swaps performed by an employee has exceeded a threshold level, whether the total number of non-receipted returns processed by an employee has exceeded a threshold level, whether the employee handling the product return request is on a watch list, or any other condition indicative of the likelihood that the product return request or the employee processing the request may be associated with a return fraud.

### Example User Interface: Employee Profile View

With reference to FIG. 14, an employee profile user interface 1400 illustrating employee data associated with a given employee of the retailer is described. As shown in FIG. 14, the employee profile user interface 1400 may include one or more graphs illustrating the return amount, the sales count, the sales amount, the late return count, the early return count, the tender swap count, the tender swap amount, and/or any other parameters associated with the given employee of the retailer. For example, the return count may be the number of returned items that the given employee processed, and the return amount may be the total dollar value of the returned items processed by the given employee. The sales count may be the number of sold items that the given employee processed, and the sales amount may be the total dollar value of the sold items processed by the given employee. The late return count may be the number of returned items that the given employee processed at least a first threshold time period after the items were first sold, and the early return count may be the number of returned items that the given employee processed within a second threshold time period after the items were first sold. In some embodiments, the first and second threshold time periods are the same. In other embodiments, the first threshold time period and the second threshold time period are different. For example, the first threshold time period may be a return period specified by the retailer after which a product return is no longer allowed (e.g., within 90 days of purchase). In another example, the first threshold time period may be shorter than such a return period by a specified number of days or percentage of the return period. The tender swap count may be the number of transactions in which a return tender type (e.g., method of payment used for the return) is different (e.g., different form, different number, different name, etc.) from the original purchase tender type (e.g., method of payment used for the purchase), and the tender swap amount may be the total dollar value of the returned items processed by the given employee in which the return tender type is different from the original purchase tender type.

In some embodiments, if the original purchase cannot be identified or does not exist, any comparison with respect to the original purchase may automatically satisfy the threshold for the comparison. For example, if the original purchase cannot be determined for a particular return request, the return request may be considered a late return as well as a tender swap return.

The employee profile user interface 1400 may also include a list of transactions that the given employee processed for the retailer. Table 11 provides example metrics that may be used by the identification service 180 to determine whether to nominate an employee.

TABLE 11
Example metrics used for nominating employees

| Metric Name | Metric Description |
|---|---|
| Average Return | Average return transaction dollars. |
| Amount | |
| Average Return | Average quantity per return transaction. |
| Quantity | |
| Average Sales | Average sales transaction dollars. |
| Amount | |
| Average Sales | Average quantity per sales transaction. |
| Quantity | |
| Bad IDs | Adjusted fraction of bad IDs on Verify returns. |
| Cash Return Amount | Adjusted fraction of return transaction dollars processed as cash |
| | tender. |
| Cash Returns | Adjusted fraction of return transactions processed as cash tender. |
| Cash Sales | Adjusted fraction of sales transactions made with cash tender. |
| Cash Sales Amount | Adjusted fraction of sales transaction dollars made with cash tender. |
| Credit Card Return | Adjusted fraction of return transaction dollars credited to credit card. |
| Amount | |
| Credit Card Returns | Adjusted fraction of return transactions credited to credit card. |
| Credit Card Sales | Adjusted fraction of sales transactions made with credit card. |
| Credit Card Sales | Adjusted fraction of sales transaction dollars made with credit card. |
| Amount | |
| Early Returns | Adjusted fraction of return transactions occurring before 8AM, store |
| | time. |
| Early Returns | Adjusted fraction of return dollars occurring before 8AM, store time. |
| Amount | |
| Gift Card Return | Adjusted fraction of return transaction dollars credited to gift card. |
| Amount | |
| Gift Card Returns | Adjusted fraction of return transactions credited to gift card. |
| Gift Card Sales | Adjusted fraction of sales transactions made with gift card(s). |
| Gift Card Sales | Adjusted fraction of sales transaction dollars made with gift card(s). |
| Amount | |
| High Frequency IDs | Adjusted fraction of Verify returns with high-frequency consumer IDs. |
| Late Returns | Adjusted fraction of return transactions occurring after 10PM, store |
| | time. |
| Late Returns | Adjusted fraction of return dollars occurring after 10PM, store time. |
| Amount | |
| Line Discount Sales | Adjusted fraction of line discounted sale dollars, proportional to (total |
| Amount | line discount amount/total sales amount). |
| Line Discount Sales | Adjusted fraction of transactions with any line discount, proportional |
| Transactions | to (transaction count with line discount(s)/total number of sale |
| | transactions). |
| Malformed ID | Adjusted fraction of Verify returns with malformed ID numbers. |
| numbers | |
| Non-Cash To Cash | Adjusted fraction of transactions where non-cash tender was swapped |
| | for cash tender. |
| Non-Cash To Cash | Adjusted fraction of transaction dollars where non-cash tender was |
| Amount | swapped for cash tender. |
| Non-CC to CC | Adjusted fraction of transactions where non-credit card tender was |
| | swapped for credit card tender. |
| Non-CC To CC | Adjusted fraction of transaction dollars where non-credit card tender |
| Amount | was swapped for credit card tender. |
| Non-Receipted | Adjusted fraction of return dollars which are non-receipted, |
| Return Amount | proportional to (non-receipted return dollars/return dollars). |
| Non-Receipted | Adjusted fraction of return item quantities which are non-receipted, |
| Return Quantity | proportional to (non-receipted return transaction item quantities/ |
| | return transaction item quantities). |
| Non-Receipted | Adjusted fraction of return transactions which are non-receipted, |
| Returns | proportional to (non-receipted return transaction count/return |
| | transaction count). |
| Paired Sale & Return | Adjusted fraction of sale transactions subsequently returned within a |
| | 15 minute window. |
| Receipt Not Found | Adjusted fraction of receipted return transactions where sales |
| | transaction key was not found. |
| Returns | Adjusted fraction of return transactions. |
| Sales | Adjusted fraction of sales transactions. |
| Same Day Sale & | Adjusted fraction of sales that were followed by returns within the |
| Return | same day, store time. |
| Store Credit Return | Adjusted fraction of return transaction dollars issued as store credit. |
| Amount | |
| Store Credit Returns | Adjusted fraction of return transactions issued as store credit. |
| Store Credit Sales | Adjusted fraction of sales transactions made with store credit. |
| Store Credit Sales | Adjusted fraction of sales transaction dollars made with store credit. |
| Amount | |
| Tender Swap | Adjusted fraction of transaction dollars where original sales and return |
| Amount | tenders are different. |
| Tender Swaps | Adjusted fraction of transactions where the original sales and returned |
| | tenders are different. |
| Total Discount Sales | Adjusted fraction of total discount applied to all sales transactions. |
| Amount | |
| Transaction Discount | Adjusted fraction of sale transaction discount dollars. |
| Sales Amount | |
| Transaction | Adjusted fraction of sales with a transaction level discount applied. |
| Discounted Sales | |
| Verify Denials | Adjusted fraction of denied transactions processed by Verify, |
| | proportional to (Denied Verify return transactions/Verify return |
| | transactions). |
| Verify Digital | Adjusted fraction of digitally captured IDs on transactions processed |
| Captures | by Verify, proportional to (digitally captured IDs/Verify return |
| | transactions). |
| Verify Manual | Adjusted fraction of manually entered IDs on transactions processed |
| Entries | by Verify, proportional to (manually captured IDs/Verify return |
| | transactions). |
| Verify No-IDs | Adjusted fraction of transactions processed by Verify without a |
| | captured ID, proportional to (No-ID Verify transactions/Verify |
| | return transactions). |
| Verify Overrides | Adjusted fraction of denied and subsequently overridden transactions |
| | processed by Verify, proportional to (overridden Verify transactions/ |
| | Verify return transactions). |
| Verify Voids | Adjusted fraction of voided transactions processed by Verify, |
| | proportional to (Voided Verify return transactions/Verify return |
| | transactions). |

### Example User Interface: Transaction Search

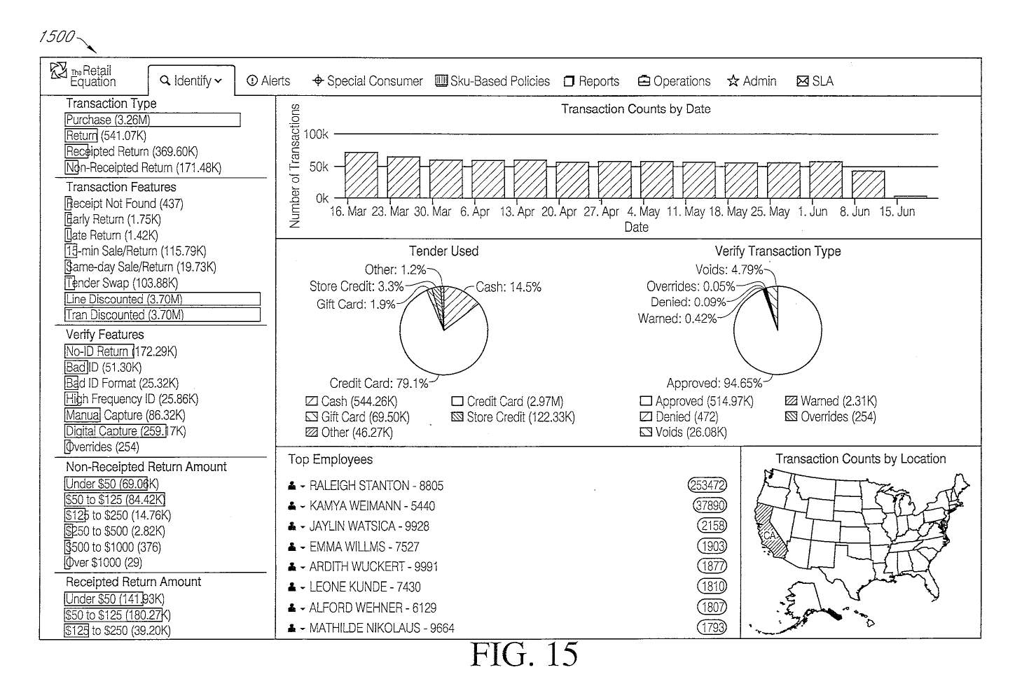

With reference to FIG. 15, a transaction search user interface 1500 allowing the retailer to search for and analyze the transactions of the retailer is described. As shown in FIG. 15, the transaction search user interface 1500 may display the transaction counts by date, display the breakdown of the transactions by the tender type (e.g., cash, credit card, gift card, store credit, or other payment methods), display the breakdown of the transactions by the transaction outcome (e.g., approved, denied, warning issued, overridden, voided, etc.), display the breakdown of the transactions by location, display the breakdown of the employees of the retailer (e.g., by the number, type, dollar amount, or other metrics of the returns, purchases, and other transactions processed by each employee), or display any other metrics related to the transactions of the retailer. As illustrated in FIG. 15, one or more filters (e.g., transaction type, transaction features, non-receipted return amount, receipted return amount, or other criteria and filters) may be used to limit the transaction search to a specific subset of transactions.

### Stock Keeping Unit (SKU) Anomaly Identification Process

FIG. 16 is a flowchart that illustrates one embodiment of a process 1600 for identifying a return fraud based on SKU anomalies. The process 1600 begins at block 1602, wherein the identification service 180 receives return authorization data from the client 120, the return authorization service 102, and/or the customer identifier extraction service 170. The return authorization data may include a plurality of transaction records, where each transaction record is associated with a product purchase, a product return, or any other transaction associated with the client 120. Each transaction record may be associated with a transaction identifier, a transaction amount, an item identifier (e.g., SKU), and/or an item category identifier (e.g., SKU category ID).

At block 1604, the identification service 180 determines client specific thresholds for identification. The client-specific thresholds may be indicative of whether a transaction or a group of transactions having specific SKU or SKU category IDs, which are unrelated or unconnected to existing nominations, may still be related to a return fraud. For example, the client-specific thresholds may include a threshold number of returns, a threshold percentage of returns, a threshold number of non-receipted returns, a threshold percentage of non-receipted returns, etc. The thresholds may also include location-specific (or season-specific, item-specific, SKU-specific, etc.) threshold levels (e.g., threshold number of returns for District A, threshold number of returns for District B, a threshold number of non-receipted returns for December, a threshold percentage of non-receipted returns for baby food, etc.).

At block 1606, the identification service 180 identifies a SKU category that satisfies the client specific thresholds. For example, the identification service 180 may determine that the actual number of returns for items in SKU Category A has exceeded a threshold number of returns (e.g., expected number of returns or some multiple of the expected number).

At block 1608, the identification service 180 updates a return authorization policy based on the identified SKU category. In some embodiments, the identification service 180 may place the individuals requesting the product returns associated with the identified SKU category on a watch list, causing future returns by such individuals to be denied or monitored more closely. In other embodiments, the identification service 180 may cause future returns of items in the identified SKU category to be automatically denied. The identification service 180 may store an indication that the identified SKU category may be associated with return frauds (e.g., a problem SKU category).

At block 1610, the identification service 180 causes return requests that are not associated with nominated transactions to be denied based on updated return authorization policy. For example, upon receiving an indication that a product return request has been processed, the identification service 180 may determine whether the product return request is related to a SKU category previously identified as a problem SKU category. In response to determining that the product return request is related to a SKU category previously identified as a problem SKU category, the identification service 180 causes the product return request to be denied regardless of whether the product return request is related to a previously nominated group of linked transaction records. Advantageously, by using SKU and SKU categories, product return requests seemingly unrelated to any previously identified or suspected return frauds can be denied or put on the watch list, thereby preventing or reducing the loss to the retailer caused by return frauds.

As will be familiar to one of skill in the art, other embodiments of the process 1600 described in FIG. 16 may be carried out by executing the functions described in FIG. 16 in a different order, by dividing the functions in another manner, and/or by including some or all of the functions described above in conjunction with other associated functions. For example, blocks 1606-1610 may be performed for individual SKUs instead of SKU categories. Other variations are possible. For example, in the process 1600 (or other processes disclosed herein) certain steps may be omitted. For example, the decision block 1610 can be omitted, and at block 1608, the identification service 180 may provide a nomination associated with the identified SKU category to the client 120.

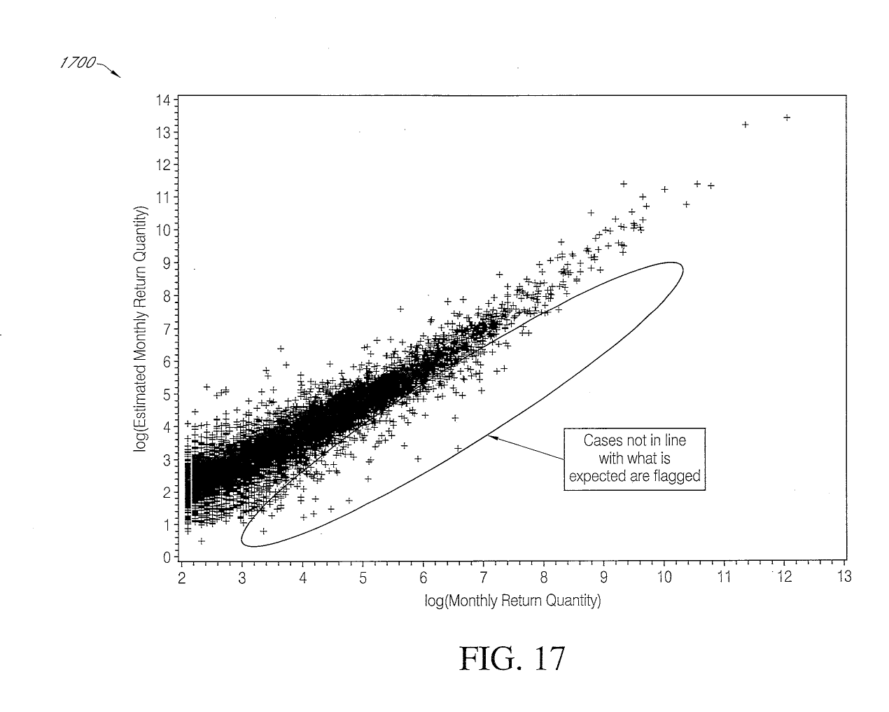

With reference to FIG. 17, a scatter graph 1700 illustrating a method of identifying SKU anomalies is described. In the example of FIG. 17, each SKU or SKU category is plotted on a scatter graph having an x-axis representing the log of the monthly return quantity and a y-axis representing the log of the estimated monthly return quantity. As shown in FIG. 17, the actual monthly return quantities for most SKUs or SKU categories fall within a range of the estimated monthly return quantities. In other words, for most SKUs or SKU categories, the actual monthly return quantity is substantially equal to the estimated monthly return quantity. However, the scatter graph 1700 also shows a small number of SKUs or SKU categories having an actual monthly return quantity that is substantially greater than the estimated monthly return quantity. In some embodiments, the identification service 180 determines that such SKUs or SKU categories are associated with return frauds.

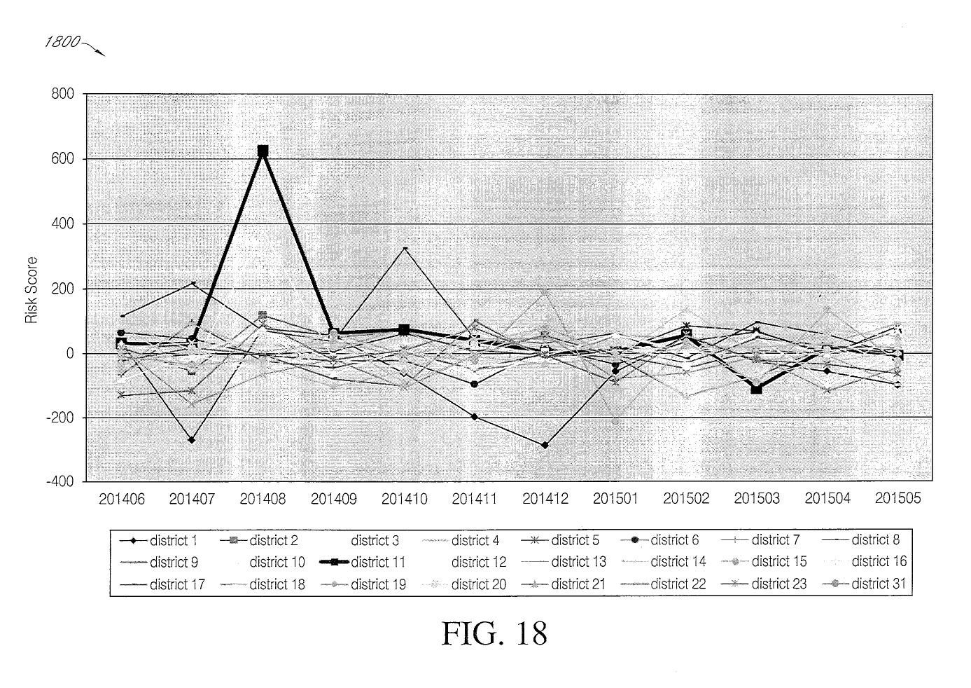

With reference to FIG. 18, a graph 1800 illustrating the risk score associated with each district over a time period is described. An example of FIG. 18, the risk score associated with district 12 has been unusually high value during November 2014. In some embodiments, the risk score may be calculated based on a comparison between the actual return quantity in a given district and the expected return quantity in the given district. The expected return quantity may be determined based on the historical return data associated with the given district. For example, the expected return quantity may be equal to the average return quantity over a period of time (e.g., past 5 years).

### Alert Model

FIG. 19 depicts one embodiment of an alert model architecture 1900 that may be used to implement one or more statistical models used by an alert engine (not illustrated) implemented by the identification service 180. In various embodiments, the alert engine may cause alerts to be created based on nominations generated by the identification service 180 and/or based on a request from the client 120.

In some embodiments, the alerts provided by the identification service 180 may be integrated into a return authorization process to provide a warning to the clerk processing the return transaction at the point of return 125 or to provide recommendations to a manager or administrator associated with the client 120 regarding further action that can be taken based on the triggered alert.

As depicted in FIG. 19, the alert engine may cause alerts to be created based on nominations generated by the identification service 180 and/or based on a request from the client 120 (block 1910). The transaction data collected by the client 120 (e.g., return data, purchase data, return authorization data, the location of the return request, the clerk processing the return, etc.), together with existing stored data which may comprise information about the customer, the clerk, the store, and/or other stored data (collectively transactions 1920), are processed by the alert engine, and the alert engine performs a real-time analysis based on the processed data (block 1930), triggering alerts 1940-1960. The triggered alerts 1940-1960 may prompt the client 120 to take additional action. For example, the client 120 may deny a return transaction, collect additional information, or immediately visit the scene of the transaction associated with the nominations and further investigate the validity of the transaction.

With reference to FIG. 20, an example alert 2000 generated and transmitted to the retailer is described. In the example of FIG. 20, an alert is generated in transmitted to the retailer's email address when a transaction satisfying one or more alert conditions specified by the retailer is processed. As shown in FIG. 20, the alert 2000 may include reference ID, date and time of the transaction triggering the alert, consumer ID, consumer initials, store number, store city, store states, store phone number, return amount, and/or any other parameters associated with the transaction. When an alert is triggered, a video camera configured to capture the scene of the transaction may be caused to take a picture or video and send the picture or video to the retailer.

Advantageously, upon receiving such an alert, the retailer may take any appropriate action to prevent or reduce return frauds. For example, a representative of the retailer at the store location associated with the transaction triggering the alert may approach the scene of the transaction to further question the consumer regarding the transaction. In another example, the product return request may be denied or the consumer associated with the transaction may be placed on a watch list for continued monitoring.

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the disclosure. Accordingly the scope of the invention is determined by the claims recited below, not by the specific examples presented above.

What is claimed is:

1. An electronic monitoring system that automatically identifies organized retail crime rings, the system comprising:
an electronic identify device configured to communicate with an identification system and a nomination database via a computer-mediated network, the electronic identify device associated with a client;
the nomination database configured to store one or more groups of linked transaction records associated with the client and generated by the identification system; and
the identification system including one or more processors and configured to at least:
receive return authorization data from a client computing system associated with the client over the computer-mediated network, the return authorization data generated by a point of return (POR) device of the client based on a plurality of product returns processed by the client, the return authorization data including a plurality of transaction records associated with the plurality of product returns, each transaction record having a transaction identifier and a transaction amount;
determine a set of threshold levels associated with the client based on the received return authorization data, the set of threshold levels indicative of whether a group of linked transaction records has an increased likelihood of being associated with an organized retail crime ring;
identify a first group of linked transaction records from the plurality of transaction records in the return authorization data based on one or more common attributes shared by one or more subsets of transaction records in the first group of linked transaction records, the one or more common attributes comprising one or more of a driver's license number, a mailing address, a gift card identifier, a loyalty card identifier, a store credit identifier, a credit card number, a state ID number, a debit card number, a check account number, a client-specific customer number, or a passport number;
determine that the first group of linked transaction records has an increased likelihood of being associated with an organized retail crime ring based on whether the first group of linked transaction records collectively satisfies the set of thresholds associated with the client;
in response to determining that the first group of linked transaction records has an increased likelihood of being associated with an organized retail crime ring, nominate the first group of linked transaction records for presentation to the client and cause the nominated first group of linked transaction records to be stored in the nomination database;
receive, from the POR device of the client over the computer-mediated network, an indication that a product return request by a user has been processed, the indication including a first transaction identifier associated with the processed product return request;
in response to receiving the indication that the product return request has been processed, query the nomination database to determine, using the received first transaction identifier, whether the nomination database includes one or more nominated transaction records that are associated with the first transaction identifier;
in response to determining that the first group of linked transaction records includes a first nominated transaction record associated with the first transaction identifier, generate organized retail crime ring information based on the first group of linked transaction records, the organized retail crime ring information including additional information linking the user with one or more other users associated with the first group of linked transaction records in a context of the organized retail crime ring; and
transmit the generated organized retail crime ring information over the computer-mediated network to the electronic identify device, thereby enabling the client to take additional action based on the transmitted organized retail crime ring information.

2. The system of claim 1, wherein each subset of transaction records in the group of linked transaction records shares at least one common attribute with at least one other subset of transaction records in the group of linked transaction records.

3. The system of claim 1, wherein the set of threshold levels includes a threshold level for a total return value, the identification system further configured to determine that the first group of linked transaction records has an increased likelihood of being associated with an organized retail crime ring based on a determination that the first group of linked transaction records collectively exceeds the threshold level for the total return value.

4. The system of claim 1, wherein the set of threshold levels includes a threshold level for a total number of identifications, the identification system further configured to determine that the first group of linked transaction records has an increased likelihood of being associated with an organized retail crime ring based on a determination that the first group of linked transaction records collectively exceeds the threshold level for the total number of identifications.

5. The system of claim 1, wherein the set of threshold levels includes a threshold level for a total return rate, the identification system further configured to determine that the first group of linked transaction records has an increased likelihood of being associated with an organized retail crime ring based on a determination that the first group of linked transaction records collectively exceeds the threshold level for the total return rate.

6. The system of claim 1, wherein the identification system is further configured to generate a data structure associated with the nominated first group of linked transaction records in the form of a connected graph user interface and cause the generated data structure to be presented via the client computing device.

7. The system of claim 1, wherein the identification system is further configured to generate a data structure associated with the nominated first group of linked transaction records in the form of a map user interface and cause the generated data structure to be presented via the client computing device.

8. The system of claim 1, wherein the identification system is further configured to generate a data structure associated with the nominated first group of linked transaction records in the form of a table user interface and cause the generated data structure to be presented via the client computing device.

9. The system of claim 1, wherein the identification system is further configured to query the nomination database in response to receiving an indication that a product return request has been denied.

10. The system of claim 1, wherein the identification system is further configured to query the nomination database in response to receiving an indication that one or more parameters associated with a granted product return request satisfy a threshold condition.

11. A method that automatically identifies organized retail crime rings, the method comprising:
receiving return authorization data from a client computing system associated with a client over a computer-mediated network, the return authorization data generated by a point of return (POR) device of the client based on a plurality of product returns processed by the client, the return authorization data including a plurality of transaction records associated with the plurality of product returns, each transaction record having a transaction identifier and a transaction amount;
determining a set of threshold levels associated with the client based on the received return authorization data, the set of threshold levels indicative of whether a group of linked transaction records has an increased likelihood of being associated with an organized retail crime ring;
identifying a first group of linked transaction records from the plurality of transaction records in the return authorization data based on one or more common attributes shared by one or more subsets of transaction records in the first group of linked transaction records, the one or more common attributes comprising one or more of a driver's license number, a mailing address, a gift card identifier, a loyalty card identifier, a store credit identifier, a credit card number, a state ID number, a debit card number, a check account number, a client-specific customer number, or a passport number;
determining that the first group of linked transaction records has an increased likelihood of being associated with an organized retail crime ring based on whether the first group of linked transaction records collectively satisfies the set of thresholds associated with the client;
in response to determining that the first group of linked transaction records has an increased likelihood of being associated with an organized retail crime ring, nominating the first group of linked transaction records for presentation to the client and cause the nominated first group of linked transaction records to be stored in the nomination database;
receiving, from the POR device of the client over the computer-mediated network, an indication that a product return request by a user has been processed, the indication including a first transaction identifier associated with the processed product return request;
in response to receiving the indication that the product return request has been processed, querying the nomination database to determine, using the received first transaction identifier, whether the nomination database includes one or more nominated transaction records that are associated with the first transaction identifier;
in response to determining that the first group of linked transaction records includes a first nominated transaction record associated with the first transaction identifier, generating organized retail crime ring information based on the first group of linked transaction records, the organized retail crime ring information including additional information linking the user with one or more other users associated with the first group of linked transaction records in a context of the organized retail crime ring; and
transmitting the generated organized retail crime ring information over the computer-mediated network to an electronic identify device associated with the client, thereby enabling the client to take additional action based on the transmitted organized retail crime ring information.

12. The method of claim 11, wherein each subset of transaction records in the group of linked transaction records shares at least one common attribute with at least one other subset of transaction records in the group of linked transaction records.

13. The method of claim 11, wherein the set of threshold levels includes a threshold level for a total return value, the method further comprising determining that the first group of linked transaction records has an increased likelihood of being associated with an organized retail crime ring based on a determination that the first group of linked transaction records collectively exceeds the threshold level for the total return value.

14. The method of claim 11, wherein the set of threshold levels includes a threshold level for a total number of identifications, the method further comprising determining that the first group of linked transaction records has an increased likelihood of being associated with an organized retail crime ring based on a determination that the first group of linked transaction records collectively exceeds the threshold level for the total number of identifications.

15. The method of claim 11, wherein the set of threshold levels includes a threshold level for a total return rate, the method further comprising determining that the first group of linked transaction records has an increased likelihood of being associated with an organized retail crime ring based on a determination that the first group of linked transaction records collectively exceeds the threshold level for the total return rate.

16. The method of claim 11, further comprising generating a data structure associated with the nominated first group of linked transaction records in the form of a connected graph user interface and causing the generated data structure to be presented to the client via the client computing device.

17. The method of claim 11, further comprising generating a data structure associated with the nominated first group of linked transaction records in the form of a map user interface and causing the generated data structure to be presented to the client via the client computing device.

18. The method of claim 11, further comprising generating a data structure associated with the nominated first group of linked transaction records in the form of a table user interface and causing the generated data structure to be presented to the client via the client computing device.

19. The method of claim 11, further comprising querying the nomination database in response to receiving an indication that a product return request has been denied.

20. The method of claim 11, further comprising querying the nomination database in response to receiving an indication that one or more parameters associated with a granted product return request satisfy a threshold condition.
